(19) United States
(12) Patent Application Publication
(10) Pub. No.: US 2025/0089720 A1
(43) Pub. Date: Mar. 20, 2025

(54) FUNGICIDAL MIXTURES COMPRISING COMBINATION CONTAINING PHTHALIMIDE

(71) Applicant: Adama Makhteshim Ltd., Beer Sheva (IL)

(72) Inventors: Matteo Cernuschi, Milan (IT); Yoav Avidor, Tel-Aviv (IL); Alexandra Rosenmund, Zurich (CH)

(73) Assignee: Adama Makhteshim Ltd., Beer Sheva (IL)

(21) Appl. No.: 18/725,998

(22) PCT Filed: Jan. 11, 2023
(86) PCT No.: PCT/IB2023/050265

§ 371 Date: Jul. 1, 2024

Related U.S. Application Data
(60) Provisional application No. 63/298,886, filed on Jan. 12, 2022.

(51) Int. Cl. A01N 47/04; A01P 3/00

(52) U.S. Cl. CPC A01N 47/04; A01P 3/00

(57) ABSTRACT

The present invention provides improved combinations, mixtures and compositions comprising a phthalimide fungicide and at least one primary fungicide selected from pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide, or inorganic fungicide and any combination thereof, as well as methods of use and processes of preparation thereof.

Throughout this application, various publications are cited. Disclosures of the documents and publications referred to herein are hereby incorporated in their entireties by reference into this application.

### FIELD OF THE PRESENT SUBJECT MATTER

The present invention provides improved combinations, mixtures and compositions comprising a phthalimide fungicide and at least one primary fungicide, as well as methods of use and processes of preparation thereof.

### BACKGROUND OF THE INVENTION

Fungicides are compounds of natural or synthetic origin which act to protect plants against damage caused by fungi. In spite of the benefits derived from the use of fungicides in agriculture such as protection of crops and improved productivity, it is nowadays desirable to reduce the amount of fungicides used in the fields owing to the potential health risks associated with an intensive use of agrochemicals.

Another important issue associated with fungus attacks is the loss of nutrients which leads to a decrease in the overall yield of the crop. Compositions comprising one single active ingredient have shown a limited control over diseases. There is therefore a need for new mixtures and method of treatment that provides a control over the fungal attacks on crops and enables higher yields while preserving a high amount of nutrients in crops.

There is also a need for a way to increase penetration of fungicide(s) into the plant. For example, ZymoSeptoria tritici is the main fungal agent responsible for wheat Septoria in temperate regions. It is in autumn that the primary inoculum will start the epidemiological cycle and lead to the first foliar infections. An asymptomatic latent phase then begins and lasts for 14 to 21 days before the emergence of the pycnidia. These reproductive structures contain pycnospores capable of spreading over short distances from a sporulating lesion mainly by splashing during a rain event. As soon as the first symptoms from the primary inoculum appear, the decision to treat must be made. However, visual observations of symptoms reflect infections that occurred 14 to 21 days earlier. The use of systemic molecules (i.e. those capable of penetrating and migrating into plant tissue) should permit to act curatively on leaves for which the disease is still incubating. A race then ensues between the pathogen developing in the tissue and the systemic active ingredient seeking to reach it before the fungal development has reached the point of no return. In this context, the penetration speed of these molecules is one of the essential criteria modulating the effectiveness of treatments, making it possible to make up for a situation of incubating infection.

In addition, repeated usage of a single fungicide often leads to the development of resistance to the fungicide. Many so-called curative active ingredients are known and used in the field against Septoria, all of these molecules are unisites meaning that they subject the targeted fungal pathogen to strong selection pressure on a single site of action. These molecules are thus confronted with the rapid development and dissemination of resistance in populations and are therefore unfavorable to a resistance management strategy. Once resistance is developed, there is a need to revert, restore, increase and/or extend the activity. Moreover, many known fungicides are effective for specific crop and have a limited activity. In order to avoid the generalization of these situations causing losses of effectiveness and yield in the field, technical experts recommend the use of active ingredients with different modes of action or with multi-site action. No specific resistance is established or expected towards them. Most of them are so-called “contact resistant”, unable to penetrate plant tissue and therefore only capable of preventive effectiveness. The use of two-way mixtures then presents an opportunity to combine these active ingredients for greater efficacy and better resistance management. However, it also brings complexity in regard to the impact that one molecule can have on the other, which can modulate the effectiveness of each molecule in unexpected ways.

There is also a need for find a way to increase the bioavailability of fungicide(s) in plants. Many known fungicides are effective for specific crop and have a limited bioavailability which effect the efficacy of the fungicide(s).

### SUMMARY OF THE INVENTION

The present invention provides a method of treating a plant or locus against fungal infection comprising applying a combination of an amount of a phthalimide fungicide and an amount of at least one primary fungicide selected from the group consisting of pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide, or inorganic fungicide and any combination thereof, to the plant or locus so as to thereby treat the plant or locus against fungal infection, wherein (i) the method is more effective against fungal infection than when the amount of the phthalimide fungicide and the amount of a primary fungicide are applied alone, and/or (ii) the amount of the phthalimide fungicide improves the fungicidal efficacy of the amount of the primary fungicide compared to when the same amount of the primary fungicide is applied not in combination with the amount of the phthalimide fungicide.

The present invention provides a method of increasing sensitivity of a fungus to an amount of at least one primary fungicide selected from the group consisting of pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide, or inorganic fungicide and any combination thereof comprising applying a combination of an amount of a phthalimide fungicide and the amount of at least one primary fungicide to the fungus, so as to thereby increase sensitivity of the fungus to the amount of the primary fungicide.

The present invention provides a method of increasing bioavailability of an amount of at least one primary fungicide selected from the group consisting of pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide, or inorganic fungicide and any combination thereof to a plant comprising applying a combination of an amount of a phthalimide fungicide and the amount of at least one primary fungicide to the plant, so as to thereby increase bioavailability of the amount of the primary fungicide.

The present invention also provides a method of inhibiting fungal mycelium formation comprising applying a combination of an amount of a phthalimide fungicide and an amount of at least one primary fungicide selected from the group consisting of pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide, or inorganic fungicide and any combination thereof to the fungus, so as to thereby inhibit fungal mycelium formation.

The present invention also provides a method of prolonging the period of protection against fungal infection and/or control of fungal infection from an application of an amount of at least one primary fungicide selected from the group consisting of pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide, or inorganic fungicide and any combination thereof to a plant or locus comprising applying a combination of an amount of a phthalimide fungicide and the amount of at least one primary fungicide to the plant or locus. In some embodiments, the plant is a crop plant.

The present invention also provides a method of reducing the amount of time needed to achieve a level of fungal control from an application of an amount of primary fungicide to a plant or locus comprising applying a combination of an amount of a phthalimide fungicide and the amount of at least one primary fungicide selected from the group consisting of pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide, or inorganic fungicide and any combination thereof to the plant or locus.

The present invention also provides a method of improving development of a plant affected by fungal infection comprising applying a combination of a phthalimide fungicide and at least one primary fungicide selected from the group consisting of pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide, or inorganic fungicide and any combination thereof to the plant or a locus thereof so as to improve the development of the plant compared to the development of a plant affected by the same type and degree of fungal infection to which the combination is not applied.

The present invention provides an improved combination comprising an amount of a primary fungicide and at least one amount of a phthalimide fungicide, wherein the primary fungicide is selected from the group consisting of pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide, or inorganic fungicide and any combination thereof.

The present invention also provides a fungicidal composition comprising (i) a phthalimide fungicide, (ii) at least one primary fungicide selected from the group consisting of pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide, or inorganic fungicide and any combination thereof, and an agriculturally acceptable carrier.

The present invention also provides a process of preparing the composition described herein, comprises the steps of: (i) obtaining an amount of the phthalimide fungicide(s) and an amount of at least one primary fungicide(s) selected from the group consisting of pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide, or inorganic fungicide and any combination thereof, and (ii) mixing the obtained amount of phthalimide fungicide(s) and the obtained amount of the primary fungicide(s) to obtain the composition.

The present invention also provides a package comprising any one of the combinations disclosed herein.

### DETAILED DESCRIPTION OF THE INVENTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Throughout the application, descriptions of various embodiments use the term “comprising”; however, it will be understood by one of skill in the art, that in some specific instances, an embodiment can alternatively be described using the language “consisting essentially of” or “consisting of.”

As used herein, the term “a” or “an” includes the singular and the plural, unless specifically stated otherwise. Therefore, the terms “a,” “an” or “at least one” can be used interchangeably in this application.

As use here in, the term “about” is inclusive of the stated value and means within an acceptable range of deviation for the particular value as determined by one of ordinary skill in the art, considering the measurement in question and the error associated with measurement of the particular quantity (i.e. the limitations of the measurement system). For example, “about” can mean within one or more standard deviations, or within ±30%, 20%, 10%, 5% of the stated value. In this regard, use of the term “about” herein specifically includes ±10% from the indicated values in the range. In addition, the endpoints of all ranges directed to the same component or property herein are inclusive of the endpoints, are independently combinable, and include all intermediate points and ranges.

As used herein, the term “and/or” includes any and all combinations of one or more of the associated listed items. Expressions such as “at least one of,” when preceding a list of elements, modify the entire list of elements and do not modify the individual elements of the list.

As used herein, the term “combination” means an assemblage of agrochemicals for application either by simultaneous or contemporaneous application.

As used herein, the term “simultaneous” when used in connection with application of agrochemicals means that the agrochemicals are applied in an admixture, for example, a tank mix. For simultaneous application, the combination may be the admixture or separate containers each containing an agrochemical that are combined prior to application.

The admixture or individual components may be in any physical form, e.g. blend, solution, suspension, dispersion, emulsion, alloy, or the like.

As used herein, the term “contemporaneous” when used in connection with application of agrochemicals means that an individual agrochemical is applied separately from another agrochemical or premixture at the same time or at times sufficiently close together that an activity that is additive or more than additive or synergistic relative to the activity of either agrochemical alone at the same dose is achieved. Benefits of applying the phthalimide fungicide with a primary fungicide, in particular fungicide (A) and fungicide I, include, but are not limited to, increased efficacy, bioavailability, penetration and translocation of the primary fungicide, in particular fungicide (A) and fungicide I.

As used herein, the term “mixture” refers to, but is not limited to, a combination in any physical form, e.g., blend, solution, suspension, dispersion, emulsion, alloy, or the like.

As used herein, the term “tank mix” means one or more of the components of the combination, mixture or composition of the present invention are added are mixed in a spray tank at the time of spray application or prior to spray application.

As used herein, the term “ready mix” means a composition that may be applied to plants directly after dilution. The composition comprises the combination of the active ingredients.

As used herein, the term “composition” includes at least one of the combinations or mixtures of the present invention with agriculturally acceptable carrier.

As used herein, the term “treating a plant or soil against fungal infection” includes, but is not limited to, protecting the plant or soil against fungal attack, preventing fungal infection of the plant or soil, controlling fungal disease infecting the plant or soil, and reducing fungal infection of the plant or soil.

As used herein, the terms “control” or “controlling” or “treating” refers but is not limited to preventing fungal disease, protecting plants from fungal disease, delaying the onset of fungal disease, and combating or killing fungal disease. They also may include the curative and/or eradication action of compounds and compositions on underway fungal diseases. Controlling fungal disease infecting the plant, propagation material of the plant or locus of the plant, controlling a plant or soil disease caused by phytopathologic fungi (pathogen), controlling fungal attack on the plant or, propagation material of the plant or locus of the plant refers to curative application and/or protectant/preventive application and/or persistence application.

The term “applying” or “application”, as used herein, refers but is not limited to applying the compounds and compositions of the invention to the plant, to a site of infestation by fungi, to a potential site of infestation by the fungi, which may require protection from infestation, or the environment around the habitat or potential habitat of the fungi. It also refers to the activity of compounds and compositions on plants and fungal tissues with which they come into contact. The application may be by methods described in the present invention such as by spraying, dipping, etc.

As used herein, the term “protectant application” means an application of one or more fungicide for preventing fungal infection of the plant or locus, wherein the fungicidal combination, mixture or composition is applied before infection/disease occurs, before any disease symptoms are shown or when the disease pressure is low. Disease pressure may be assessed based on the conditions associated with disease development such as spore concentration and certain environmental conditions.

As used herein the term “curative application” means an application of one or more fungicide for controlling fungal infection of the plant or locus, wherein the fungicidal combination, mixture or composition is applied after an infection or after disease symptoms are shown. And wherein the fungal infection is reduced and/or curing plant or soil disease caused by phytopathologic fungi.

As used herein, the term “curative treatment” or “curative activity” means an application of one or more pesticide for controlling pest infection of the plant or locus, after an infection or after disease symptoms are shown and/or when the disease pressure is high. Disease pressure may be assessed based on the conditions associated with disease development such as spore concentration and certain environmental conditions. In some embodiments, the pest is a fungus.

As used herein, the term “preventative treatment” or “preventative activity” means an application of one or more pesticide for controlling pest infection of the plant or locus, before an infection or before disease symptoms are shown and/or when the disease pressure is low. Disease pressure may be assessed based on the conditions associated with disease development such as spore concentration and certain environmental conditions. In some embodiments, the pest is a fungus.

As used herein the term “persistence treatment” or “persistence activity” means an application of one or more pesticide for controlling pest infection of the plant or locus over an extended period of time, before an infection or before fungal disease symptoms are shown and/or when the fungal disease pressure is low. Fungal disease pressure may be assessed based on the conditions associated with fungal disease development such as spore concentration and certain environmental conditions.

In particular, when the term “persistence treatment” or “persistence activity” is used in connection with a fungicide, the term means application of one or more fungicide for controlling fungal infection of the plant or locus over an extended period of inoculation, before an infection or before disease symptoms are shown and/or when the disease pressure is low. Disease pressure may be assessed based on the conditions associated with disease development such as spore concentration and certain environmental conditions.

The term “enhancing crop plants” as used herein means improving one or more of plant quality, greening effect, plant vigor, nutrient uptake, root system, tolerance to stress factors, and/or yield in a plant to which the mixture or composition described herein is applied as compared to a control plant grown under the same conditions except to which the mixture or composition described herein is not applied.

The term “improving plant quality” as used herein means that one or more traits are improved qualitatively or quantitatively in a plant to which the mixture or composition described herein is applied as compared to the same trait in a control plant grown under the same conditions except to which the mixture or composition described herein is not applied. Such traits include but are not limited to improved visual appearance and composition of the plant (i.e. improved color, density, uniformity, compactness), reduced ethylene (reduced production and/or inhibition of reception), improved visual appearance and composition of harvested material (i.e. seeds, fruits, leaves, vegetables, shoot/stem/cane),), improved carbohydrate content (i.e. increased quantities of sugar and/or starch, improved sugar acid ratio, reduction of reducing sugars, increased rate of development of sugar), improved protein content, improved oil content and composition, improved nutritional value, reduction in anti-nutritional compounds, increased nutrient uptake, stronger and healthier roots, improved organoleptic properties (i.e. improved taste), improved consumer health benefits (i.e. increased levels of vitamins and antioxidants), improved post-harvest characteristics (i.e. enhanced shelf-life and/or storage stability, easier processability, easier extraction of compounds), and/or improved seed quality (i.e. for use in following seasons).

As used herein, the term “more effective” includes, but is not limited to, increasing efficacy of fungal disease control, prolonging protection and reducing the amount of time needed to achieve a given level of fungal control, prolonging the duration of protection against fungal attack after application and extending the protection period against fungal attack and/or reducing the amount of time needed to achieve a level of fungal control compared to when each fungicide at the same amount is applied alone. In particular, “more effective” includes increasing efficacy of fungal disease control in an untreated area.

As used herein, the term “effective” when used in connection with any combination, mixture or composition may be but is not limited to increase in controlling fungal disease, increase in preventing fungal disease, decrease time for effective controlling fungal disease, decrease the amount of the fungicide(s) which is required for effective controlling fungal disease, extend the controlling effect of the individual fungicide in the mixture in terms of type of crop and disease, prolong the time of controlling effect of the mixture compared to the individual fungicide in the mixture in terms of type of crop and disease, prolong the time of controlling effect of the individual fungicide in the mixture in terms of type of crop and disease.

In particular, the term “effective” may refer to, increasing efficacy of fungal disease control in untreated plant area, reducing the amount of time needed to achieve a given level of fungal control, extending the protection period against fungal attack and/or reducing the amount of time needed to achieve a level of fungal control.

As used herein, the term “effective amount” refers to an amount of the agrochemical composition or of the mixture which is sufficient for controlling harmful fungi on crop plants and does not cause any significant damage to the treated crop plants.

As used herein, the term “fungicidally effective amount” refers to an amount of the active component that is commercially recommended for use to control fungi. The commercially recommended amount for each active component, often specified as application rates of the commercial formulation, may be found on the label accompanying the commercial formulation. The commercially recommended application rates of the commercial formulation may vary depending on factors such as the plant species and the fungus to be controlled.

As used herein, the term “agriculturally acceptable carrier” means carriers which are known and accepted in the art for the formation of compositions for agricultural or horticultural use.

As used herein, the term “adjuvant” is broadly defined as any substance that itself is not an active ingredient but which enhances or is intended to enhance the effectiveness of the pesticide with which it is used. Adjuvants may be understood to include, but are not limited to, spreading agents, penetrants, compatibility agents, and drift retardants.

As used herein, the term “agriculturally acceptable additives” is defined as any substance that itself is not an active ingredient but is added to the composition such as thickening agent, sticking agents, surfactants, anti-oxidation agent, anti-foaming agents and thickeners.

As used herein, the term “systemic fungicide” is broadly defined as any agrochemical or any active compound that is taken up into the plant tissue. Once inside it can redistribute from the sprayed leaf surface to the lower unsprayed surface and/or can redistribute through the xylem and/or phloem vessels in any other part of the plant.

As used herein, the term “treated area” refers to an area where the fungicide was applied to.

As used herein, the term “untreated area” refers to an area where the fungicide was not applied to. Presence of the fungicide in an untreated area may be due to translocation.

As used herein, the term “translocation” is synonymous with the term “migration”.

As used herein the term “plant” or “crop” includes reference to agricultural crops including field crops (soybean, maize, wheat, rice, etc.), vegetable crops (potatoes, cabbages, etc.), fruits (peach, etc.), semi-perennial crops (sugarcane) and perennial crops (coffee and guava).

As used herein the term “plant” or “crop” includes reference to whole plants, plant organs (e.g. leaves, stems, twigs, roots, trunks, limbs, shoots, fruits etc.), plant cells, seedling or plant seeds. This term also encompasses plant crops such as fruits.

As used herein, the term “plants” refers to any and all physical parts of a plant, including but not limited to seeds, seedlings, saplings, roots, tubers, stems, stalks, foliage, and fruits.

The term “plant” may also include the propagation material thereof, which may include all the generative parts of the plant such as seeds and vegetative plant material such as cuttings and tubers, which can be used for the multiplication of the plant. It may also include spores, corms, bulbs, rhizomes, sprouts, basal shoots, stolons, and buds and other parts of plants, including seedlings and young plants, which are to be transplanted after germination, rooting or after emergence from soil or any other kind of substrate, be it artificial or natural.

As used herein the term “propagation material” is to be understood to denote all the generative parts of the plant such as seeds and spores, vegetative structures such as bulbs, corms, tubers, rhizomes, roots stems, basal shoots, stolons and buds.

As used herein, the term “cultivated plants” includes plants which have been modified by breeding, mutagenesis or genetic engineering. Genetically modified plants are plants, which their genetic material has been modified by the use of recombinant DNA techniques. Typically, one or more genes have been integrated into the genetic material of such a plant in order to improve certain properties of the plant.

The term “plant health” comprises various sorts of improvements of plants that are not connected to the control of pests. For example, advantageous properties that may be mentioned are improved crop characteristics including: emergence, crop yields, protein content, oil content, starch content, more developed root system (improved root growth), improved stress tolerance (e.g. against drought, heat, salt, UV, water, cold), reduced ethylene (reduced production and/or inhibition of reception), increase in plant height, bigger leaf blade, less dead basal leaves, stronger tillers, greener leaf color, pigment content, photosynthetic activity, less input needed (such as fertilizers or water), less seeds needed, more productive tillers, earlier flowering, early grain maturity, less plant verse (lodging), shortening of stalks, increased diameter of stalks, increased shoot growth, enhanced plant vigor, increased plant stand and early and better germination; or any other advantages familiar to a person skilled in the art.

As used herein, the term “locus” includes not only areas where fungal infection/disease may already be shown, but also areas where fungal infection/disease have yet to show and also area under cultivation. Locus include but is not limited to soil and other plant growth medium.

As used herein, the term “locus” includes a habitat, breeding ground, plant, propagation material, soil, area, material or environment in which a fungal disease is growing or may grow.

As used herein the term “ha” refers to hectare.

As used herein, the term “fungicidal group” refer but is not limited to the differences in the chemical structure(s) and/or mode of action of the fungicides. e.g. pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide, or inorganic fungicide and any combination thereof, wherein OSBPI includes piperidinyl thiazole isoxazoline fungicide which is the chemical structure based name.

It will be understood that when an element is referred to as being “on” another element, it can be directly in contact with the other element or intervening elements may be present therebetween. In contrast, when an element is referred to as being “directly on” another element, there are no intervening elements present.

As used herein, the term “pathogen” includes “fungal pathogen”.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

As use here in, the term “greening effect” refers to maintain green leaf area longer.

### Methods

The present invention provides a method of treating a plant or locus against fungal infection comprising applying a combination of an amount of a phthalimide fungicide and an amount of at least one primary fungicide selected from pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide or inorganic fungicide and any combination thereof, to the plant or locus so as to thereby treat the plant or locus against fungal infection, wherein (i) the method is more effective against fungal infection than when the amount of the phthalimide fungicide and the amount of a primary fungicide are applied alone, and/or (ii) the amount of the phthalimide fungicide improves the fungicidal efficacy of the amount of the primary fungicide compared to when the same amount of the primary fungicide is applied not in combination with the amount of the phthalimide fungicide.

In some embodiments, the locus is soil.

In some embodiments, the method comprising applying the amount of the primary fungicide in combination with the amount of the phthalimide fungicide improves the fungicidal efficacy of the amount of primary fungicide compared to when the same amount of the primary fungicide is applied not in combination with the amount of the phthalimide fungicide. The present invention provides a method of improving fungicidal efficacy of an amount of a primary fungicide comprising applying a combination of an amount of a phthalimide fungicide and the amount of the primary fungicide to the fungus, so as to thereby improve the fungicidal efficacy of the amount of the primary fungicide compared to when the same amount of the primary fungicide is applied not in combination with the amount of the phthalimide fungicide.

In some embodiments, fungicidal efficacy is increased by at least 10%, 20%, or 30% compared to when the same amount of the primary fungicide is applied alone. In some embodiments, fungicidal efficacy is increased by at least 50%, 100%, 200% or 300% compared to when the same amount of the primary fungicide is applied alone.

In some embodiments, fungicidal efficacy is measured in a treated area of the plant. In some embodiments, fungicidal efficacy is measured in an untreated area of the plant. In some embodiments, fungicidal efficacy is increased in a treated area of the plant. In some embodiments, fungicidal efficacy is increased in an untreated area of the plant.

In some embodiments, fungicidal efficacy is measured 10 days after treatment. In some embodiments, fungicidal efficacy is measured at least 10 days after treatment. In some embodiments, fungicidal efficacy is measured at least 21 days after treatment. In some embodiments, fungicidal efficacy is measured at least 28 days after treatment.

In some embodiments, the amount of the phthalimide fungicide is effective to increase sensitivity of the fungus to the amount of the primary fungicide compared to the sensitivity of the fungus to the amount of the primary fungicide when it is applied not in combination with the amount of the phthalimide fungicide, so as to thereby improve the fungicidal efficacy of the amount of the primary fungicide. The present invention provides a method of increasing sensitivity of a fungus to an amount of a primary fungicide comprising applying a combination of an amount of a phthalimide fungicide and the amount of the primary fungicide to the fungus, so as to thereby increase sensitivity of the fungus to the amount of the primary fungicide.

In some embodiments, the amount of the phthalimide fungicide is effective to increase bioavailability of the amount of the primary fungicide compared to the bioavailability of the amount of the primary fungicide when it is applied not in combination with the amount of the phthalimide fungicide, so as to thereby improve the fungicidal efficacy of the amount of the primary fungicide. In some embodiments, the method increases the bioavailability the amount of the primary fungicide in the roots. In some embodiments, the method increases the bioavailability of the amount of the primary fungicide in the leaves. The present invention provides a method of increasing bioavailability of an amount of a primary fungicide to a plant comprising applying a combination of an amount of a phthalimide fungicide and the amount of the primary fungicide to the plant, so as to thereby increase bioavailability of the amount of the primary fungicide.

Increasing bioavailability includes increasing penetration of the amount of the primary fungicide into the plant. The primary fungicide may penetrate into the plant by penetrating into leaves (including penetrating leaf cuticle) and/or roots. In some embodiments, applying the amount of the primary fungicide in combination with the amount of the phthalimide fungicide increases penetration of the amount of the primary fungicide into the plant. In some embodiments, applying the amount of the primary fungicide in combination with the amount of the phthalimide fungicide increases penetration of the amount of the primary fungicide into the plant leaf. In some embodiments, applying the amount of the primary fungicide in combination with the amount of the phthalimide fungicide increases penetration of the primary fungicide into the plant root. The present invention provides a method of increasing penetration of an amount of a primary fungicide into a plant comprising applying a combination of an amount of a phthalimide fungicide and the amount of the primary fungicide to the plant, so as to thereby increase penetration of the amount of the primary fungicide into the plant.

Increasing bioavailability also includes increased translocation of the amount of the primary fungicide once inside the plant, including leaves. In some embodiments, applying the amount of the primary fungicide in combination with the amount of the phthalimide fungicide increases translocation of the amount of the primary fungicide after penetration into the plant. The present invention provides a method of increasing translocation of an amount of a primary fungicide in a plant comprising applying a combination of an amount of a phthalimide fungicide and the amount of the primary fungicide to the plant, so as to thereby increase translocation of the amount of the primary fungicide in the plant.

In some embodiments, treating a plant or soil against fungal infection comprises inhibiting fungal mycelium formation. The present invention also provides a method of inhibiting fungal mycelium formation comprising applying a combination of an amount of a phthalimide fungicide and an amount of a primary fungicide to the fungus, so as to thereby inhibit fungal mycelium formation.

In some embodiments, treating a plant or locus against fungal infection comprises combating phytopathogenic diseases on the plant or locus. The present invention also provides a method of combating phytopathogenic diseases on a plant or locus which comprises applying to the plant or to the locus a combination of a phthalimide fungicide and a primary fungicide. In some embodiments, the plant is a crop plant.

In some embodiments, treating the plant or locus against fungal infection comprises protecting the plant or locus from fungal attack.

In some embodiments, treating the plant or locus against fungal infection comprises preventing fungal infection of the plant or locus.

In some embodiments, treating the plant or locus against fungal infection comprises controlling fungal disease affecting the plant or locus.

In some embodiments, treating the plant or locus against fungal infection comprises controlling a fungal pathogen, a fungal pathogen group or a fungal pathogen class affecting the plant or locus.

In some embodiments, treating the plant or locus against fungal infection comprises controlling a fungal disease caused by a fungal pathogen, a fungal pathogen group or a fungal pathogen class affecting the plant or locus.

In some embodiments, treating the plant or locus against fungal infection comprises reducing fungal infection of the plant or locus.

In some embodiments, the method is effective for prolonging the period of protection against fungal infection and/or control of fungal infection than when the amount of the phthalimide fungicide and the amount of a primary fungicide are applied alone. The present invention also provides a method of prolonging the period of protection against fungal infection and/or control of fungal infection from an application of an amount of a primary fungicide to a plant or locus comprising applying a combination of an amount of a phthalimide fungicide and the amount of the primary fungicide to the plant or locus. In some embodiments, the plant is a crop plant.

In some embodiments, the period of protection against fungal infection and/or control of fungal infection is prolonged by at least 7 days, 14 day, 21 days, or 28 days.

In some embodiments, the method is effective for reducing the amount of time needed to achieve a level of fungal control compared to when the amount of the phthalimide fungicide and the amount of a primary fungicide are applied alone. The present invention also provides a method of reducing the amount of time needed to achieve a level of fungal control from an application of an amount of primary fungicide to a plant or locus comprising applying a combination of an amount of a phthalimide fungicide and the amount of the primary fungicide to the plant or locus.

An example for reduction is, if each fungicide is applied alone achieves 50% control of fungal disease 7 days after application, the method disclosed herein achieves 50% control of fungal diseases 2 days after application where each fungicide is applied at the amount.

In some embodiments, the amount of time needed to achieve a level of fungal control is reduced by at least 1 day, 2 days, 3 days, 4 day, 5 days, 7 days, 10 days, 14 days or 21 days, or 28 days.

In some embodiments, the method is effective for improving plant development compared to the development of a plant affected by the same type and degree of fungal infection to which the combination is not applied. The present invention also provides a method of improving development of a plant affected by fungal infection comprising applying a combination of a phthalimide fungicide and a primary fungicide to the plant or a locus thereof so as to improve the development of the plant compared to the development of a plant affected by the same type and degree of fungal infection to which the combination is not applied. In some embodiments, the plant is a crop plant.

In some embodiments, the plant development is improved by treating the plant against fungal attack.

In some embodiments, improving plant development comprises enhancing crop plants. In some embodiment, improving plant development comprises improving plant quality.

Improving plant development includes, but is not limited to, enhancing the root systems, enhancing shoot of the plant, enhancing plant vigor, enhancing greening effect on leaves and/or enhancing plant potential yield.

In some embodiments, improving plant development comprises enhancing the root system. In some embodiments, enhancement in root system is measured by root weight. In some embodiments, root weight is increased by at least 1%, 5%, 10, 20%, 30%, 40%, 50%, 60%, 70%, 80%, or 90%.

In some embodiments, improving plant development comprises enhancing shoot of the plant. In some embodiments, enhancement in shoot is measured by shoot weight. In some embodiments, shoot weight is increased by at least 1%, 5%, 10, 20%, 30%, 40%, 50%, 60%, 70%, 80%, or 90%.

In some embodiments, improving plant development comprises enhancing plant vigor. In some embodiments, plant vigor is assessed using the relative vigor index. In some embodiments, plant vigor is increased by at least 1%, 5%, 10, 20%, 30%, 40%, 50%, 60%, 70%, 80%, or 90%.

In some embodiments, improving plant development comprises enhancing greening effect on leaves. In some embodiments, greening effect on leaves is assessed using the relative vigor index. In some embodiments, greening effect on leaves is increased by at least 1%, 5%, or 10%.

In some embodiments, improving plant development comprises enhancing plant yield. In some embodiments, plant yield is increased by at least 1%, 5%, 10, 20%, 30%, 40%, 50%, 60%, 70%, 80%, or 90%.

In some embodiments, the combination is more effective in treating the plant or locus against fungal infection than when each fungicide at the same amount is applied alone.

In some embodiments, the combination comprises one or more primary fungicide(s) and the combination of the phthalimide fungicide and at least one of the primary fungicides applied is more effective in treating the plant or soil against fungal infection than when each fungicide at the same amount is applied alone. In some embodiments, the combination comprises two or more primary fungicides and the combination of the phthalimide fungicide and at least two of the primary fungicides applied is more effective in treating the plant or soil against fungal infection than when each fungicide at the same amount is applied alone.

In some embodiments, the combination is more effective in treating the plant or locus against fungal infection than when the primary fungicide at the same amount is applied alone.

In some embodiments, the amount of phthalimide fungicide applied is less than the fungicidally effective amount of the phthalimide fungicide when the phthalimide fungicide is applied alone.

In some embodiments, the amount of the primary fungicide applied is less than the fungicidally effective amount of the primary fungicide when the primary fungicide is applied not in combination with the phthalimide fungicide.

In some embodiments, the method is effective for improving potentiated efficacy, improving long lasting effect, improving anti-resistance activity, improving activity against resistant strains, improving green leaf area, improving greening effect, increasing disease spectrum of activity, increasing efficacy against disease not controlled by the solo fungicides, increasing yield, increasing protein content, increasing sugar content, increasing °Brix, improving color grading of fruits, increasing thousand kernels weight, increasing test weight or hectoliter weight, increasing fruit size, increasing number of marketable fruits, improving plant vigor, and/or reducing risks of adverse effects on plants.

### Preferred Phthalimide Fungicides, Primary Fungicides and Combinations

### i) Preferred Phthalimide Fungicides

In some embodiments, the phthalimide fungicide is selected from the group consisting of captan, folpet, captafol, and any combination thereof. In some embodiments, the phthalimide fungicide is captan. In some embodiments, the phthalimide fungicide is folpet. In some embodiments, the phthalimide fungicide is captafol.

In some embodiments, the phthalimide fungicide is not folpet. In some embodiments, the phthalimide fungicide is other than folpet. In some embodiments, the method is free of application of folpet.

### ii) Preferred Primary Fungicides

In some embodiments, the primary fungicide is selected from the group consisting of pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide, or inorganic fungicide and any combination thereof.

In some embodiments, the primary fungicide is pyrimidinone fungicide. In some embodiments, the primary fungicide is QiI (quinone inside inhibitors). In some embodiments, the primary fungicide is QoI (quinone outside inhibitors). In some embodiments, the primary fungicide is SDHI (succinate dehydrogenase inhibitors). In some embodiments, the primary fungicide is DMI fungicide (demethylation inhibitor fungicide). In some embodiments, the primary fungicide is OSBPI (oxysterol binding protein inhibitor). In some embodiments, the primary fungicide is amine fungicide. In some embodiments, the primary fungicide is tetrazolyloxime fungicide. In some embodiments, the primary fungicide is inorganic fungicide.

In some embodiments, the inorganic fungicide is selected from the group consisting of copper, sulphur and a combination thereof.

In some embodiments, the QiI (quinone inside inhibitors) is selected from the group consisting of amisulbrom, cyazofamid, fenpicoxamid and any combination thereof.

In some embodiments, the QiI (quinone inside inhibitors) is amisulbrom. In some embodiments, the QiI (quinone inside inhibitors) is cyazofamid. In some embodiments, the QiI (quinone inside inhibitors) is fenpicoxamid.

In some embodiments, the QoI (quinone outside inhibitors) is selected from the group consisting of azoxystrobin, kresoxim-methyl, picoxystrobin, fluxastrobin, dimoxystrobin, pyraclostrobin, trifloxystrobin, coumoxystrobin, fenaminstrobin, pyrametostrobin, triclopyricarb, pyribencarb, pyraoxystrobin, metyltetraprole, mandestrobin, famoxadone, oryzastrobin, enoxastrobin, pyraclostrobin, fluoxastrobin, flufenostrin, flufenoxystrobin, metominostrobin, triclopyricarb; pyriminostrobin, florylpicoxamid, and any combination thereof.

In some embodiments, the QoI (quinone outside inhibitors) is metyltetraprole. In some embodiments, the QoI (quinone outside inhibitors) is mandestrobin.

In some embodiments, the SDHI (succinate dehydrogenase inhibitors) fungicide is selected from the group consisting of fluxapyroxad, penflufen, bixafen, isopyrazam, sedaxane, benzovindiflupyr, thifluzamide, isofetamid, fluopyram, pydiflumetofen, pyraziflumid, flutolanil, carboxin, boscalid, fluindapyr, penthiopyrad, isoflucypram inpyrfluxam, furametpyr, benodanil, mepronil, fenfuram, oxycarboxin, pyrapropoyne, flubeneteram, quinofumelin and any combination thereof.

In some embodiments, the SDHI (succinate dehydrogenase inhibitors) is fluxapyroxad.

In some embodiments, the SDHI (succinate dehydrogenase inhibitors) is fluopyram.

In some embodiments, the SDHI (succinate dehydrogenase inhibitors) is pydiflumetofen.

In some embodiments, the SDHI (succinate dehydrogenase inhibitors) fungicide is different from fluxapyroxad. In some embodiments, the SDHI (succinate dehydrogenase inhibitors) fungicide is not fluxapyroxad. In some embodiments, the SDHI (succinate dehydrogenase inhibitors) fungicide is other than fluxapyroxad. In some embodiments, the method is free of application of fluxapyroxad.

In some embodiments, the demethylation inhibitor fungicide (DMI fungicide) is selected from the group consisting of ipconazole, tebuconazole, metconazole, fenbuconazole, bromuconazole, tetraconazole, flutriafol, penconazole, difenoconazole, prothioconazole, epoxiconazole, mefentrifluconazole, triticonazole, imazalil, prochloraz, lobutanil, azaconazole, etaconazole, bitertanol, fluquinconazole, myclobutanil, flusilazole, cyproconazole, triadimenol, hexaconazole, simeconazole, imibenconazole, diniconazole, pyrisoxazole and any combination thereof.

In some embodiments, the demethylation inhibitor fungicide (DMI fungicide) is mefentrifluconazole.

In some embodiments, the demethylation inhibitor fungicide (DMI fungicide) is prothioconazole.

In some embodiments, the demethylation inhibitor fungicide (DMI fungicide) is not tebuconazole. In some embodiments, the demethylation inhibitor fungicide (DMI fungicide) is other than tebuconazole. In some embodiments, the method is free of application of tebuconazole.

In some embodiments, OSBPI fungicide includes piperidinyl thiazole isoxazoline fungicide.

In some embodiments, the OSBPI fungicide is selected from the group consisting of fluoxapiprolin, oxathiapiprolin and a combination thereof.

In some embodiments, the OSBPI fungicide is fluoxapiprolin.

In some embodiments, the OSBPI fungicide is oxathiapiprolin.

In some embodiments, the amine fungicide is selected from the group consisting of fenpropidin, spiroxamine and any combination thereof. In some embodiments, the amine fungicide is a morpholine fungicide.

In some embodiments, the amine fungicide is fenpropidin.

In some embodiments, the tetrazolyloxime fungicide is picarbutrazox.

In some embodiments, the piperidinyl thiazole isoxazoline fungicide is fluoxapiprolin. In some embodiments, the piperidinyl thiazole isoxazoline fungicide is oxathiapiprolin.

In some embodiments, the phenylpyridinamine fungicide is fluazinam.

In some embodiments, the fluoropyrimidinone fungicide is 5-fluoro-4-imino-3-methyl-1-tosyl-3,4-dihydropyrimidin-2(1H)-one of the Formula I (ADF-16)

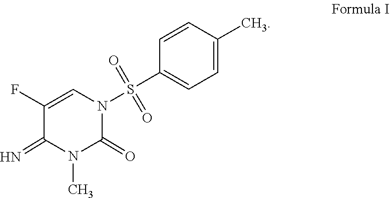 [SMILES: Cc1ccc(S(=O)(=O)n2cc(F)c(=N)n(C)c2=O)cc1]

In some embodiments, the combination comprises a QiI fungicide (quinone inside inhibitors). In some embodiments, the amount of the QiI fungicide in the mixture or composition is less than the fungicidally effective amount of the QiI fungicide when the QiI fungicide is used alone.

In some embodiments, the combination comprises a QoI fungicide (quinone outside inhibitors). In some embodiments, the amount of the QoI fungicide (quinone outside inhibitors) in the combination is less than the fungicidally effective amount of the QoI fungicide (quinone outside inhibitors) when the QoI fungicide (quinone outside inhibitors) is used alone.

In some embodiments, the combination comprises a QoSI fungicide (quinone outside stigmatellin subsite inhibitors). In some embodiments, the amount of the QoSI fungicide (quinone outside stigmatellin subsite inhibitors) in the combination is less than the fungicidally effective amount of the QoSI fungicide (quinone outside stigmatellin subsite inhibitors) when the QoSI fungicide (quinone outside stigmatellin subsite inhibitors) is used alone.

In some embodiments, the combination comprises a SDHI fungicide (succinate dehydrogenase inhibitors). In some embodiments, the amount of the SDHI fungicide (succinate dehydrogenase inhibitors) in the combination is less than the fungicidally effective amount of the SDHI fungicide (succinate dehydrogenase inhibitors) when the SDHI fungicide (succinate dehydrogenase inhibitors) is used alone.

In some embodiments, the combination comprises an amine fungicide. In some embodiments, the amount of the amine fungicide in the combination is less than the fungicidally effective amount of the amine fungicide when the amine fungicide is used alone.

In some embodiments, the combination comprises a tetrazolyloxime fungicide. In some embodiments, the amount of the tetrazolyloxime fungicide in the combination is less than the fungicidally effective amount of the tetrazolyloxime fungicide when the tetrazolyloxime fungicide is used alone.

In some embodiments, the combination comprises an oxysterol binding protein inhibitor (OSBPI) fungicide. In some embodiments, the amount of the oxysterol binding protein inhibitor (OSBPI) fungicide in the combination is less than the fungicidally effective amount of the oxysterol binding protein inhibitor (OSBPI) fungicide when the oxysterol binding protein inhibitor (OSBPI) fungicide is used alone.

In some embodiments, the combination comprises a pyrimidinone fungicide. In some embodiments, the amount of the pyrimidinone fungicide in the combination is less than the fungicidally effective amount of the pyrimidinone fungicide when the pyrimidinone fungicide is used alone.

In some embodiments, the pyrimidinone fungicide is fluoropyrimidinone fungicide. In some embodiments, fluoropyrimidinone fungicide is 5-fluoro-4-imino-3-methyl-1-tosyl-3,4-dihydropyrimidin-2(1H)-one of the Formula I (ADF-16)

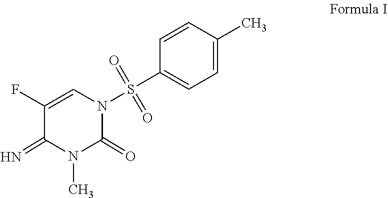 [SMILES: Cc1ccc(S(=O)(=O)n2cc(F)c(=N)n(C)c2=O)cc1]

In some embodiments, the combination or mixture comprises captan and 5-fluoro-4-imino-3-methyl-1-tosyl-3,4-dihydropyrimidin-2(1H)-one to treat fungal pathogen selected from the group consisting of Colletotrichum sp. or Ascochyta rabiei on pulses, Colletotrichum truncatum on chili, Phakopsora pachyrhizi or Corynespora cassiicola on soybean, Mycosphaerella fijiensis or Pseudocercospora musae on banana, Puccinia recondite, Fusarium sp., Ramularia collo-cygni, ZymoSeptoria tritici, or Puccinia striiformis on cereals, Colletotrichum kahawae or Hemileia vastatrix on Coffee, Pseudoperonospora cubensis on cucurbits, Plasmopara viticola on grape, Alternaria sp. or Phytophthora infestans on tomatoes and potatoes, Cercospora zeae-maydis or Cochliobolus heterostrophus on corn, Cercospora beticola, Ramularia beticola or Uromyces betae on sugar beet, Setosphaeria turcica or Cochliobolus carbonum on corn, Ramularia areola on cotton, Pyricularia oryzae or Rhizoctonia solani/Thanatephorus cucumeris on rice, Venturia inaequalis on pome fruit, ramularia on barley, Spilocea oleagina on Olive or Sclerotinia sclerotiorum on OSR.

In some embodiments, the combination or mixture comprises folpet and 5-fluoro-4-imino-3-methyl-1-tosyl-3,4-dihydropyrimidin-2(1H)-one to treat fungal pathogen selected from the group consisting of Colletotrichum sp. or Ascochyta rabiei on pulses, Colletotrichum truncatum on chili, Phakopsora pachyrhizi or Corynespora cassiicola on soybean, Mycosphaerella fijiensis or Pseudocercospora musae on banana, Puccinia recondite, Fusarium sp., Ramularia collo-cygni, ZymoSeptoria tritici, or Puccinia striiformis on cereals, Colletotrichum kahawae or Hemileia vastatrix on Coffee, Pseudoperonospora cubensis on cucurbits, Plasmopara viticola on grape, Alternaria sp. or Phytophthora infestans on tomatoes and potatoes, Cercospora zeae-maydis or Cochliobolus heterostrophus on corn, Cercospora beticola, Ramularia beticola or Uromyces betae on sugar beet, Setosphaeria turcica or Cochliobolus carbonum on corn, Ramularia areola on cotton, Pyricularia oryzae or Rhizoctonia solani/Thanatephorus cucumeris on rice, Venturia inaequalis on pome fruit, ramularia on barley, Spilocea oleagina on Olive or Sclerotinia sclerotiorum on OSR.

In some embodiments, the combination or mixture comprises captafol and 5-fluoro-4-imino-3-methyl-1-tosyl-3,4-dihydropyrimidin-2(1H)-one to treat fungal pathogen selected from the group consisting of Colletotrichum sp. or Ascochyta rabiei on pulses, Colletotrichum truncatum on chili, Phakopsora pachyrhizi or Corynespora cassiicola on soybean, Mycosphaerella fijiensis or Pseudocercospora musae on banana, Puccinia recondite, Fusarium sp., Ramularia collo-cygni, ZymoSeptoria tritici, or Puccinia striiformis on cereals, Colletotrichum kahawae or Hemileia vastatrix on Coffee, Pseudoperonospora cubensis on cucurbits, Plasmopara viticola on grape, Alternaria sp. or Phytophthora infestans on tomatoes and potatoes, Cercospora zeae-maydis or Cochliobolus heterostrophus on corn, Cercospora beticola, Ramularia beticola or Uromyces betae on sugar beet, Setosphaeria turcica or Cochliobolus carbonum on corn, Ramularia areola on cotton, Pyricularia oryzae or Rhizoctonia solani/Thanatephorus cucumeris on rice, Venturia inaequalis on pome fruit, ramularia on barley, Spilocea oleagina on Olive or Sclerotinia sclerotiorum on OSR.

In some embodiments, the combination or mixture comprises phthalimide fungicide and 5-fluoro-4-imino-3-methyl-1-tosyl-3,4-dihydropyrimidin-2(1H)-one, further comprises at least one additional orimary fungicide to treat fungal pathogen selected from the group consisting of Colletotrichum sp. or Ascochyta rabiei on pulses, Colletotrichum truncatum on chili, Phakopsora pachyrhizi or Corynespora cassiicola on soybean, Mycosphaerella fijiensis or Pseudocercospora musae on banana, Puccinia recondite, Fusarium sp., Ramularia collo-cygni, ZymoSeptoria tritici, or Puccinia striiformis on cereals, Colletotrichum kahawae or Hemileia vastatrix on Coffee, Pseudoperonospora cubensis on cucurbits, Plasmopara viticola on grape, Alternaria sp. or Phytophthora infestans on tomatoes and potatoes, Cercospora zeae-maydis or Cochliobolus heterostrophus on corn, Cercospora beticola, Ramularia beticola or Uromyces betae on sugar beet, Setosphaeria turcica or Cochliobolus carbonum on corn, Ramularia areola on cotton, Pyricularia oryzae or Rhizoctonia solani/Thanatephorus cucumeris on rice, Venturia inaequalis on pome fruit, ramularia on barley, Spilocea oleagina on Olive or Sclerotinia sclerotiorum on OSR.

In some embodiments, the combination or mixture comprises folpet and 5-fluoro-4-imino-3-methyl-1-tosyl-3,4-dihydropyrimidin-2(1H)-one to treat fungal pathogen selected from the group consisting of Colletotrichum sp. or Ascochyta rabiei on pulses, Colletotrichum truncatum on chili, Phakopsora pachyrhizi or Corynespora cassiicola on soybean, Mycosphaerella fijiensis or Pseudocercospora musae on banana, Puccinia recondite, Fusarium sp., Ramularia collo-cygni, ZymoSeptoria tritici, or Puccinia striiformis on cereals, Colletotrichum kahawae or Hemileia vastatrix on Coffee, Pseudoperonospora cubensis on cucurbits, Plasmopara viticola on grape, Alternaria sp. or Phytophthora infestans on tomatoes and potatoes, Cercospora zeae-maydis or Cochliobolus heterostrophus on corn, Cercospora beticola, Ramularia beticola or Uromyces betae on sugar beet, Setosphaeria turcica or Cochliobolus carbonum on corn, Ramularia areola on cotton, Pyricularia oryzae or Rhizoctonia solani/Thanatephorus cucumeris on rice, Venturia inaequalis on pome fruit, ramularia on barley, Spilocea oleagina on Olive or Sclerotinia sclerotiorum on OSR.

In some embodiments, the combination or mixture comprises phthalimide fungicide with two primary fungicides.

In some embodiments, the combination or mixture comprises folpet with two primary fungicides. Adding two primary embodiments here.

iii) Preferred Combinations of Primary Fungicides

In some embodiments, the method comprises applying a combination comprising at least two primary fungicides.

In some embodiments, one of the primary fungicides is an SDHI fungicide.

In some embodiments, one of the primary fungicides is fluxapyroxad.

Preferred combinations of phthalimide fungicide(s) and primary fungicide(s) are described herein. Any combination comprising phthalimide fungicide(s) and primary fungicide(s) of the present invention may be used with the methods of the present invention.

### iv) Preferred Combinations Comprising Phthalimide Fungicide(s) and Primary Fungicide(s)

In some embodiments, the combination comprises a phthalimide fungicide and a primary fungicide selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, sulphur, prothioconazole, and any combination thereof.

In some embodiments, the combination comprises a phthalimide fungicide and mefentrifluconazole. In some embodiments, the combination comprises a phthalimide fungicide and mandestrobin. In some embodiments, the combination comprises a phthalimide fungicide and metyltetraprole. In some embodiments, the combination comprises a phthalimide fungicide and pydiflumetofen. In some embodiments, the combination comprises a phthalimide fungicide and fluopyram. In some embodiments, the combination comprises a phthalimide fungicide and fluxapyroxad. In some embodiments, the combination comprises a phthalimide fungicide and fenpicoxamid. In some embodiments, the combination comprises a phthalimide fungicide and picarbutrazox. In some embodiments, the combination comprises a phthalimide fungicide and fluoxapiprolin. In some embodiments, the combination comprises a phthalimide fungicide and fenpropidin. In some embodiments, the combination comprises a phthalimide fungicide and prothioconazole.

In some embodiments, the combination comprises captan and a succinate dehydrogenase inhibitor fungicide. In some embodiments, the combination comprises folpet and a succinate dehydrogenase inhibitor fungicide. In some embodiments, the combination comprises captafol and a succinate dehydrogenase inhibitor fungicide. In some embodiments, the combination comprises folpet and fluxapyroxad. In some embodiments, the combination comprises captan and fluxapyroxad. In some embodiments, the combination comprises captafol and fluxapyroxad. In some embodiments, the combination comprises folpet and fluopyram. In some embodiments, the combination comprises folpet and mefentrifluconazole.

In some embodiments, the combination comprises a phthalimide fungicide and a succinate dehydrogenase inhibitor fungicide as the only crop protection agents. In some embodiments, the combination comprises captan and a succinate dehydrogenase inhibitor fungicide as the only crop protection agents.

TABLE A
Folpet or Captan with One Primary Fungicides

| | Phthalimide | Primary Fungicides |
|---|---|---|
| 1 | Folpet | Formula I |
| 2 | Folpet | Fenpicoxamid |
| 3 | Folpet | Fenpropidin |
| 4 | Folpet | Fluopyram |
| 5 | Folpet | Fluoxapiprolin |
| 6 | Folpet | Fluxapyroxad |
| 7 | Folpet | Mandestrobin |
| 8 | Folpet | Mefentrifluconazole |
| 9 | Folpet | Metyltetraprole |
| 10 | Folpet | Picarbutrazox |
| 11 | Folpet | Prothioconazole |
| 12 | Folpet | Pydiflumetofen |
| 13 | Folpet | Sulphur |
| 14 | Folpet | Fluazinam |
| 15 | Captan | Formula I |
| 16 | Captan | Fenpicoxamid |
| 17 | Captan | Fenpropidin |
| 18 | Captan | Fluopyram |
| 19 | Captan | Fluoxapiprolin |
| 20 | Captan | Fluxapyroxad |
| 21 | Captan | Mandestrobin |
| 22 | Captan | Mefentrifluconazole |
| 23 | Captan | Metyltetraprole |
| 24 | Captan | Picarbutrazox |
| 25 | Captan | Prothioconazole |
| 26 | Captan | Pydiflumetofen |
| 27 | Captan | Sulphur |
| 28 | Captan | Fluazinam |

In some embodiments, the combination is any one of the combinations of folpet and primary fungicide listed in Table A.

In some embodiments, the combination is any one of the combinations of captan and primary fungicide listed in Table A.

TABLE B
Folpet or Captan with Two Primary Fungicides.

| | | First Primary | Second Primary |
|---|---|---|---|
| | Phthalimide | Fungicides | fungicides |
| 1 | Folpet | ADF-16 | Fenpicoxamid |
| 2 | Folpet | Fenpicoxamid | Fenpropidin |
| 3 | Folpet | Fenpropidin | Fluazinam |
| 4 | Folpet | Fluazinam | Fluopyram |
| 5 | Folpet | Fluopyram | Fluoxapiprolin |
| 6 | Folpet | Fluoxapiprolin | Fluxapyroxad |
| 7 | Folpet | Fluxapyroxad | Mandestrobin |
| 8 | Folpet | Mandestrobin | Mefentrifluconazole |
| 9 | Folpet | Mefentrifluconazole | Metyltetraprole |
| 10 | Folpet | Metyltetraprole | Picarbutrazox |
| 11 | Folpet | Picarbutrazox | Pydiflumetofen |
| 12 | Folpet | Pydiflumetofen | Sulphur |
| 13 | Folpet | Sulphur | ADF-16 |
| 14 | Captan | ADF-16 | Fenpicoxamid |
| 15 | Captan | Fenpicoxamid | Fenpropidin |
| 16 | Captan | Fenpropidin | Fluazinam |
| 17 | Captan | Fluazinam | Fluopyram |
| 18 | Captan | Fluopyram | Fluoxapiprolin |
| 19 | Captan | Fluoxapiprolin | Fluxapyroxad |
| 20 | Captan | Fluxapyroxad | Mandestrobin |
| 21 | Captan | Mandestrobin | Mefentrifluconazole |
| 22 | Captan | Mefentrifluconazole | Metyltetraprole |
| 23 | Captan | Metyltetraprole | Picarbutrazox |
| 24 | Captan | Picarbutrazox | Pydiflumetofen |
| 25 | Captan | Pydiflumetofen | Sulphur |
| 26 | Captan | Sulfur | ADF-16 |

In some embodiments, the combination comprises folpet and at least two primary fungicides.

In some embodiments, the combination comprises captan and at least two primary fungicides.

In some embodiments, the combination is any one of the combinations of folpet and two primary fungicides listed in Table B.

In some embodiments, the combination is any one of the combinations of captan and two primary fungicides listed in Table B.

In some embodiments, the combination comprises (i) folpet, (ii) any one of the fungicides listed in the column of First Primary Fungicides in Table B, and (iii) any one of the fungicides listed in the column of Second Primary Fungicides in Table B.

In some embodiments, the combination comprises (i) captan, (ii) any one of the fungicides listed in the column of First Primary Fungicides in Table B, and (iii) any one of the fungicides listed in the column of Second Primary Fungicides in Table B.

In some embodiments, the two primary fungicides are fenpropidin and an SDHI fungicide. In some embodiments, the two primary fungicides are fenpropidin and a QoI fungicide.

In some embodiments, the combination comprises two or more primary fungicides from different fungicidal groups. In some embodiments, the combination comprises two or more primary fungicides from the same fungicidal group.

In some embodiments, the phthalimide fungicide is not folpet. In some embodiments, the phthalimide fungicide is other than folpet. In some embodiments, the combination is free of folpet.

In some embodiments, the SDHI (succinate dehydrogenase inhibitors) fungicide is not fluxapyroxad. In some embodiments, the SDHI (succinate dehydrogenase inhibitors) fungicide is other than fluxapyroxad. In some embodiments, the combination is free of fluxapyroxad.

In some embodiments, the demethylation inhibitor fungicide (DMI fungicide) is not tebuconazole. In some embodiments, the demethylation inhibitor fungicide (DMI fungicide) is other than tebuconazole. In some embodiments, the combination is free of tebuconazole.

In some embodiments, the phthalimide fungicide is folpet and the primary fungicide is not SDHI fungicide. In some embodiments, the phthalimide fungicide is folpet and the primary fungicide is other than SDHI fungicide.

In some embodiments, the combination comprises (a) a phthalimide fungicide, (b) pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide, or inorganic fungicide and any combination thereof, and (c) pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide, or inorganic fungicide and any combination thereof.

In some embodiments, the combination comprises a phthalimide fungicide, fluxapyroxad, and at least one additional primary fungicide that is not fluxapyroxad. In some embodiments, the combination comprises a phthalimide fungicide, fluxapyroxad, and at least one additional primary fungicide other than fluxapyroxad.

### v) Fungicide I

In some embodiments, the primary fungicide is a systemic fungicide.

In some embodiments, the systemic fungicide is fungicide I.

In some embodiments, fungicide I is selected from the group consisting of succinate dehydrogenase inhibitor (SDHI) fungicides, demethylation inhibitor (DMI) fungicides, quinone outside inhibitor (QoI) fungicides, and any combination thereof. In some embodiments, fungicide I is a succinate dehydrogenase inhibitor (SDHI) fungicide. In some embodiments, fungicide I is a demethylation inhibitor (DMI) fungicide. In some embodiments, fungicide I is a quinone outside inhibitor (QoI) fungicide. Preferred succinate dehydrogenase inhibitor (SDHI) fungicides, demethylation inhibitor (DMI) fungicides, and quinone outside inhibitor (QoI) fungicides are described herein.

It was found that fungicide I selected from the group consisting of succinate dehydrogenase inhibitor (SDHI) fungicides, demethylation inhibitor (DMI) fungicides, quinone outside inhibitor (QoI) fungicides, and combination thereof, if combined with at least one phthalimide fungicide have an increased efficacy, including an increased controlling effect, against disease(s) caused by pathogen in crop plants.

In some embodiments, fungicide I is selected from the group consisting of fluxapyroxad, mefentrifluconazole, fluopyram, and any combination thereof. In some embodiments, fungicide I is fluxapyroxad. In some embodiments, the fungicide I is mefentrifluconazole. In some embodiments, the fungicide I is fluopyram.

### Preferred Combinations Comprising Phthalimide Fungicide(s) and Fungicide I

In some embodiments, the phthalimide fungicide is folpet and fungicide I is fluopyram. In some embodiments, the phthalimide fungicide is folpet and fungicide I is fluxapyroxad. In some embodiments, the phthalimide fungicide is folpet and fungicide I is mefentrifluconazole.

### Preferred Weight Ratios

In some embodiments, the weight ratio between the total amount of the phthalimide fungicide(s) to the total amount of the primary fungicide(s) is from 150:1 to 1:150. In some embodiments, the weight ratio between the total amount of the phthalimide fungicide(s) to the total amount of the primary fungicide(s) is from 100:1 to 1:100. In some embodiments, the weight ratio between the total amount of the phthalimide fungicide(s) to the total amount of the primary fungicide(s) is from 50:1 to 1:50. In some embodiments, the weight ratio between the total amount of the phthalimide fungicide(s) to the total amount of the primary fungicide(s) is from 20:1 to 1:1. In some embodiments, the weight ratio between the total amount of the phthalimide fungicide(s) to the total amount of the primary fungicide(s) is from 10:1 to 1:1. In some embodiments, the weight ratio between the total amount of the phthalimide fungicide(s) to the total amount of the primary fungicide(s) is from 5:1 to 1:1. In some embodiments, the weight ratio between the total amount of the phthalimide fungicide(s) to the total amount of the primary fungicide(s) is from 2:1 to 1:1.

In some embodiments, the weight ratio between the total amount of the phthalimide fungicide(s) to the total amount of the primary fungicide(s) is any one of the following: 125:1 to 1:1, 95:1 to 1:1, 90:1 to 1:1, 85:1 to 1:1, 80:1 to 1:1, 75:1 to 1:1, 70:1 to 1:1, 65:1 to 1:1, 60:1 to 1:1, 55:1 to 1:1, 45:1 to 1:1, 40:1 to 1:1, 35:1 to 1:1, 30:1 to 1:1, 25:1 to 1:1, 15:1 to 1:1, 12:1 to 1:1, 10:1 to 1:1, 5:1 to 1:1, 4:1 to 1:1, 3:1 to 1:1 or 2:1 to 1:1.

In some embodiments, the weight ratio between the total amount of the phthalimide fungicide(s) to the total amount of the first and second primary fungicide(s) is any one of the following 125:1 to 1:1, 95:1 to 1:1, 90:1 to 1:1, 85:1 to 1:1, 80:1 to 1:1, 75:1 to 1:1, 70:1 to 1:1, 65:1 to 1:1, 60:1 to 1:1, 55:1 to 1:1, 45:1 to 1:1, 40:1 to 1:1, 35:1 to 1:1, 30:1 to 1:1, 25:1 to 1:1, 15:1 to 1:1, 12:1 to 1:1, 10:1 to 1:1, 5:1 to 1:1, 4:1 to 1:1, 3:1 to 1:1 or 2:1 to 1:1

In some embodiments, the weight ratio between the total amount of the phthalimide fungicide(s) to the total amount of the primary fungicide(s) is any one of the following: 125:1 to 1:125, 95:1 to 1:95, 90:1 to 1:90, 85:1 to 1:85, 80:1 to 1:80, 75:1 to 1:75, 70:1 to 1:70, 65:1 to 1:65, 60:1 to 1:60, 55:1 to 1:55, 45:1 to 1:45, 40:1 to 1:40, 35:1 to 1:35, 30:1 to 1:30, 25:1 to 1:25, 15:1 to 1:15, 12:1 to 1:12, 10:1 to 1:10, 5:1 to 1:5, 4:1 to 1:4, 3:1 to 1:3 or 2:1 to 1:2.

In some embodiments, the weight ratio between the total amount of the phthalimide fungicide(s) to the total amount of the primary fungicide(s) is about 10:1 to 1:1. In some embodiments, the weight ratio between the total amount of the phthalimide fungicide(s) to the total amount of the primary fungicide(s) is about 1:1 to 15:1.

In some embodiments, the weight ratio between the total amount of the phthalimide fungicide(s) to the total amount of the primary fungicide(s) is about 75:1. In some embodiments, the weight ratio between the total amount of the phthalimide fungicide(s) to the total amount of the primary fungicide(s) is about 20:1. In some embodiments, the weight ratio between the total amount of the phthalimide fungicide(s) to the total amount of the primary fungicide(s) is about 18:1. In some embodiments, the weight ratio between the total amount of the phthalimide fungicide(s) to the total amount of the primary fungicide(s) is about 12:1. In some embodiments, the weight ratio between the total amount of the phthalimide fungicide(s) to the total amount of the primary fungicide(s) is about 10:1. In some embodiments, the weight ratio between the total amount of the phthalimide fungicide(s) to the total amount of the primary fungicide(s) is about 8.3:1. In some embodiments, the weight ratio between the total amount of the phthalimide fungicide(s) to the total amount of the primary fungicide(s) is about 8:1. In some embodiments, the weight ratio between the total amount of the phthalimide fungicide(s) to the total amount of the primary fungicide(s) is about 7.5:1. In some embodiments, the weight ratio between the total amount of the phthalimide fungicide(s) to the total amount of the primary fungicide(s) is about 6:1. In some embodiments, the weight ratio between the total amount of the phthalimide fungicide(s) to the total amount of the primary fungicide(s) is about 5:1. In some embodiments, the weight ratio between the total amount of the phthalimide fungicide(s) to the total amount of the primary fungicide(s) is about 4:1. In some embodiments, the weight ratio between the total amount of the phthalimide fungicide(s) to the total amount of the primary fungicide(s) is about 3.75:1. In some embodiments, the weight ratio between the total amount of the phthalimide fungicide(s) to the total amount of the primary fungicide(s) is about 3:1. In some embodiments, the weight ratio between the total amount of the phthalimide fungicide(s) to the total amount of the primary fungicide(s) is about 2.5:1. In some embodiments, the weight ratio between the total amount of the phthalimide fungicide(s) to the total amount of the primary fungicide(s) is about 2:1. In some embodiments, the weight ratio between the total amount of the phthalimide fungicide(s) to the total amount of the primary fungicide(s) is about 1.67:1. In some embodiments, the weight ratio between the total amount of the phthalimide fungicide(s) to the total amount of the primary fungicide(s) is about 1:1.

The weight ratio between the total amount of the phthalimide fungicide(s) to the total amount of the primary fungicide(s) may be an intermediate range selected from the above indicated ratios.

The weight ratios described herein may be used with any phthalimide fungicide(s), primary fungicide(s), and combinations thereof described herein.

In a preferred embodiment, the primary fungicide is fenpropidin and the weight ratio between the total amount of the phthalimide fungicide(s) to Fenpropidin is 3:1, 3.75:1, or 4.5:1.

In a preferred embodiment, the primary fungicide is fenpropidin and the weight ratio between the total amount of folpet to fenpropidin is 3:1, 3.75:1, or 4.5:1.

In a preferred embodiment, the primary fungicide is fenpropidin and the weight ratio between the total amount of captan to fenpropidin is 3:1, 3.75:1, or 4.5:1.

In a preferred embodiment, the primary fungicide is fluopyram and the weight ratio between the total amount of the phthalimide fungicide(s) to Fenpropidin is 5:1 or 6:1.

In a preferred embodiment, the primary fungicide is fluopyram and the weight ratio between the total amount of folpet to fluopyram is 5:1 or 6:1.

In a preferred embodiment, the primary fungicide is fluopyram and the weight ratio between the total amount of captan to fluopyram is 5:1 or 6:1.

In a preferred embodiment, the primary fungicide is fluxapyroxad and the weight ratio between the total amount of the phthalimide fungicide(s) to fluxapyroxad is 12:1, 16:1 or 20:1.

In a preferred embodiment, the primary fungicide is fluxapyroxad and the weight ratio between the total amount of folpet to fluxapyroxad is 12:1, 16:1 or 20:1.

In a preferred embodiment, the primary fungicide is fluxapyroxad and the weight ratio between the total amount of captan to fluxapyroxad is 12:1, 16:1 or 20:1.

In a preferred embodiment, the primary fungicide is a succinate dehydrogenase inhibitor fungicide and the weight ratio between the phthalimide fungicide(s) and the succinate dehydrogenase inhibitor fungicide is any one of the ratios and ranges described above.

The weight ratio of the succinate dehydrogenase inhibitor fungicide to captan, captafol or folpet may be an intermediate range selected from the above indicated ratios.

In some embodiments, the succinate dehydrogenase inhibitor fungicide is fluxapyroxad. In some embodiments, the combination comprises fluxapyroxad and captan. In some embodiments, the combination comprises fluxapyroxad and captafol. In some embodiments, the combination comprises fluxapyroxad and folpet. The weight ratio between the fluxapyroxad and the captan, captafol or folpet may be any one of the ratios and ranges described above, or an intermediate range selected from the above indicated ratios.

In some embodiments, the succinate dehydrogenase inhibitor fungicide is fluopyram. In some embodiments, the combination comprises fluopyram and captan. In some embodiments, the combination comprises fluopyram and captafol. In some embodiments, the combination comprises fluopyram and folpet. The weight ratio between the fluopyram and the captan, captafol or folpet may be any one of the ratios and ranges described above, or an intermediate range selected from the above indicated ratios.

In some embodiments, the primary fungicide is 5-fluoro-4-imino-3-methyl-1-tosyl-3,4-dihydropyrimidin-2(1H)-one. In some embodiments, the combination comprises 5-fluoro-4-imino-3-methyl-1-tosyl-3,4-dihydropyrimidin-2(1H)-one and captan. In some embodiments, the combination comprises 5-fluoro-4-imino-3-methyl-1-tosyl-3,4-dihydropyrimidin-2(1H)-one and captafol. In some embodiments, the combination comprises 5-fluoro-4-imino-3-methyl-1-tosyl-3,4-dihydropyrimidin-2(1H)-one and folpet. The weight ratio between the 5-fluoro-4-imino-3-methyl-1-tosyl-3,4-dihydropyrimidin-2(1H)-one and the captan, captafol or folpet may be any one of the ratios and ranges described above, or an intermediate range selected from the above indicated ratios.

In some embodiments, the weight ratio of phthalimide fungicide and the 5-fluoro-4-imino-3-methyl-1-tosyl-3,4-dihydropyrimidin-2(1H)-one is from 150:1 to 1:150. In some embodiments, the weight ratio of phthalimide fungicide and the 5-fluoro-4-imino-3-methyl-1-tosyl-3,4-dihydropyrimidin-2(1H)-one is from 100:1 to 1:100. In some embodiments, the weight ratio of phthalimide fungicide and the 5-fluoro-4-imino-3-methyl-1-tosyl-3,4-dihydropyrimidin-2(1H)-one is from 75:1 to 1:75. In some embodiments, the weight ratio of phthalimide fungicide and the 5-fluoro-4-imino-3-methyl-1-tosyl-3,4-dihydropyrimidin-2(1H)-one is 1:1. In some embodiments, the weight ratio between the phthalimide fungicide and the 5-fluoro-4-imino-3-methyl-1-tosyl-3,4-dihydropyrimidin-2(1H)-one is about 75:1. In some embodiments, the weight ratio between the phthalimide fungicide and the 5-fluoro-4-imino-3-methyl-1-tosyl-3,4-dihydropyrimidin-2(1H)-one is about 10:1.

In some embodiments, the primary fungicide is fungicide I. In some embodiments, the combination comprises a phthalimide fungicide and fungicide I. The weight ratio between the phthalimide fungicide and fungicide I may be any one of the ratios and ranges described above, or an intermediate range selected from the above indicated ratios.

In some embodiments, the weight ratio of the phthalimide to the fungicide I is from about 1:1 to 15:1. In some embodiments, the weight ratio of the phthalimide fungicide to the fungicide I is about 1.67:1. In some embodiments, the weight ratio of the phthalimide fungicide to the fungicide I is about 20:1. In some embodiments, the weight ratio of the phthalimide fungicide to the fungicide I is about 18:1. In some embodiments, the weight ratio of the phthalimide fungicide to the fungicide I is about 12:1. In some embodiments, the weight ratio of the phthalimide fungicide to the fungicide I is about 10:1. In some embodiments, the weight ratio of the phthalimide fungicide to the fungicide I is about 8.3:1. In some embodiments, the weight ratio of the phthalimide fungicide to the fungicide I is about 8:1. In some embodiments, the weight ratio of the phthalimide fungicide to the fungicide I is about 7.5:1. In some embodiments, the weight ratio of the phthalimide fungicide to the fungicide I is about 6:1. In some embodiments, the weight ratio of the phthalimide fungicide to the fungicide I is about 5:1. In some embodiments, the weight ratio of the phthalimide fungicide to the fungicide I is about 4:1. In some embodiments, the weight ratio of the phthalimide to the fungicide I is about 3.75:1. In some embodiments, the weight ratio of the phthalimide fungicide to the fungicide I is about 3:1. In some embodiments, the weight ratio of the phthalimide to the fungicide I is about 2.5:1. In some embodiments, the weight ratio of the phthalimide to the fungicide I is about 2:1. In some embodiments, the weight ratio of the phthalimide to the fungicide I is about 1:1.

### Preferred Parameters for Application

In some embodiments, each of the phthalimide fungicide(s) and primary fungicide(s) is formulated in its own composition. In some embodiments, each of the phthalimide fungicide(s) and primary fungicide(s) is formulated in its own composition prior to application.

The components of the combination can be applied either separately or as part of a multipart fungicidal system. Consequently, the methods and uses disclosed herein include preparation of the combination, mixture and composition from the component parts prior to application or use.

In some embodiments, the phthalimide fungicide and the primary fungicide are prepared separately, and the individual formulations are applied as is, or are diluted to predetermined concentrations. In some embodiments, the phthalimide fungicide and the primary fungicides are prepared separately, and the formulations are mixed when are diluted to a predetermined concentration. In some embodiment, the phthalimide fungicide and the primary fungicides are formulated together, and the formulation is applied as it is, or the formulation is diluted to a predetermined concentration.

In some embodiments, the phthalimide fungicide(s) and primary fungicide(s) are applied together. In some embodiments, the phthalimide fungicide(s) and primary fungicide(s) are applied separately. In some embodiments, the phthalimide fungicide(s) and primary fungicide(s) are applied simultaneously. In some embodiments, the phthalimide fungicide(s) and primary fungicide(s) are applied contemporaneously. In some embodiments, the phthalimide fungicide(s) and primary fungicide(s) are applied successively.

In some embodiments, the phthalimide fungicide(s) is applied an amount of time before the primary fungicide(s) is applied. In some embodiments, the phthalimide fungicide(s) is applied an amount of time before at least one of the primary fungicide(s) is applied. In some embodiments, the primary fungicide(s) is applied an amount of time before the phthalimide fungicide(s) is applied. In some embodiments, the primary fungicide(s) is applied an amount of time before at least one of the phthalimide fungicide(s) is applied.

In some embodiments, the amount of time between application is between 1 to 28 days. In some embodiments, the amount of time between application is between 1 to 14 days. In some embodiments, the amount of time between application is between 1 to 10 days. In some embodiments, the amount of time between application is between 1 to 7 days. In some embodiments, the amount of time between application is 1 to 5 days. In some embodiments, the amount of time between application is between 1 to 72 hours. In some embodiments, the amount of time between application is between 1 to 48 hours. In some embodiments, the amount of time between application is between 1 to 24 hours. In some embodiments, the amount of time between application is between 1 to 12 hours. In some embodiments, the amount of time between application is between 1 to 10 hours. In some embodiments, the amount of time between application is between 1 to 5 hours. In some embodiments, the amount of time between application is between 1 to 2 hours. In some embodiments, the amount of time between application is less than 1 hour. In some embodiments, the amount of time between application is less than 30 minutes.

In some embodiments, the primary fungicide is fungicide I and the phthalimide fungicide is applied prior to application of fungicide I. In some embodiments, the phthalimide fungicide is applied day(s) or hour(s) before the application of fungicide I.

In some embodiments, the phthalimide fungicide is applied at least 1 day prior to application of fungicide I. In some embodiments, the phthalimide fungicide is applied at least 2 day prior to application of fungicide I. In some embodiments, the phthalimide fungicide is applied at least 3 day prior to application of fungicide I. In some embodiments, the phthalimide fungicide is applied at least 4 day prior to application of fungicide I. In some embodiments, the phthalimide fungicide is applied at least 5 day prior to application of fungicide I. In some embodiments, the phthalimide fungicide is applied at least 6 day prior to application of fungicide I. In some embodiments, the phthalimide fungicide is applied at least 7 day prior to application of fungicide I. In some embodiments, the phthalimide fungicide is applied at least 8 day prior to application of fungicide I. In some embodiments, the phthalimide fungicide is applied at least 9 day prior to application of fungicide I. In some embodiments, the phthalimide fungicide is applied at least 10 day prior to application of fungicide I. In some embodiments, the phthalimide fungicide is applied at least 11 day prior to application of fungicide I. In some embodiments, the phthalimide fungicide is applied at least 12 day prior to application of fungicide I. In some embodiments, the phthalimide fungicide is applied at least 13 day prior to application of fungicide I. In some embodiments, the phthalimide fungicide is applied at least 14 days prior to application of fungicide I.

In some embodiments, the phthalimide fungicide and fungicide I are applied 1 to 28 days apart. In some embodiments, the phthalimide fungicide and fungicide I are applied between 1 to 14 days apart. In some embodiments, the phthalimide fungicide and fungicide I are applied between 1 to 10 days apart. In some embodiments, the phthalimide fungicide and fungicide I are applied between 1 to 7 days apart. In some embodiments, the phthalimide fungicide and fungicide I are applied between 1 to 5 days apart. In some embodiments, the phthalimide fungicide and fungicide I are applied between 1 to 5 hours apart.

Number and rates of application depend on the biological and climatic environment of the pathogen. Alternatively, the active ingredients can reach the plant from the soil or water via the root system (systemic action) by drenching the locus of the plant with a liquid preparation (for example in rice growing) or incorporating the substances into the soil in solid form, for example in the form of granules (soil application). The inventive combination can also be applied to seed kernels for the purposes of seed treatment (coating), either by soaking the roots or kernels in succession with a liquid preparation of an active ingredient or by coating them with a moist or dry preparation which already comprises the combination. In addition, other types of application to plants are possible in specific cases, for example the targeted treatment of buds or fruit-bearing parts of the plant.

The amount of the combination to be applied and/or the weight ratio between the phthalimide fungicide and the primary fungicide, will depend on various factors such as the compound employed, the subject of the treatment (plant, soil, seed), the type of treatment (e.g. spraying, dusting, seed dressing), the purpose of the treatment (prophylactic or therapeutic), the type of fungi to be treated and the application time.

In some embodiments, the phthalimide fungicide(s) and primary fungicide(s) are applied at least one time during a growth season. In some embodiments, the phthalimide fungicide(s) and primary fungicide(s) are applied two or more times during a growth season.

In some embodiments, the phthalimide fungicide(s) and primary fungicide(s) are applied as a soil application, as a foliar application, as seed treatment and any combination thereof. In some embodiments, the phthalimide fungicide(s) and primary fungicide(s) are applied as a soil application. In some embodiments, the phthalimide fungicide(s) and primary fungicide(s) are applied as a foliar application. In some embodiments, the phthalimide fungicide(s) and primary fungicide(s) are applied as seed treatment. In some embodiments, the phthalimide fungicide(s) and primary fungicide(s) are applied to plant leaves. In some embodiments, the phthalimide fungicide(s) and primary fungicide(s) are applied to plant propagation material.

In some embodiments, the phthalimide fungicide(s) and primary fungicide(s) are applied as curative treatment, preventive treatment, persistence treatment and any combination thereof. In some embodiments, the phthalimide fungicide(s) and primary fungicide(s) are applied as curative treatment. In some embodiments, the phthalimide fungicide(s) and primary fungicide(s) are applied as preventive treatment. In some embodiments, the phthalimide fungicide(s) and primary fungicide(s) are applied as persistence treatment.

In some embodiments, the phthalimide fungicide(s) and primary fungicide(s) are applied before infection by harmful fungal pathogen. In some embodiments, the phthalimide fungicide(s) and primary fungicide(s) are applied after infection by harmful fungal pathogen. In some embodiments, the phthalimide fungicide(s) and primary fungicide(s) are applied before and after infection by harmful fungal pathogen.

In some embodiments, the phthalimide fungicide(s) and primary fungicide(s) are applied in the early stages of the crop cycle. In some embodiments, the phthalimide fungicide(s) and primary fungicide(s) are applied during the Tl stage of growth of cereals, from BBCH 31 to 33. The phthalimide fungicide(s) and primary fungicide(s) when applied at early stages of growth protects the plant or locus against infection by harmful fungi.

In an embodiment, the succinate dehydrogenase inhibitor fungicide and phthalimide fungicide can be applied in the early stages of the crop cycle, such as for example pre-sowing or post-sowing of the crop. In a specific embodiment, a mixture of fluxapyroxad and phthalimide fungicide can be applied in the early stages of the crop cycle. The mixture of fluxapyroxad may be applied during the Tl stage of growth. The early application can allow phthalimide fungicide to provide early protection during the early stages of growth and the SDHI, for example fluxapyroxad, to provide long lasting protectant efficacy. The phthalimide fungicide may be folpet, captan, captafol or any combination thereof.

The mixture of active substances can be diluted and applied in a customary manner, for example by watering (drenching), drip irrigation, spraying, and atomizing.

The rate at which the combination according to the invention is applied will depend upon the particular type of fungus to be controlled, the degree of control required and the timing and method of application. The effective application rates of the succinate dehydrogenase inhibitor fungicide and phthalimide fungicide cannot generally be defined, as it varies depending upon various conditions such as the type of the formulation, weather conditions, the type of crop and the type of pests.

In some embodiments, the combination is applied at a rate from 0.1 grams of total active ingredient per hectare (g a.i./ha) to 10000 g a.i./ha based on the total amount of active ingredients in the combination. In some embodiments, the combination is applied at a rate from about 10 g a.i./ha to about 10000 g a.i./ha. In some embodiments, the combination is applied at a rate from about 50 g a.i./ha to about 5000 g a.i./ha. In some embodiments, the combination is applied at a rate from about 50 g a.i./ha to about 2600 g a.i./ha. In some embodiments, the combination is applied at a rate from about 100 g a.i./ha to about 2500 g a.i./ha. In some embodiments, the combination is applied at a rate from about 50 g a.i./ha to about 2000 g a.i./ha. In some embodiments, the combination is applied at a rate from about 25 g a.i./ha to about 2000 g a.i./ha. In some embodiments, the combination is applied at a rate from about 100 g a.i./ha to about 750 g a.i./ha. In an embodiment, the combination is applied at a rate from about 60 g a.i./ha to about 600 g a.i./ha. In a more particular embodiment, the combination is applied at a rate from about 100 g a.i./ha to about 200 g a.i./ha. In a more particular embodiment, the combination is applied at a rate from about 100 g a.i./ha to about 130 g a.i./ha.

In some embodiments, the combination, if applied as soil application, is to be applied at a rate between 0.1 to 10000 g/ha. In some embodiments, the combination, if applied as soil application, is to be applied at a rate between 1 to 5000 g/ha. In some embodiments, the combination, if applied as soil application, is to be applied at a rate between 60 to 2600 g/ha.

In some embodiments, the combination, if applied as seed treatment, is to be applied at a rate between 2 g per 100 kg to 400 g per 100 kg of seed. In some embodiments, the combination, if applied as seed treatment, is to be applied at a rate between 2.5 g per 100 kg to 50 g per 100 kg of seed. In some embodiments, the combination, if applied as seed treatment, is to be applied at a rate between 2.5 g per 100 kg to 25 g per 100 kg of seed.

The application rates for phthalimide fungicide are generally from 1 to 5000 g/ha, preferably from 10 to 2500 g/ha, in particular from 20 to 1000 g/ha. In some embodiments, the application rates of phthalimide fungicide may be from 400 to 1500 g/ha. In some embodiments, the application rates of phthalimide fungicide may be from 500 to 1500 g/ha. In some embodiments, the phthalimide fungicide is applied at a rate between 500 to 1000 g/ha. In some embodiments, the phthalimide fungicide is applied at a rate between 700 to 800 g/ha. In some embodiments, the phthalimide fungicide is applied at a rate of 750 g/ha. In some embodiments, the phthalimide fungicide is applied at a rate between 450 to 550 g/ha. In some embodiments, the phthalimide fungicide is applied at a rate of 500 g/ha.

In some embodiments, the phthalimide fungicide(s) is applied at a rate between 10-400 g a.i./ha. In some embodiments, the phthalimide fungicide(s) is applied at a rate between 30-400 g a.i./ha. In some embodiments, the phthalimide fungicide(s) is applied at a rate between 100-400 g a.i./ha. In some embodiments, the phthalimide fungicide(s) is applied at a rate of 300 g a.i./ha. In some embodiments, the phthalimide fungicide(s) is applied at a rate of 250 g a.i./ha. In some embodiments, the phthalimide fungicide(s) is applied at a rate between 50-200 g a.i./ha. In some embodiments, the phthalimide fungicide(s) is applied at a rate between 100-200 g a.i./ha. In some embodiments, the phthalimide fungicide(s) is applied at a rate of less than 200 g a.i./ha. In some embodiments, the phthalimide fungicide(s) is applied at a rate of 200 g a.i./ha. In some embodiments, the phthalimide fungicide(s) is applied at a rate of 150 g a.i./ha. In some embodiments, the phthalimide fungicide(s) is applied at a rate of 100 g a.i./ha. In some embodiments, the phthalimide fungicide(s) is applied at a rate of 75 g a.i./ha. In some embodiments, the phthalimide fungicide(s) is applied at a rate of 30 g a.i./ha.

In some embodiments, the phthalimide fungicide(s) is applied at a rate between 0.0001 to 10000 ppm. In some embodiments, the phthalimide fungicide(s) is applied at a rate between 1 to 10000 ppm. In some embodiments, the phthalimide fungicide(s) is applied at a rate between 10 to 1000 ppm. In some embodiments, the phthalimide fungicide(s) is applied at a rate between 0.0001 to 0.5 ppm. In some embodiments, the phthalimide fungicide(s) is applied at a rate between 0.0005 to 0.3 ppm. In some embodiments, the phthalimide fungicide(s) is applied at a rate of about 0.0005 ppm. In some embodiments, the phthalimide fungicide(s) is applied at a rate between 0.005 to 0.03 ppm. In some embodiments, the phthalimide fungicide(s) is applied at a rate of about 0.002 ppm. In some embodiments, the phthalimide fungicide(s) is applied at a rate of about 0.06 ppm. In some embodiments, the phthalimide fungicide(s) is applied at a rate of about 0.3 ppm.

The application rates for captafol are generally from 1 to 5000 g/ha, preferably from 10 to 2500 g/ha, in particular from 20 to 1000 g/ha. In some embodiments, the application rates of captafol may be from 500 to 1500 g a.i/ha.

In some embodiments, the application rates for captan are generally from 1 to 5000 ga.i./ha, preferably from 10 to 2500 ga.i./ha, in particular from 20 to 1000 g/ha. In some embodiment, the application rates of captan may be from 500 to 1500 ga.i./ha. In some embodiments, the application rates of captan may be from 400 to 1500 g/ha.

In some embodiments, the application rates for folpet are generally from 1 to 5000 g a.i./ha, preferably from 10 to 2500 g a.i./ha, in particular from 20 to 1000 g/ha. In some embodiments, the application rates of folpet may be from 2000 to 5000 g a.i./ha. In some embodiments, the application rates of folpet may be from 500 to 1500 g a.i./ha. In some embodiments, the application rates of folpet may be from 400 to 1500 g/ha. In some embodiments, folpet is applied at a rate of 750 g/ha.

In some embodiments, the primary fungicide(s) is applied at a rate of 100-2000 g a.i./ha.

In some embodiments, the multi-site contact fungicide is applied at a rate of 500-1500 g a.i./ha. In some embodiments, the multi-site contact fungicide is applied at a rate of 1000-1500 g a.i./ha. In some embodiments, the multi-site contact fungicide is applied at a rate of 1000-1200 g a.i./ha. In some embodiments, the multi-site contact fungicide is applied at a rate of 1125 g a.i./ha. In some embodiments, the multi-site contact fungicide is applied at a rate of 1000 g a.i./ha. In some embodiments, the multi-site contact fungicide is applied at a rate of 1000-1250 g a.i./ha. In some embodiments, the multi-site contact fungicide is applied at a rate of 250-1000 g a.i./ha. In some embodiments, the multi-site contact fungicide is applied at a rate of 500-1000 g a.i./ha. In some embodiments, the multi-site contact fungicide is applied at a rate of 250-750 g a.i./ha. In some embodiments, the multi-site contact fungicide is applied at a rate of 500-750 g a.i./ha.

In some embodiments, the multi-site contact fungicide is applied at a rate between 0.0001 to 10000 ppm. In some embodiments, the multi-site contact fungicide is applied at a rate between 0.003 to about 0.01 ppm. In some embodiment, the multi-site contact fungicide is applied at a rate of about 0.003 ppm. In some embodiment, the multi-site contact fungicide is applied at a rate of about 0.01 ppm.

In some embodiments, the application rates for the succinate dehydrogenase inhibitor fungicide are generally from 1 to 1000 g a.i./ha, preferably from 10 to 900 g a.i./ha, in particular from 20 to 750 g a.i./ha. In some embodiments, the application rates of a succinate dehydrogenase inhibitor fungicide such as fluxapyroxad may be from 20 to 250 g a.i./ha.

In some embodiments, the SDHI fungicide is applied at a rate between 0.0001 to 10000 ppm. In some embodiments, the SDHI fungicide is applied at a rate between 0.00005 to about 0.1 ppm. In some embodiments, the SDHI fungicide is applied at a rate between 0.0001 to about 0.07 ppm. In some embodiments, the SDHI fungicide is applied at a rate of about 0.0001 ppm. In some embodiments, the SDHI fungicide is applied at a rate of about 0.0006 ppm. In some embodiments, the SDHI fungicide is applied at a rate of about 0.003 ppm. In some embodiments, the SDHI fungicide is applied at a rate of about 0.01 ppm. In some embodiments, the SDHI fungicide is applied at a rate of about 0.07 ppm.

The application rates for the succinate dehydrogenase inhibitor fungicide are generally from 1 to 1000 g/ha, preferably from 10 to 900 g/ha, in particular from 20 to 250 g/ha.

In some embodiments, the SDHI fungicide is applied at a rate between 20 to 250 g/ha. In some embodiments, the SDHI fungicide is applied at a rate between 20 to 150 g/ha. In some embodiments, the SDHI fungicide is applied at a rate between 50 to 100 g/ha. In some embodiments, the SDHI fungicide is applied at a rate of 62.5 g/ha. In some embodiments, the SDHI fungicide is applied at a rate of 90 g/ha.

The application rates for the DMI fungicide are generally from 1 to 1000 g/ha, preferably from 10 to 900 g/ha, in particular from 20 to 750 g/ha. In some embodiments, the DMI fungicide is applied at a rate between 20 to 450 g/ha.

In some embodiments, the DMI fungicide is applied at a rate between 300 to 600 g/ha. In some embodiments, the DMI fungicide is applied at a rate between 360 to 450 g/ha. In some embodiments, the DMI fungicide is applied at a rate between 400 to 500 g/ha. In some embodiments, the DMI fungicide is applied at a rate of 450 g/ha.

The application rates for the quinone outside inhibitor fungicide are generally from 1 to 1000 g/ha, preferably from 50 to 250 g/ha, in particular from 90 to 150 g/ha.

In some embodiments, the QoI fungicide is applied at a rate between 50 to 250 g/ha. In some embodiments, the QoI fungicide is applied at a rate between 90 to 200 g/ha. In some embodiments, the QoI fungicide is applied at a rate between 90 to 150 g/ha. In some embodiments, the QoI fungicide is applied at a rate of 150 g/ha. In some embodiments, the QoI fungicide is applied at a rate of 125 g/ha. In some embodiments, the QoI fungicide is applied at a rate of 90 g/ha. In some embodiments, the QoI fungicide is applied at a rate between 200 to 500 g/ha. In some embodiments, the QoI fungicide is applied at a rate of 200 g/ha. In some embodiments, the QoI fungicide is applied at a rate of 250 g/ha. In some embodiments, the QoI fungicide is applied at a rate of 500 g/ha.

The effective application rates of fungicide I and the phthalimide fungicide cannot generally be defined, as it varies depending upon various conditions such as the type of the formulation, weather conditions, the type of crop and the type of pests. The application rates of fungicide I and the phthalimide fungicide may also vary, depending on the desired effect.

In an embodiment, the application rate of fungicide I and the phthalimide fungicide combined is from 10 g/ha to 10000 g/ha. In an embodiment, the application rate of fungicide I and the phthalimide fungicide combined is from 50 to 5000 g/ha. In some embodiments, the application rate of fungicide I and the phthalimide fungicide combined is from 100 to 2500 g/ha. In some embodiments, the application rate of fungicide I and the phthalimide fungicide combined is from 500 to 1500 g/ha. In some embodiments, the application rate of fungicide I and the phthalimide fungicide combined is from 800 to 1200 g/ha.

In some embodiments, the application rate of the SDHI fungicide and the phthalimide fungicide combined is from 500 to 1000 g/ha. In some embodiments, the application rate of the SDHI fungicide and the phthalimide fungicide combined is from 800 to 850 g/ha. In some embodiments, the application rate of the SDHI fungicide and the phthalimide fungicide combined is 812.5 g/ha. In some embodiments, the application rate of the SDHI fungicide and the phthalimide fungicide combined is 840 g/ha.

In some embodiments, the application rate of the DMI fungicide and the phthalimide fungicide combined is from 1000 to 1500 g/ha. In some embodiments, the application rate of the DMI fungicide and the phthalimide fungicide combined is from 1100 to 1300 g/ha. In some embodiments, the application rate of the DMI fungicide and the phthalimide fungicide combined is 1200 g/ha.

In some embodiments, the application rate of the QoI fungicide and the phthalimide fungicide combined is from 500 to 1500 g/ha. In some embodiments, the application rate of the DMI fungicide and the phthalimide fungicide combined is from 500 to 1000 g/ha. In some embodiments, the application rate of the DMI fungicide and the phthalimide fungicide combined is from 890 to 900 g/ha. In some embodiments, the application rate of the DMI fungicide and the phthalimide fungicide combined is from 750 to 1000 g/ha. In some embodiments, the application rate of the DMI fungicide and the phthalimide fungicide combined is 700 g/ha. In some embodiments, the application rate of the DMI fungicide and the phthalimide fungicide combined is 750 g/ha. In some embodiments, the application rate of the DMI fungicide and the phthalimide fungicide combined is 875 g/ha. In some embodiments, the application rate of the DMI fungicide and the phthalimide fungicide combined is 900 g/ha. In some embodiments, the application rate of the DMI fungicide and the phthalimide fungicide combined is 950 g/ha. In some embodiments, the application rate of the DMI fungicide and the phthalimide fungicide combined is 1000 g/ha.

In some embodiments, the method comprises applying a fungicide in addition to the phthalimide fungicide(s) and the primary fungicide(s).

In some embodiments, the plant includes cultivated plants which tolerate the action of herbicides, fungicides or insecticides as a result of breeding and/or genetically engineered methods.

In yet another embodiment, the plant is pulses, chili, olive, barley, cereals, pulses, grape, pome fruit, oilseed rape (OSR), cucurbits, rice, corn, banana, tomatoes, potatoes, cotton, soybean, coffee, or sugar beet.

Target crops for the areas of indication disclosed herein comprise the following species of plants: cereals (wheat, barley, rye, oats, rice, sorghum and related crops); beet (sugar beet and fodder beet); pomes, stone fruit and soft fruit (apples, pears, plums, peaches, almonds, cherries, strawberries, raspberries and blackberries); leguminous plants (beans, lentils, peas, soybeans); cucumber plants (marrows, cucumbers, melons); fibre plants (cotton, flax, hemp, jute); citrus fruit (oranges, lemons, grapefruit, mandarins); vegetables (spinach, lettuce, asparagus, cabbages, carrots, onions, tomatoes, potatoes, paprika); lauraceae (avocados, cinnamon, camphor); or plants such as maize, tobacco, nuts, coffee, sugar cane, tea, vines, hops, bananas and natural rubber plants. This list does not represent any limitation.

The target crops include but are not limited to pulses, chili, olive, barley, cereals, pulses, grape, pome fruit, oilseed rape (OSR), cucurbits, rice, corn, banana, tomatoes, potatoes, cotton, soybean, coffee, or sugar beet.

In some embodiments, the plant is cereals. In some embodiments, the plant is grape. In some embodiments, the plant is banana. In some embodiments, the plant is corn. In some embodiments, the plant is cotton. In some embodiments, the plant is sugar beet. In some embodiments, the plant is rice. In some embodiments, the plant is cucurbits. In some embodiments, the plant is pome fruit. In some embodiments, the plant is oilseed rape (OSR). In some embodiments, the plant is potato. In some embodiments, the plant is pulses. In some embodiments, the plant is coffee. In some embodiments, the plant is soybean.

Fungicide I is used for controlling disease in broad spectrum of plants, the plants include pulses, chili, olive, barley, cereals, pulses, grape, pome fruit, oilseed rape (OSR), cucurbits, rice, corn, banana, tomatoes, potatoes, cotton, soybean, coffee, or sugar beet.

In some embodiments, the plant is a crop and the method is effective for increasing yield.

In some embodiments, the plant is a crop and the method is effective for having a greening effect.

In some embodiments, the fungal infection causes a fungal disease.

The fungicidal combination, mixture or compositions according to the invention are effective against a broad spectrum of phytopathogenic fungi, especially the ones belonging to the following classes: Black sigatoka (Mycosphaerella fijiensis), Septoria (ZymoSeptoria tritici), Ramularia leaf spot (Ramularia collo-cygni), Gray Leaf Spot (Cercospora zeae-maydis), Ramularia leaf spot (Ramularia areola), leaf spot of beet (Cercospora beticola), Ramularia leaf spot (Ramularia beticola), Yellow sigatoka (Pseudocercospora musae), Rizoctonia (Rhizoctonia solani/Thanatephorus cucumeris), Damping off/root rot (Rhizoctonia solani/Thanatephorus cucumeris), Rizoctonia (Rhizoctonia solani/Thanatephorus cucumeris), Sclerotinia (Sclerotinia sclerotiorum), Sclerotinia stem rot or white mold (Sclerotinia sclerotiorum), Leaf blotch of cereals (Rhynchosporium secalis), Fusarium head blight (Fusarium sp.), Maize Ear and Kernel Rot (Fusarium sp.), Downy mildew (Pseudoperonospora cubensis), Downy mildew (Plasmopara viticola), Late blight (Phytophthora infestans), Coffee Berry Disease (Colletotrichum kahawae), Anthracnose (Colletotrichum sp.), Target spot (Corynespora cassiicola), Northern Corn Leaf Blight (Setosphaeria turcica), Southern corn leaf blight (Cochliobolus heterostrophus), Northern Corn Leaf Spot (Cochliobolus carbonum), Alternaria blotch of apple (Alternaria mali/Alternaria sp.), Early blight (Alternaria sp.), Alternaria Late blight (Alternaria sp.), Brown spot (Alternaria alternata), Leaf spot (Alternaria sp.), (Venturia inaequalis), Coffee Leaf Rust (Hemileia vastatrix), Asian soybean Rust (Phakopsora pachyrhizi), Yellow Rust (Puccinia striiformis), Rust (Uromyces betae), Rice Blast (Pyricularia oryzae).

Fungicide I is used for controlling a broad spectrum of phytopathogenic fungi. For example, the phytopathogenic fungi may be one or more of Colletotrichum sp. or Ascochyta rabiei on pulses, Colletotrichum truncatum on chili, Phakopsora pachyrhizi or Corynespora cassiicola on soybean, Mycosphaerella fijiensis or Pseudocercospora musae on banana, Puccinia recondite, Fusarium sp., Ramularia collo-cygni, ZymoSeptoria tritici, or Puccinia striiformis on cereals, Colletotrichum kahawae or Hemileia vastatrix on Coffee, Pseudoperonospora cubensis on cucurbits, Plasmopara viticola on grape, Alternaria sp. or Phytophthora infestans on tomatoes and potatoes, Cercospora zeae-maydis or Cochliobolus heterostrophus on corn, Cercospora beticola, Ramularia beticola or Uromyces betae on sugar beet, Setosphaeria turcica or Cochliobolus carbonum on corn, Ramularia areola on cotton, Pyricularia oryzae or Rhizoctonia solani/Thanatephorus cucumeris on rice, Venturia inaequalis on pome fruit, ramularia on barley, Spilocea oleagina on Olive or Sclerotinia sclerotiorum on OSR.

In some embodiments, the disease is Ramularia leaf spot in barley (Ramularia collo-cygni).

The fungal pathogen is one or more of Colletotrichum sp. or Ascochyta rabiei on pulses, Colletotrichum truncatum on chili, Phakopsora pachyrhizi or Corynespora cassiicola on soybean, Mycosphaerella fijiensis or Pseudocercospora musae on banana, Puccinia recondite, Fusarium sp., Ramularia collo-cygni, ZymoSeptoria tritici, or Puccinia striiformis on cereals, Colletotrichum kahawae or Hemileia vastatrix on Coffee, Pseudoperonospora cubensis on cucurbits, Plasmopara viticola on grape, Alternaria sp. or Phytophthora infestans on tomatoes and potatoes, Cercospora zeae-maydis or Cochliobolus heterostrophus on corn, Cercospora beticola, Ramularia beticola or Uromyces betae on sugar beet, Setosphaeria turcica or Cochliobolus carbonum on corn, Ramularia areola on cotton, Pyricularia oryzae or Rhizoctonia solani/Thanatephorus cucumeris on rice, Venturia inaequalis on pome fruit, ramularia on barley, Spilocea oleagina on Olive or Sclerotinia sclerotiorum on OSR.

In some embodiments, the fungal pathogen is Mycosphaerella fijiensis. In some embodiments, the fungal pathogen is ZymoSeptoria tritici. In some embodiments, the fungal pathogen is Ramularia collo-cygni. In some embodiments, the fungal pathogen is Cercospora zeae-maydis. In some embodiments, the fungal pathogen is Ramularia areola. In some embodiments, the fungal pathogen is Cercospora beticola. In some embodiments, the fungal pathogen is Ramularia beticola. In some embodiments, the fungal pathogen is Rhizoctonia solani/Thanatephorus cucumeris. In some embodiments, the fungal pathogen is Sclerotinia sclerotiorum. In some embodiments, the fungal pathogen is Fusarium sp. In some embodiments, the fungal pathogen is Pseudoperonospora cubensis. In some embodiments, the fungal pathogen is Plasmopara viticola. In some embodiments, the fungal pathogen is Phytophthora infestans. In some embodiments, the fungal pathogen is Phytophthora infestans. In some embodiments, the fungal pathogen is Colletotrichum kahawae. In some embodiments, the fungal pathogen is Colletotrichum sp. In some embodiments, the fungal pathogen is Setosphaeria turcica. In some embodiments, the fungal pathogen is Cochliobolus heterostrophus. In some embodiments, the fungal pathogen is Cochliobolus carbonum. In some embodiments, the fungal pathogen is Alternaria sp. In some embodiments, the fungal pathogen is Venturia inaequalis. In some embodiments, the fungal pathogen is Alternaria sp. In some embodiments, the fungal pathogen is Alternaria sp. In some embodiments, the fungal pathogen is Puccinia striiformis. In some embodiments, the fungal pathogen is Hemileia vastatrix. In some embodiments, the fungal pathogen is Phakopsora pachyrhizi. In some embodiments, the fungal pathogen is Uromyces betae. In some embodiments, the fungal pathogen is Pyricularia oryzae. In some embodiments, the fungal pathogen is ramularia. In some embodiments, the fungal pathogen is Spilocea oleagina.

Fungicide I is used for controlling fungal groups, fungal classes and fungal pathogens, including the fungal groups, fungal classes and fungal pathogens described herein.

Fungal infection may cause fungal disease affecting the plant or soil. In some embodiments, treating a plant or soil against fungal infection comprises treating the plant or soil against fungal disease.

In some embodiments, the fungal disease is apple Scab disease. In some embodiments, the fungal disease is Black sigatoka. In some embodiments, the fungal disease is Septoria. In some embodiments, the fungal disease is Ramularia leaf spot. In some embodiments, the fungal disease is Gray Leaf Spot. In some embodiments, the fungal disease is leaf spot of beet. In some embodiments, the fungal disease is Sheath Blight. In some embodiments, the fungal disease is Fusarium head blight. In some embodiments, the fungal disease is Downy mildew. In some embodiments, the fungal disease is Late blight. In some embodiments, the fungal disease is Coffee Berry Disease. In some embodiments, the fungal disease is Anthracnose. In some embodiments, the fungal disease is Northern Corn Leaf Blight. In some embodiments, the fungal disease is Northern Corn Leaf Spot. In some embodiments, the fungal disease is Scab. In some embodiments, the fungal disease is Early blight. In some embodiments, the fungal disease is Didymella pisi. In some embodiments, the fungal disease is Target spot. In some embodiments, the fungal disease is Brown Rust. In some embodiments, the fungal disease is yellow Rust. In some embodiments, the fungal disease is Coffee Leaf Rust. In some embodiments, the fungal disease is Asian soybean Rust. In some embodiments, the fungal disease is Rust. In some embodiments, the fungal disease is Rice Blast.

Fungicide I is used for controlling broad spectrum of diseases, including the fungal diseases described herein. Fungicide I may be used on a variety of plants, including the plants described herein. Preferably, fungicide I is used for controlling the following fungal diseases. In some embodiments, the disease is Sheath Blight in rice crop. In some embodiments, the disease is apple Scab. In some embodiments, the disease is Early blight disease in vegetable crop. In some embodiments, the vegetable crop is potato. In some embodiments, the vegetable crop is tomato. In some embodiments, the vegetable crop is chili. In some embodiments, the disease is Anthracnose and/or Alternaria. In some embodiments, the disease is an Early blight disease in potatoes. In some embodiments, the disease is an Anthracnose disease in chili. In some embodiments, the disease is Septoria in cereals. In some embodiments, the disease is Black sigatoka in banana. In some embodiments, the disease is Sphaerotheca fuliginea in melon. In some embodiments, the disease is Anthracnose and/or Alternariain chilli. In some embodiments, the disease is Erysiphe necator in grape. In some embodiments, the disease is Phakopsora pachyrhizi in soybean. In some embodiments, the disease is Venturia inaequalis in apple. In some embodiments, the disease is Alternaria sp. or Phytophthora infestans in tomato. In some embodiments, the disease is Plasmopara viticola in grape.

In some embodiments, the method is for controlling downy mildew (Plasmopara viticola) on grape, and the phthalimide fungicide is folpet and the primary fungicide is fluazinam, preferably folpet is applied at a rate of 500 g AI/ha and fluazinam is applied at a rate of 350 g AI/ha.

In some embodiments, the method is for controlling Septoria Tritici Blotch (STB) (Zymoseptoria tritici) on wheat, and the phthalimide fungicide is folpet and the primary fungicide is metyltetraprole, preferably folpet is applied at a rate of 500 g AI/ha and metyltetrprole is applied at 100 g AI/ha.

Preferred Combinations for Specific Fungal Pathogens, Fungal Diseases, and/or Plants

TABLE C
Diseases, Fungal Pathogens and Crops

| Disease | Fungal Pathogen | Crops |
|---|---|---|
| Early blight | Alternaria sp. | Potato |
| | | ortomato |
| Anthracnose | Colletotrichum sp. | Pulses |
| Anthracnose | Colletotrichum truncatum | Chilli |
| Asian soybean rust | Phakopsora pachyrhizi | Soybean |
| Black sigatoka | Mycosphaerella fijiensis | Banana |
| Brown rust | Puccinia recondita | Cereals |
| Coffee Berry Disease | Colletotrichum kahawae | Coffee |
| Coffee Leaf Rust | Hemileia vastatrix | Coffee |
| Didymella pisi | Ascochyta rabiei | Pulses |
| Downy mildew | Pseudoperonospora cubensis | Cucurbits |
| Downy mildew | Plasmopara viticola | Grape |
| Fusarium head blight | Fusarium sp. | Cereals |
| Gray Leaf Spot | Cercospora zeae-maydis | Corn |
| Late blight | Phytophthora infestans | Potato |
| | | ortomato |
| leaf spot of beet | Cercospora beticola | Sugar beet |
| Northern Corn Leaf Blight | Setosphaeria turcica | Corn |
| Northern Corn Leaf Spot | Cochliobolus carbonum | Corn |
| Ramularia leaf spot | Ramularia collo-cygni | Cereals |
| Ramularia leaf spot | Ramularia areola | Cotton |
| Ramularia leaf spot | Ramularia beticola | Sugar Beet |
| Rice Blast | Pyricularia oryzae | Rice |
| Rust | Uromyces betae | Sugar beet |
| Scab | Venturia inaequalis | Pome fruit |
| Sclerotinia | Sclerotinia sclerotiorum | OSR |
| Septoria | Zymoseptoria tritici | Cereals |
| Sheath Blight | Rhizoctonia solani / | Rice |
| | Thanatephorus cucumeris | |
| Southern corn leaf blight | Cochliobolus heterostrophus | Corn |
| Target spot | Corynespora cassiicola | Soybean |
| Yellow rust | Puccinia striiformis | Cereals |
| Yellow sigatoka | Pseudocercospora musae | Banana |

In some embodiments, folpet and a primary fungicide selected from pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide, or inorganic fungicide and any combination thereof is used to control the diseases in each row of Table C.

In some embodiments, Captan and a primary fungicide selected from pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide, or inorganic fungicide and any combination thereof is used to control the diseases in each row of Table C.

In some embodiments, folpet, a first primary fungicide and a second primary funcide selected from pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide, or inorganic fungicide and any combination thereof is used to control the diseases in each row of Table C.

In some embodiments, Captan, a primary fungicide and a second primary funcide selected from pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide, or inorganic fungicide and any combination thereof is used to control the diseases in each row of Table C.

In some embodiments, the fungal disease is a fungal disease in a vegetable crop. In some embodiments, the vegetable crop is potato. In some embodiments, the vegetable crop is tomato. In some embodiments, the vegetable crop is chili. In some embodiments, the fungal disease is a fungal disease in a fruit crop. In some embodiments, the fruit crop is banana. In some embodiments, the fruit is grape. In some embodiments, the fungal disease is a fungal disease in rice. In some embodiments, the fungal disease is a fungal disease in barley. In some embodiments, the fungal disease is a fungal disease in soybean.

In some embodiments, the fungal disease is Early blight disease. In some embodiments, the fungal disease is Early blight disease in tomato. In some embodiments, the fungal disease is Early blight disease in potato. In some embodiments, the fungal disease is caused by Alternaria sp. In some embodiments, the Alternaria sp. is Alternaria solani. In some embodiments, the Early blight disease is caused by Alternaria sp. In some embodiments, the Early blight disease is caused by Alternaria solani. For Early blight disease and/or fungal disease caused by Alternaria sp., the combination comprising a phthalimide fungicide and the following primary fungicides or combinations of primary fungicides are preferred.

In some embodiments, the primary fungicide is selected from the group consisting of demethylation inhibitor fungicides (DMI), succinate dehydrogenase inhibitor fungicides (SDHI), quinone outside inhibitors and any combination thereof. In some embodiments, the primary fungicide is a demethylation inhibitor fungicide (DMI). In some embodiments, the primary fungicide is a succinate dehydrogenase inhibitor fungicide (SDHI). In some embodiments, the primary fungicide is a quinone outside inhibitor. In some embodiments, the demethylation inhibitor fungicide (DMI) is difenoconazole or tebuconazole. In some embodiments, the succinate dehydrogenase inhibitor fungicide (SDHI) is fluxapyroxad.

In some embodiments, the combination comprises two primary fungicides, wherein the two primary fungicides are a quinone outside inhibitor fungicide and a succinate dehydrogenase inhibitor fungicide (SDHI), preferably the succinate dehydrogenase inhibitor fungicide (SDHI) is fluxapyroxad.

In some embodiments, the fungal pathogen is Alternaria sp. and/or the fungal disease in tomato or potato is caused by Alternaria sp. and the primary fungicide is selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, sulphur, prothioconazole, and any combination thereof.

In some embodiments, the fungal pathogen is Alternaria sp. and/or the fungal disease in tomato or potato is caused by Alternaria sp. and the primary fungicide is selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, sulphur, or prothioconazole.

In some embodiments, the combination for controlling Alternaria sp. in tomato or potato comprises folpet and the primary fungicide selected from the group consisting of Formula I, fenpicoxamid, fenpropidin, fluazinam, fluopyram, 1, fluoxapiprolin, fluxapyroxad, mandestrobin, mefentrifluconazole, metyltetraprole, picarbutrazox, pydiflumetofen, sulphur or prothioconazole.

In some embodiments, the combination for controlling Alternaria sp. in tomato or potato comprises captan and the primary fungicide selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, sulphur or prothioconazole.

In some embodiments, the fungal disease is Late blight disease. In some embodiments, the fungal disease is Late blight disease in tomato. In some embodiments, the fungal disease is caused by Phytophthora infestans. In some embodiments, the Late blight disease is caused by Phytophthora infestans. For Late blight disease and/or fungal disease caused by Phytophthora infestans, the combination comprising a phthalimide fungicide and the following primary fungicides or combinations of primary fungicides are preferred. In some embodiments, primary fungicide is selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, sulphur, prothioconazole, and any combination thereof. In some embodiments, the fungal pathogen is Phytophthora infestans and/or the fungal disease in tomato is caused by Phytophthora infestans and the primary fungicide is selected from the group consisting of of Formula I, fenpicoxamid, fenpropidin, metyltetraprole, picarbutrazox, pydiflumetofen, sulphur, prothioconazole, and any combination thereof.

In some embodiments, the fungal disease is Sheath Blight disease in rice.

In some embodiments, the fungal disease is Anthracnose and/or Alternaria in chili. In some embodiments, the fungal disease in chili is caused by Colletotrichum capsica. In some embodiments, the fungal disease in chili is caused by Alternaria solani.

In some embodiments, the fungal disease is Black sigatoka in banana. In some embodiments, the fungal disease is caused by Mycosphaerella fijiensis.

In some embodiments, the fungal disease is Ramularia leaf spot in barley. In some embodiments, the fungal disease is caused by Ramularia collo-cygni. For Ramularia leaf spot in barley and/or fungal disease caused by Ramularia collo-cygni, the combination comprising a phthalimide fungicide and a pyrimidinone fungicide, or the combination comprising a phthalimide fungicide and two or more primary fungicides wherein at least one primary fungicide is a pyrimidinone fungicide are preferred. It is more preferred that the pyrimidinone fungicide or at least one of the pyrimidinone fungicides is 5-fluoro-4-imino-3-methyl-1-tosyl-3,4-dihydropyrimidin-2(1H)-one. In some embodiments, for Ramularia leaf spot in barley, the phthalimide fungicide is folpet. In some embodiments, for Ramularia leaf spot in barley, the phthalimide fungicide is captan. In some embodiments, for Ramularia leaf spot in barley, the phthalimide fungicide is captafol. In some embodiments, the combination for controlling Ramularia collo-cygni in barley comprises 5-fluoro-4-imino-3-methyl-1-tosyl-3,4-dihydropyrimidin-2(1H)-one and folpet. In some embodiments, the combination for controlling Ramularia collo-cygni in barley comprises 5-fluoro-4-imino-3-methyl-1-tosyl-3,4-dihydropyrimidin-2(1H)-one and captan. For Ramularia leaf spot in barley and/or fungal disease caused by Ramularia collo-cygni, the combination comprising a phthalimide fungicide, a SDHI fungicide and a DMI fungicide is also preferred. In some embodiments, the combination for controlling Ramularia collo-cygni in barley comprises folpet, prothioconazole and fluxapyroxad.

In some embodiments, the fungal disease is Asian soybean Rust. In some embodiments, the fungal pathogen is Phakopsora pachyrhizi. In some embodiments, the Asian soybean Rust is caused by Phakopsora pachyrhizi. For Asian soybean Rust and/or fungal disease caused by Phakopsora pachyrhizi, the combination comprising a phthalimide fungicide and the following primary fungicides or combinations of primary fungicides are preferred. In some embodiments, the primary fungicide is a quinone outside inhibitors fungicide. In some embodiments, the quinone outside inhibitors fungicide is azoxystrobin or picoxystrobin. In some embodiments, the combination comprises two primary fungicides, wherein the two primary fungicides are a quinone outside inhibitor fungicide and a succinate dehydrogenase inhibitor fungicide, preferably the succinate dehydrogenase inhibitor fungicide is fluxapyroxad. In some embodiments, the fungal pathogen is Phakopsora pachyrhizi and/or the fungal disease in soybean is caused by Phakopsora pachyrhizi and the primary fungicide is selected from the group consisting of azoxystrobin, picoxystrobin, fluxapyroxad and any combination thereof. In some embodiments, the combination for controlling Phakopsora pachyrhizi in soybean comprises picoxystrobin and folpet. In some embodiments, the combination for controlling Phakopsora pachyrhizi in soybean comprises fluxapyroxad and folpet. In some embodiments, the combination for controlling Phakopsora pachyrhizi in soybean comprises azoxystrobin and folpet. In some embodiments, the combination for controlling Phakopsora pachyrhizi in soybean comprises picoxystrobin, fluxapyroxad and folpet. In some embodiments, the combination for controlling Phakopsora pachyrhizi in soybean comprises azoxystrobin, fluxapyroxad and folpet. In some embodiments, the combination for controlling Phakopsora pachyrhizi in soybean comprises picoxystrobin and captan. In some embodiments, the combination for controlling Phakopsora pachyrhizi in soybean comprises fluxapyroxad and captan. In some embodiments, the combination for controlling Phakopsora pachyrhizi in soybean comprises azoxystrobin and captan. In some embodiments, the combination for controlling Phakopsora pachyrhizi in soybean comprises picoxystrobin, fluxapyroxad and captan. In some embodiments, the combination for controlling Phakopsora pachyrhizi in soybean comprises azoxystrobin, fluxapyroxad and captan.

In some embodiments, the fungal disease is Downy mildew in grape. In some embodiments, the fungal pathogen is Plasmopara viticola. In some embodiments, the Downy mildew is caused by Plasmopara viticola. For Downy mildew in grape and/or fungal disease caused by Plasmopara viticola, the combination comprising a phthalimide fungicide and the following primary fungicides or combinations of primary fungicides are preferred. In some embodiments, the primary fungicide is selected from the group consisting of pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide, or inorganic fungicide and any combination thereof. In some embodiments, the primary fungicide is a succinate dehydrogenase inhibitor fungicide (SDHI). In some embodiments, the primary fungicide is a quinone outside stigmatellin inhibitor fungicide. In some embodiments, the primary fungicide is an oxysterol binding protein inhibitor fungicide. In some embodiments, the succinate dehydrogenase inhibitor fungicide (SDHI) is fluxapyroxad. In some embodiments, the fluoropyrimidinone fungicide is 5-fluoro-4-imino-3-methyl-1-tosyl-3,4-dihydropyrimidin-2(1H)-one.

In some embodiments, the fungal pathogen is Plasmopara viticola and/or the fungal disease in grape is caused by Plasmopara viticola and the primary fungicide is selected from the group consisting of fluxapyroxad, mandipropamid, ametoctradin, zoxamide, cymoxanil, fluopicolide, potassium phosphonate, oxathiapiprolin and any combination thereof. In some embodiments, the combination for controlling Plasmopara viticola in grape comprises fluxapyroxad and folpet. In some embodiments, the combination for controlling Plasmopara viticola in grape comprises mandipropamide and folpet. In some embodiments, the combination for controlling Plasmopara viticola in grape comprises ametoctradin and folpet. In some embodiments, the combination for controlling Plasmopara viticola in grape comprises zoxamide and folpet. In some embodiments, the combination for controlling Plasmopara viticola in grape comprises cymoxanil and folpet. In some embodiments, the combination for controlling Plasmopara viticola in grape comprises fluopicolide and folpet. In some embodiments, the combination for controlling Plasmopara viticola in grape comprises oxathiapiprolin and folpet. In some embodiments, the combination for controlling Plasmopara viticola in grape comprises fluxapyroxad and captan. In some embodiments the combination for controlling Plasmopara viticola in grape comprises mandipropamid and captan. In some embodiments, the combination for controlling Plasmopara viticola in grape comprises ametoctradin and captan. In some embodiments, the combination for controlling Plasmopara viticola in grape comprises zoxamide and captan. In some embodiments, the combination for controlling Plasmopara viticola in grape comprises cymoxanil and captan. In some embodiments, the combination for controlling Plasmopara viticola in grape comprises fluopicolide and captan. In some embodiments, the combination for controlling Plasmopara viticola in grape comprises oxathiapiprolin and captan. In some embodiments, the combination for controlling Plasmopara viticola in grape comprises potassium phosphonate and captan. In some embodiments, the combination for controlling Plasmopara viticola in grape comprises potassium phosphonate and folpet. In some embodiments, the combination for controlling Plasmopara viticola in grape comprises 5-fluoro-4-imino-3-methyl-1-tosyl-3,4-dihydropyrimidin-2(1H)-one and folpet.

In some embodiments, the fungal disease is Septoria leaf blotch. In some embodiments, the fungal disease is Septoria leaf blotch in wheat. In some embodiments, the fungal pathogen is ZymoSeptoria tritici. In some embodiments, the Septoria leaf blotch is caused by ZymoSeptoria tritici. For Septoria leaf blotch and/or fungal disease caused by ZymoSeptoria tritici, the combination comprising a phthalimide fungicide and a SDHI fungicide, or the combination comprising phthalimide fungicide and a QoI fungicide is preferred. In some embodiments, the combination for controlling ZymoSeptoria tritici comprises captan and fluxapyroxad. In some embodiments, the combination for controlling ZymoSeptoria tritici comprises folpet and fluxapyroxad. In some embodiments, the combination for controlling ZymoSeptoria tritici comprises folpet and bixafen. In some embodiments, the combination for controlling ZymoSeptoria tritici comprises folpet and penthiopyrad. In some embodiments, the combination for controlling ZymoSeptoria tritici comprises folpet and prochloraz. In some embodiments, the combination for controlling ZymoSeptoria tritici comprises folpet and azoxystrobin. In some embodiments, the combination for controlling ZymoSeptoria tritici comprises folpet and trifloxystrobin. In some embodiments, the combination for controlling ZymoSeptoria tritici comprises folpet and pyraclostrobin.

In some embodiments, the fungal disease is Cercospora leaf spot. In some embodiments, the fungal disease is Cercospora leaf spot in sugar beet. In some embodiments, the fungal pathogen is Cercospora beticola. In some embodiments, the Cercospora leaf spot is caused by Cercospora beticola. For Cercospora leaf spot and/or fungal disease caused by Cercospora beticola, the combination comprising a phthalimide fungicide and an amine fungicide is preferred. In some embodiments, the combination for controlling Cercospora beticola comprises fenpropidin and folpet.

In some embodiments, the combination for controlling fungal disease caused by a fungal pathogen in barley comprises folpet and fluxapyroxad.

In some embodiments, the combination for controlling fungal disease caused by a fungal pathogen in sugar beet comprises folpet and fenpropidin.

The fungicidal mixture of (1) an amount of phthalimide fungicide and (2) an amount of succinate dehydrogenase inhibitor fungicide, if applied, has excellent activity against a broad spectrum of phytopathogenic fungi.

For example, the phytopathogenic fungi may be one or more of Alternaria species on vegetables, fruit trees, oilseed rape, sugar beet and fruit and rice, such as, A. solani or A. alternata on potatoes and tomatoes; Aphanomyces species on sugar beet and vegetables; Ascochyta species on cereals and vegetables; Bipolaris and Drechslera species on corn, cereals, and rice, for example, Blumeria graminis (powdery mildew) on cereals; Colletotricum species on vegetables, soybeans and cotton, such as Colletotrichum truncatum in soybean; Phakopsora pachyrhizi on soybeans; Phomopsis species on soybeans, sunflowers and grapes; Phytophthora infestans on potatoes and tomatoes; Ramularia species on cereals, barley and cotton, for example, Ramularia collo-cygni on barley and Ramularia areola on cotton.

In some embodiments, the method comprises application of at least one pesticide in addition to the phthalimide fungicide(s) and the primary fungicide(s). In some embodiments, the method comprises application of at least two pesticides in addition to the phthalimide fungicide(s) and the primary fungicide(s). In some embodiments, the pesticide is herbicide, insecticide, acaricides, or nematicide.

In some embodiments, the method comprises application of at least one fungicide in addition to the phthalimide fungicide(s) and the primary fungicide(s). In some embodiments, the method comprises application of at least two fungicides in addition to the phthalimide fungicide(s) and the primary fungicide(s).

In some embodiments, the method does not comprise application of any pesticide in addition to the phthalimide fungicide(s) and the primary fungicide(s).

In some embodiments, the method comprises application of an additional crop protection agents, for example insecticides, herbicides, fungicides, bactericides, nematicides, molluscicides, growth regulators, biological agents, fertilizers, or mixtures thereof.

### Preferred Methods

The present invention provides a method for controlling Sheath Blight disease in rice, comprising applying a fungicidal mixture comprising (1) an amount of phthalimide fungicide and (2) an amount of succinate dehydrogenase inhibitor fungicide to the plant, propagation material of the plant, and/or a locus of the plant.

The present invention provides a method for controlling Sheath Blight disease in rice, comprising applying (1) an amount of phthalimide fungicide and (2) an amount of succinate dehydrogenase inhibitor fungicide to the plant, propagation material of the plant, and/or a locus of the plant.

The present invention provides a method for controlling Sheath Blight disease in rice, comprising applying a fungicidal mixture comprising (1) a phthalimide fungicide and (2) a succinate dehydrogenase inhibitor fungicide to the plant, propagation material of the plant, and/or a locus of the plant.

The present invention provides a method for controlling fungal disease in chili, comprising applying a fungicidal mixture of (1) a phthalimide fungicide and (2) a succinate dehydrogenase inhibitor fungicide to the plant, propagation material of the plant, and/or a locus of the plant. In some embodiments, the disease in chili is Anthracnose disease.

The present invention provides a method for controlling fungal disease in banana comprising applying (a) a phthalimide fungicide and (b) a succinate dehydrogenase inhibitor fungicide, to the plant, part of the plant or locus of the plant. In some embodiments, the fungal disease in banana is Black sigatoka.

The present invention provides a method for controlling Plasmopara viticola, in grape comprising applying (a) at least one phthalimide fungicide selected from the group consisting of captan, folpet, captafol and any combination thereof and (b) at least one succinate dehydrogenase inhibitor fungicide, to the plant, part of the plant or locus of the plant.

The present invention provides a method of protecting and prolonging the lifespan of medium to high resistance risk fungicides comprising applying to the locus of the crop a mixture or a composition comprising (1) an amount of phthalimide fungicide and (2) an amount of succinate dehydrogenase inhibitor fungicide.

The present invention provides a method of protecting and prolonging the lifespan of medium to high resistance risk fungicides comprising applying to the plant and/or the locus of the plant any combination comprising (1) a phthalimide fungicide and (2) a succinate dehydrogenase inhibitor fungicide disclosed herein.

### Combinations

TABLE D
Combinations of Folpet or Captan and One Primary Fungicide

| | | Ratio of | | | |
|---|---|---|---|---|---|
| | | amount of PH | | | |
| Phthalamide | | to Primary | Target | | |
| (PH) | Primary Fungicide | Fungicide | Disease | Fungal Pathogen | Crops |
| folpet or captan | ADF-16 | from 100:1 | Anthracnose | Colletotrichum sp. | Pulses |
| | | till 1:100 | | | |
| folpet or captan | ADF-16 | from 100:1 | Anthracnose | Colletotrichum sp. | Pulses |
| | | till 1:100 | | | |
| folpet or captan | fenpicoxamid | from 100:1 | Anthracnose | Colletotrichum sp. | Pulses |
| | | till 1:100 | | | |
| folpet or captan | fenpicoxamid | from 100:1 | Anthracnose | Colletotrichum sp. | Pulses |
| | | till 1:100 | | | |
| folpet or captan | fenpropidin | from 100:1 | Anthracnose | Colletotrichum sp. | Pulses |
| | | till 1:100 | | | |
| folpet or captan | fenpropidin | from 100:1 | Anthracnose | Colletotrichum sp. | Pulses |
| | | till 1:100 | | | |
| folpet or captan | fluopyram | from 100:1 | Anthracnose | Colletotrichum sp. | Pulses |
| | | till 1:100 | | | |
| folpet or captan | fluopyram | from 100:1 | Anthracnose | Colletotrichum sp. | Pulses |
| | | till 1:100 | | | |
| folpet or captan | fluoxapiprolin | from 100:1 | Anthracnose | Colletotrichum sp. | Pulses |
| | | till 1:100 | | | |
| folpet or captan | fluoxapiprolin | from 100:1 | Anthracnose | Colletotrichum sp. | Pulses |
| | | till 1:100 | | | |
| folpet or captan | fluxapyroxad | from 100:1 | Anthracnose | Colletotrichum sp. | Pulses |
| | | till 1:100 | | | |
| folpet or captan | fluxapyroxad | from 100:1 | Anthracnose | Colletotrichum sp. | Pulses |
| | | till 1:100 | | | |
| folpet or captan | Mandestrobin | from 100:1 | Anthracnose | Colletotrichum sp. | Pulses |
| | | till 1:100 | | | |
| folpet or captan | Mandestrobin | from 100:1 | Anthracnose | Colletotrichum sp. | Pulses |
| | | till 1:100 | | | |
| folpet or captan | mefentrifluconazole | from 100:1 | Anthracnose | Colletotrichum sp. | Pulses |
| | | till 1:100 | | | |
| folpet or captan | mefentrifluconazole | from 100:1 | Anthracnose | Colletotrichum sp. | Pulses |
| | | till 1:100 | | | |
| folpet or captan | metyltetraprole | from 100:1 | Anthracnose | Colletotrichum sp. | Pulses |
| | | till 1:100 | | | |
| folpet or captan | metyltetraprole | from 100:1 | Anthracnose | Colletotrichum sp. | Pulses |
| | | till 1:100 | | | |
| folpet or captan | picarbutrazox | from 100:1 | Anthracnose | Colletotrichum sp. | Pulses |
| | | till 1:100 | | | |
| folpet or captan | picarbutrazox | from 100:1 | Anthracnose | Colletotrichum sp. | Pulses |
| | | till 1:100 | | | |
| folpet or captan | prothioconazole | from 100:1 | Anthracnose | Colletotrichum sp. | Pulses |
| | | till 1:100 | | | |
| folpet or captan | prothioconazole | from 100:1 | Anthracnose | Colletotrichum sp. | Pulses |
| | | till 1:100 | | | |
| folpet or captan | pydiflumetofen | from 100:1 | Anthracnose | Colletotrichum sp. | Pulses |
| | | till 1:100 | | | |
| folpet or captan | pydiflumetofen | from 100:1 | Anthracnose | Colletotrichum sp. | Pulses |
| | | till 1:100 | | | |
| folpet or captan | Sulphur | from 100:1 | Anthracnose | Colletotrichum sp. | Pulses |
| | | till 1:100 | | | |
| folpet or captan | Fluazinam | from 100:1 | Anthracnose | Colletotrichum sp. | Pulses |
| | | till 1:100 | | | |
| folpet or captan | ADF-16 | from 100:1 | Asian soybean | Phakopsora | Soybean |
| | | till 1:100 | rust | pachyrhizi | |
| folpet or captan | ADF-16 | from 100:1 | Asian soybean | Phakopsora | Soybean |
| | | till 1:100 | rust | pachyrhizi | |
| folpet or captan | fenpicoxamid | from 100:1 | Asian soybean | Phakopsora | Soybean |
| | | till 1:100 | rust | pachyrhizi | |
| folpet or captan | fenpicoxamid | from 100:1 | Asian soybean | Phakopsora | Soybean |
| | | till 1:100 | rust | pachyrhizi | |
| folpet or captan | fenpropidin | from 100:1 | Asian soybean | Phakopsora | Soybean |
| | | till 1:100 | rust | pachyrhizi | |
| folpet or captan | fenpropidin | from 100:1 | Asian soybean | Phakopsora | Soybean |
| | | till 1:100 | rust | pachyrhizi | |
| folpet or captan | fluopyram | from 100:1 | Asian soybean | Phakopsora | Soybean |
| | | till 1:100 | rust | pachyrhizi | |
| folpet or captan | fluopyram | from 100:1 | Asian soybean | Phakopsora | Soybean |
| | | till 1:100 | rust | pachyrhizi | |
| folpet or captan | fluoxapiprolin | from 100:1 | Asian soybean | Phakopsora | Soybean |
| | | till 1:100 | rust | pachyrhizi | |
| folpet or captan | fluoxapiprolin | from 100:1 | Asian soybean | Phakopsora | Soybean |
| | | till 1:100 | rust | pachyrhizi | |
| folpet or captan | fluxapyroxad | from 100:1 | Asian soybean | Phakopsora | Soybean |
| | | till 1:100 | rust | pachyrhizi | |
| folpet or captan | fluxapyroxad | from 100:1 | Asian soybean | Phakopsora | Soybean |
| | | till 1:100 | rust | pachyrhizi | |
| folpet or captan | Mandestrobin | from 100:1 | Asian soybean | Phakopsora | Soybean |
| | | till 1:100 | rust | pachyrhizi | |
| folpet or captan | Mandestrobin | from 100:1 | Asian soybean | Phakopsora | Soybean |
| | | till 1:100 | rust | pachyrhizi | |
| folpet or captan | mefentrifluconazole | from 100:1 | Asian soybean | Phakopsora | Soybean |
| | | till 1:100 | rust | pachyrhizi | |
| folpet or captan | mefentrifluconazole | from 100:1 | Asian soybean | Phakopsora | Soybean |
| | | till 1:100 | rust | pachyrhizi | |
| folpet or captan | metyltetraprole | from 100:1 | Asian soybean | Phakopsora | Soybean |
| | | till 1:100 | rust | pachyrhizi | |
| folpet or captan | metyltetraprole | from 100:1 | Asian soybean | Phakopsora | Soybean |
| | | till 1:100 | rust | pachyrhizi | |
| folpet or captan | picarbutrazox | from 100:1 | Asian soybean | Phakopsora | Soybean |
| | | till 1:100 | rust | pachyrhizi | |
| folpet or captan | picarbutrazox | from 100:1 | Asian soybean | Phakopsora | Soybean |
| | | till 1:100 | rust | pachyrhizi | |
| folpet or captan | prothioconazole | from 100:1 | Asian soybean | Phakopsora | Soybean |
| | | till 1:100 | rust | pachyrhizi | |
| folpet or captan | prothioconazole | from 100:1 | Asian soybean | Phakopsora | Soybean |
| | | till 1:100 | rust | pachyrhizi | |
| folpet or captan | pydiflumetofen | from 100:1 | Asian soybean | Phakopsora | Soybean |
| | | till 1:100 | rust | pachyrhizi | |
| folpet or captan | pydiflumetofen | from 100:1 | Asian soybean | Phakopsora | Soybean |
| | | till 1:100 | rust | pachyrhizi | |
| folpet or captan | Sulphur | from 100:1 | Asian soybean | Phakopsora | Soybean |
| | | till 1:100 | rust | pachyrhizi | |
| folpet or captan | Fluazinam | from 100:1 | Asian soybean | Phakopsora | Soybean |
| | | till 1:100 | rust | pachyrhizi | |
| folpet or captan | ADF-16 | from 100:1 | Black sigatoka | Mycosphaerella | Banana |
| | | till 1:100 | | fijiensis | |
| folpet or captan | ADF-16 | from 100:1 | Black sigatoka | Mycosphaerella | Banana |
| | | till 1:100 | | fijiensis | |
| folpet or captan | fenpicoxamid | from 100:1 | Black sigatoka | Mycosphaerella | Banana |
| | | till 1:100 | | fijiensis | |
| folpet or captan | fenpicoxamid | from 100:1 | Black sigatoka | Mycosphaerella | Banana |
| | | till 1:100 | | fijiensis | |
| folpet or captan | fenpropidin | from 100:1 | Black sigatoka | Mycosphaerella | Banana |
| | | till 1:100 | | fijiensis | |
| folpet or captan | fenpropidin | from 100:1 | Black sigatoka | Mycosphaerella | Banana |
| | | till 1:100 | | fijiensis | |
| folpet or captan | fluopyram | from 100:1 | Black sigatoka | Mycosphaerella | Banana |
| | | till 1:100 | | fijiensis | |
| folpet or captan | fluopyram | from 100:1 | Black sigatoka | Mycosphaerella | Banana |
| | | till 1:100 | | fijiensis | |
| folpet or captan | fluoxapiprolin | from 100:1 | Black sigatoka | Mycosphaerella | Banana |
| | | till 1:100 | | fijiensis | |
| folpet or captan | fluoxapiprolin | from 100:1 | Black sigatoka | Mycosphaerella | Banana |
| | | till 1:100 | | fijiensis | |
| folpet or captan | fluxapyroxad | from 100:1 | Black sigatoka | Mycosphaerella | Banana |
| | | till 1:100 | | fijiensis | |
| folpet or captan | fluxapyroxad | from 100:1 | Black sigatoka | Mycosphaerella | Banana |
| | | till 1:100 | | fijiensis | |
| folpet or captan | Mandestrobin | from 100:1 | Black sigatoka | Mycosphaerella | Banana |
| | | till 1:100 | | fijiensis | |
| folpet or captan | Mandestrobin | from 100:1 | Black sigatoka | Mycosphaerella | Banana |
| | | till 1:100 | | fijiensis | |
| folpet or captan | mefentrifluconazole | from 100:1 | Black sigatoka | Mycosphaerella | Banana |
| | | till 1:100 | | fijiensis | |
| folpet or captan | mefentrifluconazole | from 100:1 | Black sigatoka | Mycosphaerella | Banana |
| | | till 1:100 | | fijiensis | |
| folpet or captan | metyltetraprole | from 100:1 | Black sigatoka | Mycosphaerella | Banana |
| | | till 1:100 | | fijiensis | |
| folpet or captan | metyltetraprole | from 100:1 | Black sigatoka | Mycosphaerella | Banana |
| | | till 1:100 | | fijiensis | |
| folpet or captan | picarbutrazox | from 100:1 | Black sigatoka | Mycosphaerella | Banana |
| | | till 1:100 | | fijiensis | |
| folpet or captan | picarbutrazox | from 100:1 | Black sigatoka | Mycosphaerella | Banana |
| | | till 1:100 | | fijiensis | |
| folpet or captan | pydiflumetofen | from 100:1 | Black sigatoka | Mycosphaerella | Banana |
| | | till 1:100 | | fijiensis | |
| folpet or captan | pydiflumetofen | from 100:1 | Black sigatoka | Mycosphaerella | Banana |
| | | till 1:100 | | fijiensis | |
| folpet or captan | Sulphur | from 100:1 | Black sigatoka | Mycosphaerella | Banana |
| | | till 1:100 | | fijiensis | |
| folpet or captan | Fluazinam | from 100:1 | Black sigatoka | Mycosphaerella | Banana |
| | | till 1:100 | | fijiensis | |
| folpet or captan | prothioconazole | from 100:1 | Black sigatoka | Mycosphaerella | Banana |
| | | till 1:100 | | fijiensis | |
| folpet or captan | ADF-16 | from 100:1 | Brown rust | Puccinia recondita | Cereals |
| | | till 1:100 | | | |
| folpet or captan | ADF-16 | from 100:1 | Brown rust | Puccinia recondita | Cereals |
| | | till 1:100 | | | |
| folpet or captan | fenpicoxamid | from 100:1 | Brown rust | Puccinia recondita | Cereals |
| | | till 1:100 | | | |
| folpet or captan | fenpicoxamid | from 100:1 | Brown rust | Puccinia recondita | Cereals |
| | | till 1:100 | | | |
| folpet or captan | fenpropidin | from 100:1 | Brown rust | Puccinia recondita | Cereals |
| | | till 1:100 | | | |
| folpet or captan | fenpropidin | from 100:1 | Brown rust | Puccinia recondita | Cereals |
| | | till 1:100 | | | |
| folpet or captan | fluopyram | from 100:1 | Brown rust | Puccinia recondita | Cereals |
| | | till 1:100 | | | |
| folpet or captan | fluopyram | from 100:1 | Brown rust | Puccinia recondita | Cereals |
| | | till 1:100 | | | |
| folpet or captan | fluoxapiprolin | from 100:1 | Brown rust | Puccinia recondita | Cereals |
| | | till 1:100 | | | |
| folpet or captan | fluoxapiprolin | from 100:1 | Brown rust | Puccinia recondita | Cereals |
| | | till 1:100 | | | |
| folpet or captan | fluxapyroxad | from 100:1 | Brown rust | Puccinia recondita | Cereals |
| | | till 1:100 | | | |
| folpet or captan | fluxapyroxad | from 100:1 | Brown rust | Puccinia recondita | Cereals |
| | | till 1:100 | | | |
| folpet or captan | Mandestrobin | from 100:1 | Brown rust | Puccinia recondita | Cereals |
| | | till 1:100 | | | |
| folpet or captan | Mandestrobin | from 100:1 | Brown rust | Puccinia recondita | Cereals |
| | | till 1:100 | | | |
| folpet or captan | mefentrifluconazole | from 100:1 | Brown rust | Puccinia recondita | Cereals |
| | | till 1:100 | | | |
| folpet or captan | mefentrifluconazole | from 100:1 | Brown rust | Puccinia recondita | Cereals |
| | | till 1:100 | | | |
| folpet or captan | metyltetraprole | from 100:1 | Brown rust | Puccinia recondita | Cereals |
| | | till 1:100 | | | |
| folpet or captan | metyltetraprole | from 100:1 | Brown rust | Puccinia recondita | Cereals |
| | | till 1:100 | | | |
| folpet or captan | picarbutrazox | from 100:1 | Brown rust | Puccinia recondita | Cereals |
| | | till 1:100 | | | |
| folpet or captan | picarbutrazox | from 100:1 | Brown rust | Puccinia recondita | Cereals |
| | | till 1:100 | | | |
| folpet or captan | prothioconazole | from 100:1 | Brown rust | Puccinia recondita | Cereals |
| | | till 1:100 | | | |
| folpet or captan | prothioconazole | from 100:1 | Brown rust | Puccinia recondita | Cereals |
| | | till 1:100 | | | |
| folpet or captan | pydiflumetofen | from 100:1 | Brown rust | Puccinia recondita | Cereals |
| | | till 1:100 | | | |
| folpet or captan | pydiflumetofen | from 100:1 | Brown rust | Puccinia recondita | Cereals |
| | | till 1:100 | | | |
| folpet or captan | Sulphur | from 100:1 | Brown rust | Puccinia recondita | Cereals |
| | | till 1:100 | | | |
| folpet or captan | Fluazinam | from 100:1 | Brown rust | Puccinia recondita | Cereals |
| | | till 1:100 | | | |
| folpet or captan | ADF-16 | from 100:1 | Coffee Berry | Colletotrichum | Coffee |
| | | till 1:100 | Disease | kahawae | |
| folpet or captan | ADF-16 | from 100:1 | Coffee Berry | Colletotrichum | Coffee |
| | | till 1:100 | Disease | kahawae | |
| folpet or captan | fenpicoxamid | from 100:1 | Coffee Berry | Colletotrichum | Coffee |
| | | till 1:100 | Disease | kahawae | |
| folpet or captan | fenpicoxamid | from 100:1 | Coffee Berry | Colletotrichum | Coffee |
| | | till 1:100 | Disease | kahawae | |
| folpet or captan | fenpropidin | from 100:1 | Coffee Berry | Colletotrichum | Coffee |
| | | till 1:100 | Disease | kahawae | |
| folpet or captan | fenpropidin | from 100:1 | Coffee Berry | Colletotrichum | Coffee |
| | | till 1:100 | Disease | kahawae | |
| folpet or captan | fluopyram | from 100:1 | Coffee Berry | Colletotrichum | Coffee |
| | | till 1:100 | Disease | kahawae | |
| folpet or captan | fluopyram | from 100:1 | Coffee Berry | Colletotrichum | Coffee |
| | | till 1:100 | Disease | kahawae | |
| folpet or captan | fluoxapiprolin | from 100:1 | Coffee Berry | Colletotrichum | Coffee |
| | | till 1:100 | Disease | kahawae | |
| folpet or captan | fluoxapiprolin | from 100:1 | Coffee Berry | Colletotrichum | Coffee |
| | | till 1:100 | Disease | kahawae | |
| folpet or captan | fluxapyroxad | from 100:1 | Coffee Berry | Colletotrichum | Coffee |
| | | till 1:100 | Disease | kahawae | |
| folpet or captan | fluxapyroxad | from 100:1 | Coffee Berry | Colletotrichum | Coffee |
| | | till 1:100 | Disease | kahawae | |
| folpet or captan | Mandestrobin | from 100:1 | Coffee Berry | Colletotrichum | Coffee |
| | | till 1:100 | Disease | kahawae | |
| folpet or captan | Mandestrobin | from 100:1 | Coffee Berry | Colletotrichum | Coffee |
| | | till 1:100 | Disease | kahawae | |
| folpet or captan | mefentrifluconazole | from 100:1 | Coffee Berry | Colletotrichum | Coffee |
| | | till 1:100 | Disease | kahawae | |
| folpet or captan | mefentrifluconazole | from 100:1 | Coffee Berry | Colletotrichum | Coffee |
| | | till 1:100 | Disease | kahawae | |
| folpet or captan | metyltetraprole | from 100:1 | Coffee Berry | Colletotrichum | Coffee |
| | | till 1:100 | Disease | kahawae | |
| folpet or captan | metyltetraprole | from 100:1 | Coffee Berry | Colletotrichum | Coffee |
| | | till 1:100 | Disease | kahawae | |
| folpet or captan | picarbutrazox | from 100:1 | Coffee Berry | Colletotrichum | Coffee |
| | | till 1:100 | Disease | kahawae | |
| folpet or captan | picarbutrazox | from 100:1 | Coffee Berry | Colletotrichum | Coffee |
| | | till 1:100 | Disease | kahawae | |
| folpet or captan | prothioconazole | from 100:1 | Coffee Berry | Colletotrichum | Coffee |
| | | till 1:100 | Disease | kahawae | |
| folpet or captan | prothioconazole | from 100:1 | Coffee Berry | Colletotrichum | Coffee |
| | | till 1:100 | Disease | kahawae | |
| folpet or captan | pydiflumetofen | from 100:1 | Coffee Berry | Colletotrichum | Coffee |
| | | till 1:100 | Disease | kahawae | |
| folpet or captan | pydiflumetofen | from 100:1 | Coffee Berry | Colletotrichum | Coffee |
| | | till 1:100 | Disease | kahawae | |
| folpet or captan | Sulphur | from 100:1 | Coffee Berry | Colletotrichum | Coffee |
| | | till 1:100 | Disease | kahawae | |
| folpet or captan | Fluazinam | from 100:1 | Coffee Berry | Colletotrichum | Coffee |
| | | till 1:100 | Disease | kahawae | |
| folpet or captan | ADF-16 | from 100:1 | Coffee Leaf | Hemileia vastatrix | Coffee |
| | | till 1:100 | Rust | | |
| folpet or captan | ADF-16 | from 100: | Coffee Leaf | Hemileia vastatrix | Coffee |
| | | till 1:100 | Rust | | |
| folpet or captan | fenpicoxamid | from 100:1 | Coffee Leaf | Hemileia vastatrix | Coffee |
| | | till 1:100 | Rust | | |
| folpet or captan | fenpicoxamid | from 100:1 | Coffee Leaf | Hemileia vastatrix | Coffee |
| | | till 1:100 | Rust | | |
| folpet or captan | fenpropidin | from 100:1 | Coffee Leaf | Hemileia vastatrix | Coffee |
| | | till 1:100 | Rust | | |
| folpet or captan | fenpropidin | from 100:1 | Coffee Leaf | Hemileia vastatrix | Coffee |
| | | till 1:100 | Rust | | |
| folpet or captan | fluopyram | from 100:1 | Coffee Leaf | Hemileia vastatrix | Coffee |
| | | till 1:100 | Rust | | |
| folpet or captan | fluopyram | from 100:1 | Coffee Leaf | Hemileia vastatrix | Coffee |
| | | till 1:100 | Rust | | |
| folpet or captan | fluoxapiprolin | from 100:1 | Coffee Leaf | Hemileia vastatrix | Coffee |
| | | till 1:100 | Rust | | |
| folpet or captan | fluoxapiprolin | from 100:1 | Coffee Leaf | Hemileia vastatrix | Coffee |
| | | till 1:100 | Rust | | |
| folpet or captan | fluxapyroxad | from 100:1 | Coffee Leaf | Hemileia vastatrix | Coffee |
| | | till 1:100 | Rust | | |
| folpet or captan | fluxapyroxad | from 100:1 | Coffee Leaf | Hemileia vastatrix | Coffee |
| | | till 1:100 | Rust | | |
| folpet or captan | Mandestrobin | from 100:1 | Coffee Leaf | Hemileia vastatrix | Coffee |
| | | till 1:100 | Rust | | |
| folpet or captan | Mandestrobin | from 100:1 | Coffee Leaf | Hemileia vastatrix | Coffee |
| | | till 1:100 | Rust | | |
| folpet or captan | mefentrifluconazole | from 100:1 | Coffee Leaf | Hemileia vastatrix | Coffee |
| | | till 1:100 | Rust | | |
| folpet or captan | mefentrifluconazole | from 100:1 | Coffee Leaf | Hemileia vastatrix | Coffee |
| | | till 1:100 | Rust | | |
| folpet or captan | metyltetraprole | from 100:1 | Coffee Leaf | Hemileia vastatrix | Coffee |
| | | till 1:100 | Rust | | |
| folpet or captan | metyltetraprole | from 100:1 | Coffee Leaf | Hemileia vastatrix | Coffee |
| | | till 1:100 | Rust | | |
| folpet or captan | picarbutrazox | from 100:1 | Coffee Leaf | Hemileia vastatrix | Coffee |
| | | till 1:100 | Rust | | |
| folpet or captan | picarbutrazox | from 100:1 | Coffee Leaf | Hemileia vastatrix | Coffee |
| | | till 1:100 | Rust | | |
| folpet or captan | prothioconazole | from 100:1 | Coffee Leaf | Hemileia vastatrix | Coffee |
| | | till 1:100 | Rust | | |
| folpet or captan | prothioconazole | from 100:1 | Coffee Leaf | Hemileia vastatrix | Coffee |
| | | till 1:100 | Rust | | |
| folpet or captan | pydiflumetofen | from 100:1 | Coffee Leaf | Hemileia vastatrix | Coffee |
| | | till 1:100 | Rust | | |
| folpet or captan | pydiflumetofen | from 100:1 | Coffee Leaf | Hemileia vastatrix | Coffee |
| | | till 1:100 | Rust | | |
| folpet or captan | Sulphur | from 100:1 | Coffee Leaf | Hemileia vastatrix | Coffee |
| | | till 1:100 | Rust | | |
| folpet or captan | Fluazinam | from 100:1 | Coffee Leaf | Hemileia vastatrix | Coffee |
| | | till 1:100 | Rust | | |
| folpet or captan | ADF-16 | from 100:1 | Didymella pisi | Ascochyta rabiei | Pulses |
| | | till 1:100 | | | |
| folpet or captan | ADF-16 | from 100:1 | Didymella pisi | Ascochyta rabiei | Pulses |
| | | till 1:100 | | | |
| folpet or captan | fenpicoxamid | from 100:1 | Didymella pisi | Ascochyta rabiei | Pulses |
| | | till 1:100 | | | |
| folpet or captan | fenpicoxamid | from 100:1 | Didymella pisi | Ascochyta rabiei | Pulses |
| | | till 1:100 | | | |
| folpet or captan | fenpropidin | from 100:1 | Didymella pisi | Ascochyta rabiei | Pulses |
| | | till 1:100 | | | |
| folpet or captan | fenpropidin | from 100:1 | Didymella pisi | Ascochyta rabiei | Pulses |
| | | till 1:100 | | | |
| folpet or captan | fluopyram | from 100:1 | Didymella pisi | Ascochyta rabiei | Pulses |
| | | till 1:100 | | | |
| folpet or captan | fluopyram | from 100:1 | Didymella pisi | Ascochyta rabiei | Pulses |
| | | till 1:100 | | | |
| folpet or captan | fluoxapiprolin | from 100:1 | Didymella pisi | Ascochyta rabiei | Pulses |
| | | till 1:100 | | | |
| folpet or captan | fluoxapiprolin | from 100:1 | Didymella pisi | Ascochyta rabiei | Pulses |
| | | till 1:100 | | | |
| folpet or captan | fluxapyroxad | from 100:1 | Didymella pisi | Ascochyta rabiei | Pulses |
| | | till 1:100 | | | |
| folpet or captan | fluxapyroxad | from 100:1 | Didymella pisi | Ascochyta rabiei | Pulses |
| | | till 1:100 | | | |
| folpet or captan | Mandestrobin | from 100:1 | Didymella pisi | Ascochyta rabiei | Pulses |
| | | till 1:100 | | | |
| folpet or captan | Mandestrobin | from 100:1 | Didymella pisi | Ascochyta rabiei | Pulses |
| | | till 1:100 | | | |
| folpet or captan | mefentrifluconazole | from 100:1 | Didymella pisi | Ascochyta rabiei | Pulses |
| | | till 1:100 | | | |
| folpet or captan | mefentrifluconazole | from 100:1 | Didymella pisi | Ascochyta rabiei | Pulses |
| | | till 1:100 | | | |
| folpet or captan | metyltetraprole | from 100:1 | Didymella pisi | Ascochyta rabiei | Pulses |
| | | till 1:100 | | | |
| folpet or captan | metyltetraprole | from 100:1 | Didymella pisi | Ascochyta rabiei | Pulses |
| | | till 1:100 | | | |
| folpet or captan | picarbutrazox | from 100:1 | Didymella pisi | Ascochyta rabiei | Pulses |
| | | till 1:100 | | | |
| folpet or captan | picarbutrazox | from 100:1 | Didymella pisi | Ascochyta rabiei | Pulses |
| | | till 1:100 | | | |
| folpet or captan | prothioconazole | from 100:1 | Didymella pisi | Ascochyta rabiei | Pulses |
| | | till 1:100 | | | |
| folpet or captan | prothioconazole | from 100:1 | Didymella pisi | Ascochyta rabiei | Pulses |
| | | till 1:100 | | | |
| folpet or captan | pydiflumetofen | from 100:1 | Didymella pisi | Ascochyta rabiei | Pulses |
| | | till 1:100 | | | |
| folpet or captan | pydiflumetofen | from 100:1 | Didymella pisi | Ascochyta rabiei | Pulses |
| | | till 1:100 | | | |
| folpet or captan | Sulphur | from 100:1 | Didymella pisi | Ascochyta rabiei | Pulses |
| | | till 1:100 | | | |
| folpet or captan | Fluazinam | from 100:1 | Didymella pisi | Ascochyta rabiei | Pulses |
| | | till 1:100 | | | |
| folpet or captan | ADF-16 | from 100:1 | Downy | Pseudoperonospora | Cucurbits |
| | | till 1:100 | mildew | cubensis | |
| folpet or captan | ADF-16 | from 100:1 | Downy | Pseudoperonospora | Cucurbits |
| | | till 1:100 | mildew | cubensis | |
| folpet or captan | fenpicoxamid | from 100:1 | Downy | Pseudoperonospora | Cucurbits |
| | | till 1:100 | mildew | cubensis | |
| folpet or captan | fenpicoxamid | from 100:1 | Downy | Pseudoperonospora | Cucurbits |
| | | till 1:100 | mildew | cubensis | |
| folpet or captan | fluopyram | from 100:1 | Downy | Pseudoperonospora | Cucurbits |
| | | till 1:100 | mildew | cubensis | |
| folpet or captan | fluopyram | from 100:1 | Downy | Pseudoperonospora | Cucurbits |
| | | till 1:100 | mildew | cubensis | |
| folpet or captan | fluoxapiprolin | from 100:1 | Downy | Pseudoperonospora | Cucurbits |
| | | till 1:100 | mildew | cubensis | |
| folpet or captan | fluoxapiprolin | from 100:1 | Downy | Pseudoperonospora | Cucurbits |
| | | till 1:100 | mildew | cubensis | |
| folpet or captan | fluxapyroxad | from 100:1 | Downy | Pseudoperonospora | Cucurbits |
| | | till 1:100 | mildew | cubensis | |
| folpet or captan | fluxapyroxad | from 100:1 | Downy | Pseudoperonospora | Cucurbits |
| | | till 1:100 | mildew | cubensis | |
| folpet or captan | Mandestrobin | from 100:1 | Downy | Pseudoperonospora | Cucurbits |
| | | till 1:100 | mildew | cubensis | |
| folpet or captan | Mandestrobin | from 100:1 | Downy | Pseudoperonospora | Cucurbits |
| | | till 1:100 | mildew | cubensis | |
| folpet or captan | mefentrifluconazole | from 100:1 | Downy | Pseudoperonospora | Cucurbits |
| | | till 1:100 | mildew | cubensis | |
| folpet or captan | mefentrifluconazole | from 100:1 | Downy | Pseudoperonospora | Cucurbits |
| | | till 1:100 | mildew | cubensis | |
| folpet or captan | metyltetraprole | from 100:1 | Downy | Pseudoperonospora | Cucurbits |
| | | till 1:100 | mildew | cubensis | |
| folpet or captan | metyltetraprole | from 100:1 | Downy | Pseudoperonospora | Cucurbits |
| | | till 1:100 | mildew | cubensis | |
| folpet or captan | picarbutrazox | from 100:1 | Downy | Pseudoperonospora | Cucurbits |
| | | till 1:100 | mildew | cubensis | |
| folpet or captan | picarbutrazox | from 100:1 | Downy | Pseudoperonospora | Cucurbits |
| | | till 1:100 | mildew | cubensis | |
| folpet or captan | prothioconazole | from 100:1 | Downy | Pseudoperonospora | Cucurbits |
| | | till 1:100 | mildew | cubensis | |
| folpet or captan | prothioconazole | from 100:1 | Downy | Pseudoperonospora | Cucurbits |
| | | till 1:100 | mildew | cubensis | |
| folpet or captan | pydiflumetofen | from 100:1 | Downy | Pseudoperonospora | Cucurbits |
| | | till 1:100 | mildew | cubensis | |
| folpet or captan | pydiflumetofen | from 100:1 | Downy | Pseudoperonospora | Cucurbits |
| | | till 1:100 | mildew | cubensis | |
| folpet or captan | Sulphur | from 100:1 | Downy | Pseudoperonospora | Cucurbits |
| | | till 1:100 | mildew | cubensis | |
| folpet or captan | Fluazinam | from 100:1 | Downy | Pseudoperonospora | Cucurbits |
| | | till 1:100 | mildew | cubensis | |
| folpet or captan | ADF-16 | from 100:1 | Downy | Plasmopara | Grape |
| | | till 1:100 | mildew | viticola | |
| folpet or captan | ADF-16 | from 100:1 | Downy | Plasmopara | Grape |
| | | till 1:100 | mildew | viticola | |
| folpet or captan | fenpicoxamid | from 100:1 | Downy | Plasmopara | Grape |
| | | till 1:100 | mildew | viticola | |
| folpet or captan | fenpicoxamid | from 100:1 | Downy | Plasmopara | Grape |
| | | till 1:100 | mildew | viticola | |
| folpet or captan | fluopyram | from 100:1 | Downy | Plasmopara | Grape |
| | | till 1:100 | mildew | viticola | |
| folpet or captan | fluopyram | from 100:1 | Downy | Plasmopara | Grape |
| | | till 1:100 | mildew | viticola | |
| folpet or captan | fluoxapiprolin | from 100:1 | Downy | Plasmopara | Grape |
| | | till 1:100 | mildew | viticola | |
| folpet or captan | fluoxapiprolin | from 100:1 | Downy | Plasmopara | Grape |
| | | till 1:100 | mildew | viticola | |
| folpet or captan | fluxapyroxad | from 100:1 | Downy | Plasmopara | Grape |
| | | till 1:100 | mildew | viticola | |
| folpet or captan | fluxapyroxad | from 100:1 | Downy | Plasmopara | Grape |
| | | till 1:100 | mildew | viticola | |
| folpet or captan | Mandestrobin | from 100:1 | Downy | Plasmopara | Grape |
| | | till 1:100 | mildew | viticola | |
| folpet or captan | Mandestrobin | from 100:1 | Downy | Plasmopara | Grape |
| | | till 1:100 | mildew | viticola | |
| folpet or captan | mefentrifluconazole | from 100:1 | Downy | Plasmopara | Grape |
| | | till 1:100 | mildew | viticola | |
| folpet or captan | mefentrifluconazole | from 100:1 | Downy | Plasmopara | Grape |
| | | till 1:100 | mildew | viticola | |
| folpet or captan | metyltetraprole | from 100:1 | Downy | Plasmopara | Grape |
| | | till 1:100 | mildew | viticola | |
| folpet or captan | metyltetraprole | from 100:1 | Downy | Plasmopara | Grape |
| | | till 1:100 | mildew | viticola | |
| folpet or captan | picarbutrazox | from 100:1 | Downy | Plasmopara | Grape |
| | | till 1:100 | mildew | viticola | |
| folpet or captan | picarbutrazox | from 100:1 | Downy | Plasmopara | Grape |
| | | till 1:100 | mildew | viticola | |
| folpet or captan | prothioconazole | from 100:1 | Downy | Plasmopara | Grape |
| | | till 1:100 | mildew | viticola | |
| folpet or captan | prothioconazole | from 100:1 | Downy | Plasmopara | Grape |
| | | till 1:100 | mildew | viticola | |
| folpet or captan | pydiflumetofen | from 100:1 | Downy | Plasmopara | Grape |
| | | till 1:100 | mildew | viticola | |
| folpet or captan | pydiflumetofen | from 100:1 | Downy | Plasmopara | Grape |
| | | till 1:100 | mildew | viticola | |
| folpet or captan | Sulphur | from 100:1 | Downy | Plasmopara | Grape |
| | | till 1:100 | mildew | viticola | |
| folpet or captan | Fluazinam | from 100:1 | Downy | Plasmopara | Grape |
| | | till 1:100 | mildew | viticola | |
| folpet or captan | fenpropidin | from 100:1 | Downy | Plasmopara | Grape |
| | | till 1:100 | mildew | viticola | |
| folpet or captan | ADF-16 | from 100:1 | Early blight | Alternaria sp. | Potato/ |
| | | till 1:100 | | | tomato |
| folpet or captan | ADF-16 | from 100:1 | Early blight | Alternaria sp. | Potato/ |
| | | till 1:100 | | | tomato |
| folpet or captan | fenpicoxamid | from 100:1 | Early blight | Alternaria sp. | Potato/ |
| | | till 1:100 | | | tomato |
| folpet or captan | fenpicoxamid | from 100:1 | Early blight | Alternaria sp. | Potato/ |
| | | till 1:100 | | | tomato |
| folpet or captan | fenpropidin | from 100:1 | Early blight | Alternaria sp. | Potato/ |
| | | till 1:100 | | | tomato |
| folpet or captan | fenpropidin | from 100:1 | Early blight | Alternaria sp. | Potato/ |
| | | till 1:100 | | | tomato |
| folpet or captan | fluopyram | from 100:1 | Early blight | Alternaria sp. | Potato/ |
| | | till 1:100 | | | tomato |
| folpet or captan | fluopyram | from 100:1 | Early blight | Alternaria sp. | Potato/ |
| | | till 1:100 | | | tomato |
| folpet or captan | fluoxapiprolin | from 100:1 | Early blight | Alternaria sp. | Potato/ |
| | | till 1:100 | | | tomato |
| folpet or captan | fluoxapiprolin | from 100:1 | Early blight | Alternaria sp. | Potato/ |
| | | till 1:100 | | | tomato |
| folpet or captan | fluxapyroxad | from 100:1 | Early blight | Alternaria sp. | Potato/ |
| | | till 1:100 | | | tomato |
| folpet or captan | fluxapyroxad | from 100:1 | Early blight | Alternaria sp. | Potato/ |
| | | till 1:100 | | | tomato |
| folpet or captan | Mandestrobin | from 100:1 | Early blight | Alternaria sp. | Potato/ |
| | | till 1:100 | | | tomato |
| folpet or captan | Mandestrobin | from 100:1 | Early blight | Alternaria sp. | Potato/ |
| | | till 1:100 | | | tomato |
| folpet or captan | mefentrifluconazole | from 100:1 | Early blight | Alternaria sp. | Potato/ |
| | | till 1:100 | | | tomato |
| folpet or captan | mefentrifluconazole | from 100:1 | Early blight | Alternaria sp. | Potato/ |
| | | till 1:100 | | | tomato |
| folpet or captan | metyltetraprole | from 100:1 | Early blight | Alternaria sp. | Potato/ |
| | | till 1:100 | | | tomato |
| folpet or captan | metyltetraprole | from 100:1 | Early blight | Alternaria sp. | Potato/ |
| | | till 1:100 | | | tomato |
| folpet or captan | picarbutrazox | from 100:1 | Early blight | Alternaria sp. | Potato/ |
| | | till 1:100 | | | tomato |
| folpet or captan | picarbutrazox | from 100:1 | Early blight | Alternaria sp. | Potato/ |
| | | till 1:100 | | | tomato |
| folpet or captan | pydiflumetofen | from 100:1 | Early blight | Alternaria sp. | Potato/ |
| | | till 1:100 | | | tomato |
| folpet or captan | pydiflumetofen | from 100:1 | Early blight | Alternaria sp. | Potato/ |
| | | till 1:100 | | | tomato |
| folpet or captan | Sulphur | from 100:1 | Early blight | Alternaria sp. | Potato/ |
| | | till 1:100 | | | tomato |
| folpet or captan | Fluazinam | from 100:1 | Early blight | Alternaria sp. | Potato/ |
| | | till 1:100 | | | tomato |
| folpet or captan | ADF-16 | from 100:1 | Fusarium head | Fusarium sp. | Cereals |
| | | till 1:100 | blight | | |
| folpet or captan | ADF-16 | from 100:1 | Fusarium head | Fusarium sp. | Cereals |
| | | till 1:100 | blight | | |
| folpet or captan | fenpicoxamid | from 100:1 | Fusarium head | Fusarium sp. | Cereals |
| | | till 1:100 | blight | | |
| folpet or captan | fenpicoxamid | from 100:1 | Fusarium head | Fusarium sp. | Cereals |
| | | till 1:100 | blight | | |
| folpet or captan | fenpropidin | from 100:1 | Fusarium head | Fusarium sp. | Cereals |
| | | till 1:100 | blight | | |
| folpet or captan | fenpropidin | from 100:1 | Fusarium head | Fusarium sp. | Cereals |
| | | till 1:100 | blight | | |
| folpet or captan | fluopyram | from 100:1 | Fusarium head | Fusarium sp. | Cereals |
| | | till 1:100 | blight | | |
| folpet or captan | fluopyram | from 100:1 | Fusarium head | Fusarium sp. | Cereals |
| | | till 1:100 | blight | | |
| folpet or captan | fluoxapiprolin | from 100:1 | Fusarium head | Fusarium sp. | Cereals |
| | | till 1:100 | blight | | |
| folpet or captan | fluoxapiprolin | from 100:1 | Fusarium head | Fusarium sp. | Cereals |
| | | till 1:100 | blight | | |
| folpet or captan | fluxapyroxad | from 100:1 | Fusarium head | Fusarium sp. | Cereals |
| | | till 1:100 | blight | | |
| folpet or captan | fluxapyroxad | from 100:1 | Fusarium head | Fusarium sp. | Cereals |
| | | till 1:100 | blight | | |
| folpet or captan | Mandestrobin | from 100:1 | Fusarium head | Fusarium sp. | Cereals |
| | | till 1:100 | blight | | |
| folpet or captan | Mandestrobin | from 100:1 | Fusarium head | Fusarium sp. | Cereals |
| | | till 1:100 | blight | | |
| folpet or captan | mefentrifluconazole | from 100:1 | Fusarium head | Fusarium sp. | Cereals |
| | | till 1:100 | blight | | |
| folpet or captan | mefentrifluconazole | from 100:1 | Fusarium head | Fusarium sp. | Cereals |
| | | till 1:100 | blight | | |
| folpet or captan | metyltetraprole | from 100:1 | Fusarium head | Fusarium sp. | Cereals |
| | | till 1:100 | blight | | |
| folpet or captan | metyltetraprole | from 100:1 | Fusarium head | Fusarium sp. | Cereals |
| | | till 1:100 | blight | | |
| folpet or captan | picarbutrazox | from 100:1 | Fusarium head | Fusarium sp. | Cereals |
| | | till 1:100 | blight | | |
| folpet or captan | picarbutrazox | from 100:1 | Fusarium head | Fusarium sp. | Cereals |
| | | till 1:100 | blight | | |
| folpet or captan | prothioconazole | from 100:1 | Fusarium head | Fusarium sp. | Cereals |
| | | till 1:100 | blight | | |
| folpet or captan | prothioconazole | from 100:1 | Fusarium head | Fusarium sp. | Cereals |
| | | till 1:100 | blight | | |
| folpet or captan | pydiflumetofen | from 100:1 | Fusarium head | Fusarium sp. | Cereals |
| | | till 1:100 | blight | | |
| folpet or captan | pydiflumetofen | from 100:1 | Fusarium head | Fusarium sp. | Cereals |
| | | till 1:100 | blight | | |
| folpet or captan | Sulphur | from 100:1 | Fusarium head | Fusarium sp. | Cereals |
| | | till 1:100 | blight | | |
| folpet or captan | Fluazinam | from 100:1 | Fusarium head | Fusarium sp. | Cereals |
| | | till 1:100 | blight | | |
| folpet or captan | ADF-16 | from 100:1 | Gray Leaf | Cercospora zeae- | Corn |
| | | till 1:100 | Spot | maydis | |
| folpet or captan | ADF-16 | from 100:1 | Gray Leaf | Cercospora zeae- | Corn |
| | | till 1:100 | Spot | maydis | |
| folpet or captan | fenpicoxamid | from 100:1 | Gray Leaf | Cercospora zeae- | Corn |
| | | till 1:100 | Spot | maydis | |
| folpet or captan | fenpicoxamid | from 100:1 | Gray Leaf | Cercospora zeae- | Corn |
| | | till 1:100 | Spot | maydis | |
| folpet or captan | fenpropidin | from 100:1 | Gray Leaf | Cercospora zeae- | Corn |
| | | till 1:100 | Spot | maydis | |
| folpet or captan | fenpropidin | from 100:1 | Gray Leaf | Cercospora zeae- | Corn |
| | | till 1:100 | Spot | maydis | |
| folpet or captan | fluopyram | from 100:1 | Gray Leaf | Cercospora zeae- | Corn |
| | | till 1:100 | Spot | maydis | |
| folpet or captan | fluopyram | from 100:1 | Gray Leaf | Cercospora zeae- | Corn |
| | | till 1:100 | Spot | maydis | |
| folpet or captan | fluoxapiprolin | from 100:1 | Gray Leaf | Cercospora zeae- | Corn |
| | | till 1:100 | Spot | maydis | |
| folpet or captan | fluoxapiprolin | from 100:1 | Gray Leaf | Cercospora zeae- | Corn |
| | | till 1:100 | Spot | maydis | |
| folpet or captan | fluxapyroxad | from 100:1 | Gray Leaf | Cercospora zeae- | Corn |
| | | till 1:100 | Spot | maydis | |
| folpet or captan | fluxapyroxad | from 100:1 | Gray Leaf | Cercospora zeae- | Corn |
| | | till 1:100 | Spot | maydis | |
| folpet or captan | Mandestrobin | from 100:1 | Gray Leaf | Cercospora zeae- | Corn |
| | | till 1:100 | Spot | maydis | |
| folpet or captan | Mandestrobin | from 100:1 | Gray Leaf | Cercospora zeae- | Corn |
| | | till 1:100 | Spot | maydis | |
| folpet or captan | mefentrifluconazole | from 100:1 | Gray Leaf | Cercospora zeae- | Corn |
| | | till 1:100 | Spot | maydis | |
| folpet or captan | mefentrifluconazole | from 100:1 | Gray Leaf | Cercospora zeae- | Corn |
| | | till 1:100 | Spot | maydis | |
| folpet or captan | metyltetraprole | from 100:1 | Gray Leaf | Cercospora zeae- | Corn |
| | | till 1:100 | Spot | maydis | |
| folpet or captan | metyltetraprole | from 100:1 | Gray Leaf | Cercospora zeae- | Corn |
| | | till 1:100 | Spot | maydis | |
| folpet or captan | picarbutrazox | from 100:1 | Gray Leaf | Cercospora zeae- | Corn |
| | | till 1:100 | Spot | maydis | |
| folpet or captan | picarbutrazox | from 100:1 | Gray Leaf | Cercospora zeae- | Corn |
| | | till 1:100 | Spot | maydis | |
| folpet or captan | prothioconazole | from 100:1 | Gray Leaf | Cercospora zeae- | Corn |
| | | till 1:100 | Spot | maydis | |
| folpet or captan | prothioconazole | from 100:1 | Gray Leaf | Cercospora zeae- | Corn |
| | | till 1:100 | Spot | maydis | |
| folpet or captan | pydiflumetofen | from 100:1 | Gray Leaf | Cercospora zeae- | Corn |
| | | till 1:100 | Spot | maydis | |
| folpet or captan | pydiflumetofen | from 100:1 | Gray Leaf | Cercospora zeae- | Corn |
| | | till 1:100 | Spot | maydis | |
| folpet or captan | Sulphur | from 100:1 | Gray Leaf | Cercospora zeae- | Corn |
| | | till 1:100 | Spot | maydis | |
| folpet or captan | Fluazinam | from 100:1 | Gray Leaf | Cercospora zeae- | Corn |
| | | till 1:100 | Spot | maydis | |
| folpet or captan | ADF-16 | from 100:1 | Late blight | Phytophthora | Potato/ |
| | | till 1:100 | | infestans | tomato |
| folpet or captan | ADF-16 | from 100:1 | Late blight | Phytophthora | Potato/ |
| | | till 1:100 | | infestans | tomato |
| folpet or captan | fenpicoxamid | from 100:1 | Late blight | Phytophthora | Potato/ |
| | | till 1:100 | | infestans | tomato |
| folpet or captan | fenpicoxamid | from 100:1 | Late blight | Phytophthora | Potato/ |
| | | till 1:100 | | infestans | tomato |
| folpet or captan | fenpropidin | from 100:1 | Late blight | Phytophthora | Potato/ |
| | | till 1:100 | | infestans | tomato |
| folpet or captan | fenpropidin | from 100:1 | Late blight | Phytophthora | Potato/ |
| | | till 1:100 | | infestans | tomato |
| folpet or captan | fluopyram | from 100:1 | Late blight | Phytophthora | Potato/ |
| | | till 1:100 | | infestans | tomato |
| folpet or captan | fluopyram | from 100:1 | Late blight | Phytophthora | Potato/ |
| | | till 1:100 | | infestans | tomato |
| folpet or captan | fluoxapiprolin | from 100:1 | Late blight | Phytophthora | Potato/ |
| | | till 1:100 | | infestans | tomato |
| folpet or captan | fluoxapiprolin | from 100:1 | Late blight | Phytophthora | Potato/ |
| | | till 1:100 | | infestans | tomato |
| folpet or captan | fluxapyroxad | from 100:1 | Late blight | Phytophthora | Potato/ |
| | | till 1:100 | | infestans | tomato |
| folpet or captan | fluxapyroxad | from 100:1 | Late blight | Phytophthora | Potato/ |
| | | till 1:100 | | infestans | tomato |
| folpet or captan | Mandestrobin | from 100:1 | Late blight | Phytophthora | Potato/ |
| | | till 1:100 | | infestans | tomato |
| folpet or captan | Mandestrobin | from 100:1 | Late blight | Phytophthora | Potato/ |
| | | till 1:100 | | infestans | tomato |
| folpet or captan | mefentrifluconazole | from 100:1 | Late blight | Phytophthora | Potato/ |
| | | till 1:100 | | infestans | tomato |
| folpet or captan | mefentrifluconazole | from 100:1 | Late blight | Phytophthora | Potato/ |
| | | till 1:100 | | infestans | tomato |
| folpet or captan | metyltetraprole | from 100:1 | Late blight | Phytophthora | Potato/ |
| | | till 1:100 | | infestans | tomato |
| folpet or captan | metyltetraprole | from 100:1 | Late blight | Phytophthora | Potato/ |
| | | till 1:100 | | infestans | tomato |
| folpet or captan | picarbutrazox | from 100:1 | Late blight | Phytophthora | Potato/ |
| | | till 1:100 | | infestans | tomato |
| folpet or captan | picarbutrazox | from 100:1 | Late blight | Phytophthora | Potato/ |
| | | till 1:100 | | infestans | tomato |
| folpet or captan | prothioconazole | from 100:1 | Late blight | Phytophthora | Potato/ |
| | | till 1:100 | | infestans | tomato |
| folpet or captan | prothioconazole | from 100:1 | Late blight | Phytophthora | Potato/ |
| | | till 1:100 | | infestans | tomato |
| folpet or captan | pydiflumetofen | from 100:1 | Late blight | Phytophthora | Potato/ |
| | | till 1:100 | | infestans | tomato |
| folpet or captan | pydiflumetofen | from 100:1 | Late blight | Phytophthora | Potato/ |
| | | till 1:100 | | infestans | tomato |
| folpet or captan | Sulphur | from 100:1 | Late blight | Phytophthora | Potato/ |
| | | till 1:100 | | infestans | tomato |
| folpet or captan | Fluazinam | from 100:1 | Late blight | Phytophthora | Potato/ |
| | | till 1:100 | | infestans | tomato |
| folpet or captan | ADF-16 | from 100:1 | leaf spot of | Cercospora | Sugar beet |
| | | till 1:100 | beet | beticola | |
| folpet or captan | ADF-16 | from 100:1 | leaf spot of | Cercospora | Sugar beet |
| | | till 1:100 | beet | beticola | |
| folpet or captan | fenpicoxamid | from 100:1 | leaf spot of | Cercospora | Sugar beet |
| | | till 1:100 | beet | beticola | |
| folpet or captan | fenpicoxamid | from 100:1 | leaf spot of | Cercospora | Sugar beet |
| | | till 1:100 | beet | beticola | |
| folpet or captan | fenpropidin | from 100:1 | leaf spot of | Cercospora | Sugar beet |
| | | till 1:100 | beet | beticola | |
| folpet or captan | fenpropidin | from 100:1 | leaf spot of | Cercospora | Sugar beet |
| | | till 1:100 | beet | beticola | |
| folpet or captan | fluopyram | from 100:1 | leaf spot of | Cercospora | Sugar beet |
| | | till 1:100 | beet | beticola | |
| folpet or captan | fluopyram | from 100:1 | leaf spot of | Cercospora | Sugar beet |
| | | till 1:100 | beet | beticola | |
| folpet or captan | fluoxapiprolin | from 100:1 | leaf spot of | Cercospora | Sugar beet |
| | | till 1:100 | beet | beticola | |
| folpet or captan | fluoxapiprolin | from 100:1 | leaf spot of | Cercospora | Sugar beet |
| | | till 1:100 | beet | beticola | |
| folpet or captan | fluxapyroxad | from 100:1 | leaf spot of | Cercospora | Sugar beet |
| | | till 1:100 | beet | beticola | |
| folpet or captan | fluxapyroxad | from 100:1 | leaf spot of | Cercospora | Sugar beet |
| | | till 1:100 | beet | beticola | |
| folpet or captan | Mandestrobin | from 100:1 | leaf spot of | Cercospora | Sugar beet |
| | | till 1:100 | beet | beticola | |
| folpet or captan | Mandestrobin | from 100:1 | leaf spot of | Cercospora | Sugar beet |
| | | till 1:100 | beet | beticola | |
| folpet or captan | mefentrifluconazole | from 100:1 | leaf spot of | Cercospora | Sugar beet |
| | | till 1:100 | beet | beticola | |
| folpet or captan | mefentrifluconazole | from 100:1 | leaf spot of | Cercospora | Sugar beet |
| | | till 1:100 | beet | beticola | |
| folpet or captan | metyltetraprole | from 100:1 | leaf spot of | Cercospora | Sugar beet |
| | | till 1:100 | beet | beticola | |
| folpet or captan | metyltetraprole | from 100:1 | leaf spot of | Cercospora | Sugar beet |
| | | till 1:100 | beet | beticola | |
| folpet or captan | picarbutrazox | from 100:1 | leaf spot of | Cercospora | Sugar beet |
| | | till 1:100 | beet | beticola | |
| folpet or captan | picarbutrazox | from 100:1 | leaf spot of | Cercospora | Sugar beet |
| | | till 1:100 | beet | beticola | |
| folpet or captan | prothioconazole | from 100:1 | leaf spot of | Cercospora | Sugar beet |
| | | till 1:100 | beet | beticola | |
| folpet or captan | prothioconazole | from 100:1 | leaf spot of | Cercospora | Sugar beet |
| | | till 1:100 | beet | beticola | |
| folpet or captan | pydiflumetofen | from 100:1 | leaf spot of | Cercospora | Sugar beet |
| | | till 1:100 | beet | beticola | |
| folpet or captan | pydiflumetofen | from 100:1 | leaf spot of | Cercospora | Sugar beet |
| | | till 1:100 | beet | beticola | |
| folpet or captan | Sulphur | from 100:1 | leaf spot of | Cercospora | Sugar beet |
| | | till 1:100 | beet | beticola | |
| folpet or captan | Fluazinam | from 100:1 | leaf spot of | Cercospora | Sugar beet |
| | | till 1:100 | beet | beticola | |
| folpet or captan | ADF-16 | from 100:1 | Northern Corn | Setosphaeria | Corn |
| | | till 1:100 | Leaf Blight | turcica | |
| folpet or captan | ADF-16 | from 100:1 | Northern Corn | Setosphaeria | Corn |
| | | till 1:100 | Leaf Blight | turcica | |
| folpet or captan | fenpicoxamid | from 100:1 | Northern Corn | Setosphaeria | Corn |
| | | till 1:100 | Leaf Blight | turcica | |
| folpet or captan | fenpicoxamid | from 100:1 | Northern Corn | Setosphaeria | Corn |
| | | till 1:100 | Leaf Blight | turcica | |
| folpet or captan | fenpropidin | from 100:1 | Northern Corn | Setosphaeria | Corn |
| | | till 1:100 | Leaf Blight | turcica | |
| folpet or captan | fenpropidin | from 100:1 | Northern Corn | Setosphaeria | Corn |
| | | till 1:100 | Leaf Blight | turcica | |
| folpet or captan | fluopyram | from 100:1 | Northern Corn | Setosphaeria | Corn |
| | | till 1:100 | Leaf Blight | turcica | |
| folpet or captan | fluopyram | from 100:1 | Northern Corn | Setosphaeria | Corn |
| | | till 1:100 | Leaf Blight | turcica | |
| folpet or captan | fluoxapiprolin | from 100:1 | Northern Corn | Setosphaeria | Corn |
| | | till 1:100 | Leaf Blight | turcica | |
| folpet or captan | fluoxapiprolin | from 100:1 | Northern Corn | Setosphaeria | Corn |
| | | till 1:100 | Leaf Blight | turcica | |
| folpet or captan | fluxapyroxad | from 100:1 | Northern Corn | Setosphaeria | Corn |
| | | till 1:100 | Leaf Blight | turcica | |
| folpet or captan | fluxapyroxad | from 100:1 | Northern Corn | Setosphaeria | Corn |
| | | till 1:100 | Leaf Blight | turcica | |
| folpet or captan | Mandestrobin | from 100:1 | Northern Corn | Setosphaeria | Corn |
| | | till 1:100 | Leaf Blight | turcica | |
| folpet or captan | Mandestrobin | from 100:1 | Northern Corn | Setosphaeria | Corn |
| | | till 1:100 | Leaf Blight | turcica | |
| folpet or captan | mefentrifluconazole | from 100:1 | Northern Corn | Setosphaeria | Corn |
| | | till 1:100 | Leaf Blight | turcica | |
| folpet or captan | mefentrifluconazole | from 100:1 | Northern Corn | Setosphaeria | Corn |
| | | till 1:100 | Leaf Blight | turcica | |
| folpet or captan | metyltetraprole | from 100:1 | Northern Corn | Setosphaeria | Corn |
| | | till 1:100 | Leaf Blight | turcica | |
| folpet or captan | metyltetraprole | from 100:1 | Northern Corn | Setosphaeria | Corn |
| | | till 1:100 | Leaf Blight | turcica | |
| folpet or captan | picarbutrazox | from 100:1 | Northern Corn | Setosphaeria | Corn |
| | | till 1:100 | Leaf Blight | turcica | |
| folpet or captan | picarbutrazox | from 100:1 | Northern Corn | Setosphaeria | Corn |
| | | till 1:100 | Leaf Blight | turcica | |
| folpet or captan | prothioconazole | from 100:1 | Northern Corn | Setosphaeria | Corn |
| | | till 1:100 | Leaf Blight | turcica | |
| folpet or captan | prothioconazole | from 100:1 | Northern Corn | Setosphaeria | Corn |
| | | till 1:100 | Leaf Blight | turcica | |
| folpet or captan | pydiflumetofen | from 100:1 | Northern Corn | Setosphaeria | Corn |
| | | till 1:100 | Leaf Blight | turcica | |
| folpet or captan | pydiflumetofen | from 100:1 | Northern Corn | Setosphaeria | Corn |
| | | till 1:100 | Leaf Blight | turcica | |
| folpet or captan | Sulphur | from 100:1 | Northern Corn | Setosphaeria | Corn |
| | | till 1:100 | Leaf Blight | turcica | |
| folpet or captan | Fluazinam | from 100:1 | Northern Corn | Setosphaeria | Corn |
| | | till 1:100 | Leaf Blight | turcica | |
| folpet or captan | ADF-16 | from 100:1 | Northern Corn | Cochliobolus | Corn |
| | | till 1:100 | Leaf Spot | carbonum | |
| folpet or captan | ADF-16 | from 100:1 | Northern Corn | Cochliobolus | Corn |
| | | till 1:100 | Leaf Spot | carbonum | |
| folpet or captan | fenpicoxamid | from 100:1 | Northern Corn | Cochliobolus | Corn |
| | | till 1:100 | Leaf Spot | carbonum | |
| folpet or captan | fenpicoxamid | from 100:1 | Northern Corn | Cochliobolus | Corn |
| | | till 1:100 | Leaf Spot | carbonum | |
| folpet or captan | fenpropidin | from 100:1 | Northern Corn | Cochliobolus | Corn |
| | | till 1:100 | Leaf Spot | carbonum | |
| folpet or captan | fenpropidin | from 100:1 | Northern Corn | Cochliobolus | Corn |
| | | till 1:100 | Leaf Spot | carbonum | |
| folpet or captan | fluopyram | from 100:1 | Northern Corn | Cochliobolus | Corn |
| | | till 1:100 | Leaf Spot | carbonum | |
| folpet or captan | fluopyram | from 100:1 | Northern Corn | Cochliobolus | Corn |
| | | till 1:100 | Leaf Spot | carbonum | |
| folpet or captan | fluoxapiprolin | from 100:1 | Northern Corn | Cochliobolus | Corn |
| | | till 1:100 | Leaf Spot | carbonum | |
| folpet or captan | fluoxapiprolin | from 100:1 | Northern Corn | Cochliobolus | Corn |
| | | till 1:100 | Leaf Spot | carbonum | |
| folpet or captan | fluxapyroxad | from 100:1 | Northern Corn | Cochliobolus | Corn |
| | | till 1:100 | Leaf Spot | carbonum | |
| folpet or captan | fluxapyroxad | from 100:1 | Northern Corn | Cochliobolus | Corn |
| | | till 1:100 | Leaf Spot | carbonum | |
| folpet or captan | Mandestrobin | from 100:1 | Northern Corn | Cochliobolus | Corn |
| | | till 1:100 | Leaf Spot | carbonum | |
| folpet or captan | Mandestrobin | from 100:1 | Northern Corn | Cochliobolus | Corn |
| | | till 1:100 | Leaf Spot | carbonum | |
| folpet or captan | mefentrifluconazole | from 100:1 | Northern Corn | Cochliobolus | Corn |
| | | till 1:100 | Leaf Spot | carbonum | |
| folpet or captan | mefentrifluconazole | from 100:1 | Northern Corn | Cochliobolus | Corn |
| | | till 1:100 | Leaf Spot | carbonum | |
| folpet or captan | metyltetraprole | from 100:1 | Northern Corn | Cochliobolus | Corn |
| | | till 1:100 | Leaf Spot | carbonum | |
| folpet or captan | metyltetraprole | from 100:1 | Northern Corn | Cochliobolus | Corn |
| | | till 1:100 | Leaf Spot | carbonum | |
| folpet or captan | picarbutrazox | from 100:1 | Northern Corn | Cochliobolus | Corn |
| | | till 1:100 | Leaf Spot | carbonum | |
| folpet or captan | picarbutrazox | from 100:1 | Northern Corn | Cochliobolus | Corn |
| | | till 1:100 | Leaf Spot | carbonum | |
| folpet or captan | prothioconazole | from 100:1 | Northern Corn | Cochliobolus | Corn |
| | | till 1:100 | Leaf Spot | carbonum | |
| folpet or captan | prothioconazole | from 100:1 | Northern Corn | Cochliobolus | Corn |
| | | till 1:100 | Leaf Spot | carbonum | |
| folpet or captan | pydiflumetofen | from 100:1 | Northern Corn | Cochliobolus | Corn |
| | | till 1:100 | Leaf Spot | carbonum | |
| folpet or captan | pydiflumetofen | from 100:1 | Northern Corn | Cochliobolus | Corn |
| | | till 1:100 | Leaf Spot | carbonum | |
| folpet or captan | Sulphur | from 100:1 | Northern Corn | Cochliobolus | Corn |
| | | till 1:100 | Leaf Spot | carbonum | |
| folpet or captan | Fluazinam | from 100:1 | Northern Corn | Cochliobolus | Corn |
| | | till 1:100 | Leaf Spot | carbonum | |
| folpet or captan | ADF-16 | from 100:1 | Ramularia leaf | Ramularia collo- | Cereals |
| | | till 1:100 | spot | cygni | |
| folpet or captan | ADF-16 | from 100:1 | Ramularia leaf | Ramularia collo- | Cereals |
| | | till 1:100 | spot | cygni | |
| folpet or captan | fenpicoxamid | from 100:1 | Ramularia leaf | Ramularia collo- | Cereals |
| | | till 1:100 | spot | cygni | |
| folpet or captan | fenpicoxamid | from 100:1 | Ramularia leaf | Ramularia collo- | Cereals |
| | | till 1:100 | spot | cygni | |
| folpet or captan | fenpropidin | from 100:1 | Ramularia leaf | Ramularia collo- | Cereals |
| | | till 1:100 | spot | cygni | |
| folpet or captan | fenpropidin | from 100:1 | Ramularia leaf | Ramularia collo- | Cereals |
| | | till 1:100 | spot | cygni | |
| folpet or captan | fluopyram | from 100:1 | Ramularia leaf | Ramularia collo- | Cereals |
| | | till 1:100 | spot | cygni | |
| folpet or captan | fluopyram | from 100:1 | Ramularia leaf | Ramularia collo- | Cereals |
| | | till 1:100 | spot | cygni | |
| folpet or captan | fluoxapiprolin | from 100:1 | Ramularia leaf | Ramularia collo- | Cereals |
| | | till 1:100 | spot | cygni | |
| folpet or captan | fluoxapiprolin | from 100:1 | Ramularia leaf | Ramularia collo- | Cereals |
| | | till 1:100 | spot | cygni | |
| folpet or captan | fluxapyroxad | from 100:1 | Ramularia leaf | Ramularia collo- | Cereals |
| | | till 1:100 | spot | cygni | |
| folpet or captan | fluxapyroxad | from 100:1 | Ramularia leaf | Ramularia collo- | Cereals |
| | | till 1:100 | spot | cygni | |
| folpet or captan | Mandestrobin | from 100:1 | Ramularia leaf | Ramularia collo- | Cereals |
| | | till 1:100 | spot | cygni | |
| folpet or captan | Mandestrobin | from 100:1 | Ramularia leaf | Ramularia collo- | Cereals |
| | | till 1:100 | spot | cygni | |
| folpet or captan | mefentrifluconazole | from 100:1 | Ramularia leaf | Ramularia collo- | Cereals |
| | | till 1:100 | spot | cygni | |
| folpet or captan | mefentrifluconazole | from 100:1 | Ramularia leaf | Ramularia collo- | Cereals |
| | | till 1:100 | spot | cygni | |
| folpet or captan | metyltetraprole | from 100:1 | Ramularia leaf | Ramularia collo- | Cereals |
| | | till 1:100 | spot | cygni | |
| folpet or captan | metyltetraprole | from 100:1 | Ramularia leaf | Ramularia collo- | Cereals |
| | | till 1:100 | spot | cygni | |
| folpet or captan | picarbutrazox | from 100:1 | Ramularia leaf | Ramularia collo- | Cereals |
| | | till 1:100 | spot | cygni | |
| folpet or captan | picarbutrazox | from 100:1 | Ramularia leaf | Ramularia collo- | Cereals |
| | | till 1:100 | spot | cygni | |
| folpet or captan | prothioconazole | from 100:1 | Ramularia leaf | Ramularia collo- | Cereals |
| | | till 1:100 | spot | cygni | |
| folpet or captan | prothioconazole | from 100:1 | Ramularia leaf | Ramularia collo- | Cereals |
| | | till 1:100 | spot | cygni | |
| folpet or captan | pydiflumetofen | from 100:1 | Ramularia leaf | Ramularia collo- | Cereals |
| | | till 1:100 | spot | cygni | |
| folpet or captan | pydiflumetofen | from 100:1 | Ramularia leaf | Ramularia collo- | Cereals |
| | | till 1:100 | spot | cygni | |
| folpet or captan | folpet or captan | from 100:1 | Ramularia leaf | Ramularia collo- | Cereals |
| | | till 1:100 | spot | cygni | |
| folpet or captan | Sulphur | from 100:1 | Ramularia leaf | Ramularia collo- | Cereals |
| | | till 1:100 | spot | cygni | |
| folpet or captan | Fluazinam | from 100:1 | Ramularia leaf | Ramularia collo- | Cereals |
| | | till 1:100 | spot | cygni | |
| folpet or captan | ADF-16 | from 100:1 | Ramularia leaf | Ramularia areola | Cotton |
| | | till 1:100 | spot | | |
| folpet or captan | ADF-16 | from 100:1 | Ramularia leaf | Ramularia areola | Cotton |
| | | till 1:100 | spot | | |
| folpet or captan | fenpicoxamid | from 100:1 | Ramularia leaf | Ramularia areola | Cotton |
| | | till 1:100 | spot | | |
| folpet or captan | fenpicoxamid | from 100:1 | Ramularia leaf | Ramularia areola | Cotton |
| | | till 1:100 | spot | | |
| folpet or captan | fenpropidin | from 100:1 | Ramularia leaf | Ramularia areola | Cotton |
| | | till 1:100 | spot | | |
| folpet or captan | fenpropidin | from 100:1 | Ramularia leaf | Ramularia areola | Cotton |
| | | till 1:100 | spot | | |
| folpet or captan | fluopyram | from 100:1 | Ramularia leaf | Ramularia areola | Cotton |
| | | till 1:100 | spot | | |
| folpet or captan | fluopyram | from 100:1 | Ramularia leaf | Ramularia areola | Cotton |
| | | till 1:100 | spot | | |
| folpet or captan | fluoxapiprolin | from 100:1 | Ramularia leaf | Ramularia areola | Cotton |
| | | till 1:100 | spot | | |
| folpet or captan | fluoxapiprolin | from 100:1 | Ramularia leaf | Ramularia areola | Cotton |
| | | till 1:100 | spot | | |
| folpet or captan | fluxapyroxad | from 100:1 | Ramularia leaf | Ramularia areola | Cotton |
| | | till 1:100 | spot | | |
| folpet or captan | fluxapyroxad | from 100:1 | Ramularia leaf | Ramularia areola | Cotton |
| | | till 1:100 | spot | | |
| folpet or captan | Mandestrobin | from 100:1 | Ramularia leaf | Ramularia areola | Cotton |
| | | till 1:100 | spot | | |
| folpet or captan | Mandestrobin | from 100:1 | Ramularia leaf | Ramularia areola | Cotton |
| | | till 1:100 | spot | | |
| folpet or captan | mefentrifluconazole | from 100:1 | Ramularia leaf | Ramularia areola | Cotton |
| | | till 1:100 | spot | | |
| folpet or captan | mefentrifluconazole | from 100:1 | Ramularia leaf | Ramularia areola | Cotton |
| | | till 1:100 | spot | | |
| folpet or captan | metyltetraprole | from 100:1 | Ramularia leaf | Ramularia areola | Cotton |
| | | till 1:100 | spot | | |
| folpet or captan | metyltetraprole | from 100:1 | Ramularia leaf | Ramularia areola | Cotton |
| | | till 1:100 | spot | | |
| folpet or captan | picarbutrazox | from 100:1 | Ramularia leaf | Ramularia areola | Cotton |
| | | till 1:100 | spot | | |
| folpet or captan | picarbutrazox | from 100:1 | Ramularia leaf | Ramularia areola | Cotton |
| | | till 1:100 | spot | | |
| folpet or captan | prothioconazole | from 100:1 | Ramularia leaf | Ramularia areola | Cotton |
| | | till 1:100 | spot | | |
| folpet or captan | prothioconazole | from 100:1 | Ramularia leaf | Ramularia areola | Cotton |
| | | till 1:100 | spot | | |
| folpet or captan | pydiflumetofen | from 100:1 | Ramularia leaf | Ramularia areola | Cotton |
| | | till 1:100 | spot | | |
| folpet or captan | pydiflumetofen | from 100:1 | Ramularia leaf | Ramularia areola | Cotton |
| | | till 1:100 | spot | | |
| folpet or captan | Sulphur | from 100:1 | Ramularia leaf | Ramularia areola | Cotton |
| | | till 1:100 | spot | | |
| folpet or captan | Fluazinam | from 100:1 | Ramularia leaf | Ramularia areola | Cotton |
| | | till 1:100 | spot | | |
| folpet or captan | ADF-16 | from 100:1 | Ramularia leaf | Ramularia | Sugar beet |
| | | till 1:100 | spot | beticola | |
| folpet or captan | ADF-16 | from 100:1 | Ramularia leaf | Ramularia | Sugar beet |
| | | till 1:100 | spot | beticola | |
| folpet or captan | fenpicoxamid | from 100:1 | Ramularia leaf | Ramularia | Sugar beet |
| | | till 1:100 | spot | beticola | |
| folpet or captan | fenpicoxamid | from 100:1 | Ramularia leaf | Ramularia | Sugar beet |
| | | till 1:100 | spot | beticola | |
| folpet or captan | fenpropidin | from 100:1 | Ramularia leaf | Ramularia | Sugar beet |
| | | till 1:100 | spot | beticola | |
| folpet or captan | fenpropidin | from 100:1 | Ramularia leaf | Ramularia | Sugar beet |
| | | till 1:100 | spot | beticola | |
| folpet or captan | fluopyram | from 100:1 | Ramularia leaf | Ramularia | Sugar beet |
| | | till 1:100 | spot | beticola | |
| folpet or captan | fluopyram | from 100:1 | Ramularia leaf | Ramularia | Sugar beet |
| | | till 1:100 | spot | beticola | |
| folpet or captan | fluoxapiprolin | from 100:1 | Ramularia leaf | Ramularia | Sugar beet |
| | | till 1:100 | spot | beticola | |
| folpet or captan | fluoxapiprolin | from 100:1 | Ramularia leaf | Ramularia | Sugar beet |
| | | till 1:100 | spot | beticola | |
| folpet or captan | fluxapyroxad | from 100:1 | Ramularia leaf | Ramularia | Sugar beet |
| | | till 1:100 | spot | beticola | |
| folpet or captan | fluxapyroxad | from 100:1 | Ramularia leaf | Ramularia | Sugar beet |
| | | till 1:100 | spot | beticola | |
| folpet or captan | Mandestrobin | from 100:1 | Ramularia leaf | Ramularia | Sugar beet |
| | | till 1:100 | spot | beticola | |
| folpet or captan | Mandestrobin | from 100:1 | Ramularia leaf | Ramularia | Sugar beet |
| | | till 1:100 | spot | beticola | |
| folpet or captan | mefentrifluconazole | from 100:1 | Ramularia leaf | Ramularia | Sugar beet |
| | | till 1:100 | spot | beticola | |
| folpet or captan | mefentrifluconazole | from 100:1 | Ramularia leaf | Ramularia | Sugar beet |
| | | till 1:100 | spot | beticola | |
| folpet or captan | metyltetraprole | from 100:1 | Ramularia leaf | Ramularia | Sugar beet |
| | | till 1:100 | spot | beticola | |
| folpet or captan | metyltetraprole | from 100:1 | Ramularia leaf | Ramularia | Sugar beet |
| | | till 1:100 | spot | beticola | |
| folpet or captan | picarbutrazox | from 100:1 | Ramularia leaf | Ramularia | Sugar beet |
| | | till 1:100 | spot | beticola | |
| folpet or captan | picarbutrazox | from 100:1 | Ramularia leaf | Ramularia | Sugar beet |
| | | till 1:100 | spot | beticola | |
| folpet or captan | prothioconazole | from 100:1 | Ramularia leaf | Ramularia | Sugar beet |
| | | till 1:100 | spot | beticola | |
| folpet or captan | prothioconazole | from 100:1 | Ramularia leaf | Ramularia | Sugar beet |
| | | till 1:100 | spot | beticola | |
| folpet or captan | pydiflumetofen | from 100:1 | Ramularia leaf | Ramularia | Sugar beet |
| | | till 1:100 | spot | beticola | |
| folpet or captan | pydiflumetofen | from 100:1 | Ramularia leaf | Ramularia | Sugar beet |
| | | till 1:100 | spot | beticola | |
| folpet or captan | Sulphur | from 100:1 | Ramularia leaf | Ramularia | Sugar beet |
| | | till 1:100 | spot | beticola | |
| folpet or captan | Fluazinam | from 100:1 | Ramularia leaf | Ramularia | Sugar beet |
| | | till 1:100 | spot | beticola | |
| folpet or captan | ADF-16 | from 100:1 | Rice Blast | Pyricularia oryzae | Rice |
| | | till 1:100 | | | |
| folpet or captan | ADF-16 | from 100:1 | Rice Blast | Pyricularia oryzae | Rice |
| | | till 1:100 | | | |
| folpet or captan | fenpicoxamid | from 100:1 | Rice Blast | Pyricularia oryzae | Rice |
| | | till 1:100 | | | |
| folpet or captan | fenpicoxamid | from 100:1 | Rice Blast | Pyricularia oryzae | Rice |
| | | till 1:100 | | | |
| folpet or captan | fenpropidin | from 100:1 | Rice Blast | Pyricularia oryzae | Rice |
| | | till 1:100 | | | |
| folpet or captan | fenpropidin | from 100:1 | Rice Blast | Pyricularia oryzae | Rice |
| | | till 1:100 | | | |
| folpet or captan | fluopyram | from 100:1 | Rice Blast | Pyricularia oryzae | Rice |
| | | till 1:100 | | | |
| folpet or captan | fluopyram | from 100:1 | Rice Blast | Pyricularia oryzae | Rice |
| | | till 1:100 | | | |
| folpet or captan | fluoxapiprolin | from 100:1 | Rice Blast | Pyricularia oryzae | Rice |
| | | till 1:100 | | | |
| folpet or captan | fluoxapiprolin | from 100:1 | Rice Blast | Pyricularia oryzae | Rice |
| | | till 1:100 | | | |
| folpet or captan | fluxapyroxad | from 100:1 | Rice Blast | Pyricularia oryzae | Rice |
| | | till 1:100 | | | |
| folpet or captan | fluxapyroxad | from 100:1 | Rice Blast | Pyricularia oryzae | Rice |
| | | till 1:100 | | | |
| folpet or captan | Mandestrobin | from 100:1 | Rice Blast | Pyricularia oryzae | Rice |
| | | till 1:100 | | | |
| folpet or captan | Mandestrobin | from 100:1 | Rice Blast | Pyricularia oryzae | Rice |
| | | till 1:100 | | | |
| folpet or captan | mefentrifluconazole | from 100:1 | Rice Blast | Pyricularia oryzae | Rice |
| | | till 1:100 | | | |
| folpet or captan | mefentrifluconazole | from 100:1 | Rice Blast | Pyricularia oryzae | Rice |
| | | till 1:100 | | | |
| folpet or captan | metyltetraprole | from 100:1 | Rice Blast | Pyricularia oryzae | Rice |
| | | till 1:100 | | | |
| folpet or captan | metyltetraprole | from 100:1 | Rice Blast | Pyricularia oryzae | Rice |
| | | till 1:100 | | | |
| folpet or captan | picarbutrazox | from 100:1 | Rice Blast | Pyricularia oryzae | Rice |
| | | till 1:100 | | | |
| folpet or captan | picarbutrazox | from 100:1 | Rice Blast | Pyricularia oryzae | Rice |
| | | till 1:100 | | | |
| folpet or captan | prothioconazole | from 100:1 | Rice Blast | Pyricularia oryzae | Rice |
| | | till 1:100 | | | |
| folpet or captan | prothioconazole | from 100:1 | Rice Blast | Pyricularia oryzae | Rice |
| | | till 1:100 | | | |
| folpet or captan | pydiflumetofen | from 100:1 | Rice Blast | Pyricularia oryzae | Rice |
| | | till 1:100 | | | |
| folpet or captan | pydiflumetofen | from 100:1 | Rice Blast | Pyricularia oryzae | Rice |
| | | till 1:100 | | | |
| folpet or captan | Sulphur | from 100:1 | Rice Blast | Pyricularia oryzae | Rice |
| | | till 1:100 | | | |
| folpet or captan | Fluazinam | from 100:1 | Rice Blast | Pyricularia oryzae | Rice |
| | | till 1:100 | | | |
| folpet or captan | ADF-16 | from 100:1 | Rust | Uromyces betae | Sugar beet |
| | | till 1:100 | | | |
| folpet or captan | ADF-16 | from 100:1 | Rust | Uromyces betae | Sugar beet |
| | | till 1:100 | | | |
| folpet or captan | fenpicoxamid | from 100:1 | Rust | Uromyces betae | Sugar beet |
| | | till 1:100 | | | |
| folpet or captan | fenpicoxamid | from 100:1 | Rust | Uromyces betae | Sugar beet |
| | | till 1:100 | | | |
| folpet or captan | fenpropidin | from 100:1 | Rust | Uromyces betae | Sugar beet |
| | | till 1:100 | | | |
| folpet or captan | fenpropidin | from 100:1 | Rust | Uromyces betae | Sugar beet |
| | | till 1:100 | | | |
| folpet or captan | fluopyram | from 100:1 | Rust | Uromyces betae | Sugar beet |
| | | till 1:100 | | | |
| folpet or captan | fluopyram | from 100:1 | Rust | Uromyces betae | Sugar beet |
| | | till 1:100 | | | |
| folpet or captan | fluoxapiprolin | from 100:1 | Rust | Uromyces betae | Sugar beet |
| | | till 1:100 | | | |
| folpet or captan | fluoxapiprolin | from 100:1 | Rust | Uromyces betae | Sugar beet |
| | | till 1:100 | | | |
| folpet or captan | fluxapyroxad | from 100:1 | Rust | Uromyces betae | Sugar beet |
| | | till 1:100 | | | |
| folpet or captan | fluxapyroxad | from 100:1 | Rust | Uromyces betae | Sugar beet |
| | | till 1:100 | | | |
| folpet or captan | Mandestrobin | from 100:1 | Rust | Uromyces betae | Sugar beet |
| | | till 1:100 | | | |
| folpet or captan | Mandestrobin | from 100:1 | Rust | Uromyces betae | Sugar beet |
| | | till 1:100 | | | |
| folpet or captan | mefentrifluconazole | from 100:1 | Rust | Uromyces betae | Sugar beet |
| | | till 1:100 | | | |
| folpet or captan | mefentrifluconazole | from 100:1 | Rust | Uromyces betae | Sugar beet |
| | | till 1:100 | | | |
| folpet or captan | metyltetraprole | from 100:1 | Rust | Uromyces betae | Sugar beet |
| | | till 1:100 | | | |
| folpet or captan | metyltetraprole | from 100:1 | Rust | Uromyces betae | Sugar beet |
| | | till 1:100 | | | |
| folpet or captan | picarbutrazox | from 100:1 | Rust | Uromyces betae | Sugar beet |
| | | till 1:100 | | | |
| folpet or captan | picarbutrazox | from 100:1 | Rust | Uromyces betae | Sugar beet |
| | | till 1:100 | | | |
| folpet or captan | prothioconazole | from 100:1 | Rust | Uromyces betae | Sugar beet |
| | | till 1:100 | | | |
| folpet or captan | prothioconazole | from 100:1 | Rust | Uromyces betae | Sugar beet |
| | | till 1:100 | | | |
| folpet or captan | pydiflumetofen | from 100:1 | Rust | Uromyces betae | Sugar beet |
| | | till 1:100 | | | |
| folpet or captan | pydiflumetofen | from 100:1 | Rust | Uromyces betae | Sugar beet |
| | | till 1:100 | | | |
| folpet or captan | Sulphur | from 100:1 | Rust | Uromyces betae | Sugar beet |
| | | till 1:100 | | | |
| folpet or captan | Fluazinam | from 100:1 | Rust | Uromyces betae | Sugar beet |
| | | till 1:100 | | | |
| folpet or captan | ADF-16 | from 100:1 | Scab | Venturia | Pome fruit |
| | | till 1:100 | | inaequalis | |
| folpet or captan | fenpicoxamid | from 100:1 | Scab | Venturia | Pome fruit |
| | | till 1:100 | | inaequalis | |
| folpet or captan | fenpropidin | 3:1 | Scab | Venturia | Pome fruit |
| | | | | inaequalis | |
| folpet or captan | fenpropidin | 3.75:1 | Scab | Venturia | Pome fruit |
| | | | | inaequalis | |
| folpet or captan | fenpropidin | 4.5:1 | Scab | Venturia | Pome fruit |
| | | | | inaequalis | |
| folpet or captan | fenpropidin | from 100:1 | Scab | Venturia | Pome fruit |
| | | till 1:100 | | inaequalis | |
| folpet or captan | fluopyram | 5:1 | Scab | Venturia | Pome fruit |
| | | | | inaequalis | |
| folpet or captan | fluopyram | 6:1 | Scab | Venturia | Pome fruit |
| | | | | inaequalis | |
| folpet or captan | fluopyram | from 100:1 | Scab | Venturia | Pome fruit |
| | | till 1:100 | | inaequalis | |
| folpet or captan | fluoxapiprolin | from 100:1 | Scab | Venturia | Pome fruit |
| | | till 1:100 | | inaequalis | |
| folpet or captan | fluxapyroxad | 12:1 | Scab | Venturia | Pome fruit |
| | | | | inaequalis | |
| folpet or captan | fluxapyroxad | 16:1 | Scab | Venturia | Pome fruit |
| | | | | inaequalis | |
| folpet or captan | fluxapyroxad | 20:1 | Scab | Venturia | Pome fruit |
| | | | | inaequalis | |
| folpet or captan | fluxapyroxad | from 100:1 | Scab | Venturia | Pome fruit |
| | | till 1:100 | | inaequalis | |
| folpet or captan | Mandestrobin | from 100:1 | Scab | Venturia | Pome fruit |
| | | till 1:100 | | inaequalis | |
| folpet or captan | mefentrifluconazole | from 100:1 | Scab | Venturia | Pome fruit |
| | | till 1:100 | | inaequalis | |
| folpet or captan | metyltetraprole | from 100:1 | Scab | Venturia | Pome fruit |
| | | till 1:100 | | inaequalis | |
| folpet or captan | picarbutrazox | from 100:1 | Scab | Venturia | Pome fruit |
| | | till 1:100 | | inaequalis | |
| folpet or captan | prothioconazole | from 100:1 | Scab | Venturia | Pome fruit |
| | | till 1:100 | | inaequalis | |
| folpet or captan | pydiflumetofen | from 100:1 | Scab | Venturia | Pome fruit |
| | | till 1:100 | | inaequalis | |
| folpet or captan | Sulphur | from 100:1 | Scab | Venturia | Pome fruit |
| | | till 1:100 | | inaequalis | |
| folpet or captan | Fluazinam | from 100:1 | Scab | Venturia | Pome fruit |
| | | till 1:100 | | inaequalis | |
| folpet or captan | ADF-16 | from 100:1 | Sclerotinia | Sclerotinia | OSR |
| | | till 1:100 | | sclerotiorum | |
| folpet or captan | ADF-16 | from 100:1 | Sclerotinia | Sclerotinia | OSR |
| | | till 1:100 | | sclerotiorum | |
| folpet or captan | fenpicoxamid | from 100:1 | Sclerotinia | Sclerotinia | OSR |
| | | till 1:100 | | sclerotiorum | |
| folpet or captan | fenpicoxamid | from 100:1 | Sclerotinia | Sclerotinia | OSR |
| | | till 1:100 | | sclerotiorum | |
| folpet or captan | fenpropidin | from 100:1 | Sclerotinia | Sclerotinia | OSR |
| | | till 1:100 | | sclerotiorum | |
| folpet or captan | fenpropidin | from 100:1 | Sclerotinia | Sclerotinia | OSR |
| | | till 1:100 | | sclerotiorum | |
| folpet or captan | fluopyram | from 100:1 | Sclerotinia | Sclerotinia | OSR |
| | | till 1:100 | | sclerotiorum | |
| folpet or captan | fluopyram | from 100:1 | Sclerotinia | Sclerotinia | OSR |
| | | till 1:100 | | sclerotiorum | |
| folpet or captan | fluoxapiprolin | from 100:1 | Sclerotinia | Sclerotinia | OSR |
| | | till 1:100 | | sclerotiorum | |
| folpet or captan | fluoxapiprolin | from 100:1 | Sclerotinia | Sclerotinia | OSR |
| | | till 1:100 | | sclerotiorum | |
| folpet or captan | fluxapyroxad | from 100:1 | Sclerotinia | Sclerotinia | OSR |
| | | till 1:100 | | sclerotiorum | |
| folpet or captan | fluxapyroxad | from 100:1 | Sclerotinia | Sclerotinia | OSR |
| | | till 1:100 | | sclerotiorum | |
| folpet or captan | Mandestrobin | from 100:1 | Sclerotinia | Sclerotinia | OSR |
| | | till 1:100 | | sclerotiorum | |
| folpet or captan | Mandestrobin | from 100:1 | Sclerotinia | Sclerotinia | OSR |
| | | till 1:100 | | sclerotiorum | |
| folpet or captan | mefentrifluconazole | from 100:1 | Sclerotinia | Sclerotinia | OSR |
| | | till 1:100 | | sclerotiorum | |
| folpet or captan | mefentrifluconazole | from 100:1 | Sclerotinia | Sclerotinia | OSR |
| | | till 1:100 | | sclerotiorum | |
| folpet or captan | metyltetraprole | from 100:1 | Sclerotinia | Sclerotinia | OSR |
| | | till 1:100 | | sclerotiorum | |
| folpet or captan | metyltetraprole | from 100:1 | Sclerotinia | Sclerotinia | OSR |
| | | till 1:100 | | sclerotiorum | |
| folpet or captan | picarbutrazox | from 100:1 | Sclerotinia | Sclerotinia | OSR |
| | | till 1:100 | | sclerotiorum | |
| folpet or captan | picarbutrazox | from 100:1 | Sclerotinia | Sclerotinia | OSR |
| | | till 1:100 | | sclerotiorum | |
| folpet or captan | prothioconazole | from 100:1 | Sclerotinia | Sclerotinia | OSR |
| | | till 1:100 | | sclerotiorum | |
| folpet or captan | prothioconazole | from 100:1 | Sclerotinia | Sclerotinia | OSR |
| | | till 1:100 | | sclerotiorum | |
| folpet or captan | pydiflumetofen | from 100:1 | Sclerotinia | Sclerotinia | OSR |
| | | till 1:100 | | sclerotiorum | |
| folpet or captan | pydiflumetofen | from 100:1 | Sclerotinia | Sclerotinia | OSR |
| | | till 1:100 | | sclerotiorum | |
| folpet or captan | Sulphur | from 100:1 | Sclerotinia | Sclerotinia | OSR |
| | | till 1:100 | | sclerotiorum | |
| folpet or captan | Fluazinam | from 100:1 | Sclerotinia | Sclerotinia | OSR |
| | | till 1:100 | | sclerotiorum | |
| folpet or captan | ADF-16 | from 100:1 | Septoria | Zymoseptoria | Cereals |
| | | till 1:100 | | tritici | |
| folpet or captan | ADF-16 | from 100:1 | Septoria | Zymoseptoria | Cereals |
| | | till 1:100 | | tritici | |
| folpet or captan | fenpicoxamid | from 100:1 | Septoria | Zymoseptoria | Cereals |
| | | till 1:100 | | tritici | |
| folpet or captan | fenpicoxamid | from 100:1 | Septoria | Zymoseptoria | Cereals |
| | | till 1:100 | | tritici | |
| folpet or captan | fenpropidin | from 100:1 | Septoria | Zymoseptoria | Cereals |
| | | till 1:100 | | tritici | |
| folpet or captan | fenpropidin | from 100:1 | Septoria | Zymoseptoria | Cereals |
| | | till 1:100 | | tritici | |
| folpet or captan | fluopyram | from 100:1 | Septoria | Zymoseptoria | Cereals |
| | | till 1:100 | | tritici | |
| folpet or captan | fluopyram | from 100:1 | Septoria | Zymoseptoria | Cereals |
| | | till 1:100 | | tritici | |
| folpet or captan | fluoxapiprolin | from 100:1 | Septoria | Zymoseptoria | Cereals |
| | | till 1:100 | | tritici | |
| folpet or captan | fluoxapiprolin | from 100:1 | Septoria | Zymoseptoria | Cereals |
| | | till 1:100 | | tritici | |
| folpet or captan | fluxapyroxad | from 100:1 | Septoria | Zymoseptoria | Cereals |
| | | till 1:100 | | tritici | |
| folpet or captan | fluxapyroxad | from 100:1 | Septoria | Zymoseptoria | Cereals |
| | | till 1:100 | | tritici | |
| folpet or captan | Mandestrobin | from 100:1 | Septoria | Zymoseptoria | Cereals |
| | | till 1:100 | | tritici | |
| folpet or captan | Mandestrobin | from 100:1 | Septoria | Zymoseptoria | Cereals |
| | | till 1:100 | | tritici | |
| folpet or captan | mefentrifluconazole | from 100:1 | Septoria | Zymoseptoria | Cereals |
| | | till 1:100 | | tritici | |
| folpet or captan | mefentrifluconazole | from 100:1 | Septoria | Zymoseptoria | Cereals |
| | | till 1:100 | | tritici | |
| folpet or captan | metyltetraprole | from 100:1 | Septoria | Zymoseptoria | Cereals |
| | | till 1:100 | | tritici | |
| folpet or captan | metyltetraprole | from 100:1 | Septoria | Zymoseptoria | Cereals |
| | | till 1:100 | | tritici | |
| folpet or captan | picarbutrazox | from 100:1 | Septoria | Zymoseptoria | Cereals |
| | | till 1:100 | | tritici | |
| folpet or captan | picarbutrazox | from 100:1 | Septoria | Zymoseptoria | Cereals |
| | | till 1:100 | | tritici | |
| folpet or captan | prothioconazole | from 100:1 | Septoria | Zymoseptoria | Cereals |
| | | till 1:100 | | tritici | |
| folpet or captan | prothioconazole | from 100:1 | Septoria | Zymoseptoria | Cereals |
| | | till 1:100 | | tritici | |
| folpet or captan | pydiflumetofen | from 100:1 | Septoria | Zymoseptoria | Cereals |
| | | till 1:100 | | tritici | |
| folpet or captan | pydiflumetofen | from 100:1 | Septoria | Zymoseptoria | Cereals |
| | | till 1:100 | | tritici | |
| folpet or captan | Sulphur | from 100:1 | Septoria | Zymoseptoria | Cereals |
| | | till 1:100 | | tritici | |
| folpet or captan | Fluazinam | from 100:1 | Septoria | Zymoseptoria | Cereals |
| | | till 1:100 | | tritici | |
| folpet or captan | ADF-16 | from 100:1 | Sheath Blight | Rhizoctonia solani/ | Rice |
| | | till 1:100 | | Thanatephorus | |
| | | | | cucumeris | |
| folpet or captan | ADF-16 | from 100:1 | Sheath Blight | Rhizoctonia solani/ | Rice |
| | | till 1:100 | | Thanatephorus | |
| | | | | cucumeris | |
| folpet or captan | fenpicoxamid | from 100:1 | Sheath Blight | Rhizoctonia solani/ | Rice |
| | | till 1:100 | | Thanatephorus | |
| | | | | cucumeris | |
| folpet or captan | fenpicoxamid | from 100:1 | Sheath Blight | Rhizoctonia solani/ | Rice |
| | | till 1:100 | | Thanatephorus | |
| | | | | cucumeris | |
| folpet or captan | fenpropidin | from 100:1 | Sheath Blight | Rhizoctonia solani/ | Rice |
| | | till 1:100 | | Thanatephorus | |
| | | | | cucumeris | |
| folpet or captan | fenpropidin | from 100:1 | Sheath Blight | Rhizoctonia solani/ | Rice |
| | | till 1:100 | | Thanatephorus | |
| | | | | cucumeris | |
| folpet or captan | fluopyram | from 100:1 | Sheath Blight | Rhizoctonia solani/ | Rice |
| | | till 1:100 | | Thanatephorus | |
| | | | | cucumeris | |
| folpet or captan | fluopyram | from 100:1 | Sheath Blight | Rhizoctonia solani/ | Rice |
| | | till 1:100 | | Thanatephorus | |
| | | | | cucumeris | |
| folpet or captan | fluoxapiprolin | from 100:1 | Sheath Blight | Rhizoctonia solani/ | Rice |
| | | till 1:100 | | Thanatephorus | |
| | | | | cucumeris | |
| folpet or captan | fluoxapiprolin | from 100:1 | Sheath Blight | Rhizoctonia solani/ | Rice |
| | | till 1:100 | | Thanatephorus | |
| | | | | cucumeris | |
| folpet or captan | fluxapyroxad | from 100:1 | Sheath Blight | Rhizoctonia solani/ | Rice |
| | | till 1:100 | | Thanatephorus | |
| | | | | cucumeris | |
| folpet or captan | fluxapyroxad | from 100:1 | Sheath Blight | Rhizoctonia solani/ | Rice |
| | | till 1:100 | | Thanatephorus | |
| | | | | cucumeris | |
| folpet or captan | Mandestrobin | from 100:1 | Sheath Blight | Rhizoctonia solani/ | Rice |
| | | till 1:100 | | Thanatephorus | |
| | | | | cucumeris | |
| folpet or captan | Mandestrobin | from 100:1 | Sheath Blight | Rhizoctonia solani/ | Rice |
| | | till 1:100 | | Thanatephorus | |
| | | | | cucumeris | |
| folpet or captan | mefentrifluconazole | from 100:1 | Sheath Blight | Rhizoctonia solani/ | Rice |
| | | till 1:100 | | Thanatephorus | |
| | | | | cucumeris | |
| folpet or captan | mefentrifluconazole | from 100:1 | Sheath Blight | Rhizoctonia solani/ | Rice |
| | | till 1:100 | | Thanatephorus | |
| | | | | cucumeris | |
| folpet or captan | metyltetraprole | from 100:1 | Sheath Blight | Rhizoctonia solani/ | Rice |
| | | till 1:100 | | Thanatephorus | |
| | | | | cucumeris | |
| folpet or captan | metyltetraprole | from 100:1 | Sheath Blight | Rhizoctonia solani/ | Rice |
| | | till 1:100 | | Thanatephorus | |
| | | | | cucumeris | |
| folpet or captan | picarbutrazox | from 100:1 | Sheath Blight | Rhizoctonia solani/ | Rice |
| | | till 1:100 | | Thanatephorus | |
| | | | | cucumeris | |
| folpet or captan | picarbutrazox | from 100:1 | Sheath Blight | Rhizoctonia solani/ | Rice |
| | | till 1:100 | | Thanatephorus | |
| | | | | cucumeris | |
| folpet or captan | prothioconazole | from 100:1 | Sheath Blight | Rhizoctonia solani/ | Rice |
| | | till 1:100 | | Thanatephorus | |
| | | | | cucumeris | |
| folpet or captan | prothioconazole | from 100:1 | Sheath Blight | Rhizoctonia solani/ | Rice |
| | | till 1:100 | | Thanatephorus | |
| | | | | cucumeris | |
| folpet or captan | pydiflumetofen | from 100:1 | Sheath Blight | Rhizoctonia solani/ | Rice |
| | | till 1:100 | | Thanatephorus | |
| | | | | cucumeris | |
| folpet or captan | pydiflumetofen | from 100:1 | Sheath Blight | Rhizoctonia solani/ | Rice |
| | | till 1:100 | | Thanatephorus | |
| | | | | cucumeris | |
| folpet or captan | Sulphur | from 100:1 | Sheath Blight | Rhizoctonia solani/ | Rice |
| | | till 1:100 | | Thanatephorus | |
| | | | | cucumeris | |
| folpet or captan | Fluazinam | from 100:1 | Sheath Blight | Rhizoctonia solani/ | Rice |
| | | till 1:100 | | Thanatephorus | |
| | | | | cucumeris | |
| folpet or captan | ADF-16 | from 100:1 | Southern corn | Cochliobolus | Corn |
| | | till 1:100 | leaf blight | heterostrophus | |
| folpet or captan | ADF-16 | from 100:1 | Southern corn | Cochliobolus | Corn |
| | | till 1:100 | leaf blight | heterostrophus | |
| folpet or captan | fenpicoxamid | from 100:1 | Southern corn | Cochliobolus | Corn |
| | | till 1:100 | leaf blight | heterostrophus | |
| folpet or captan | fenpicoxamid | from 100:1 | Southern corn | Cochliobolus | Corn |
| | | till 1:100 | leaf blight | heterostrophus | |
| folpet or captan | fenpropidin | from 100:1 | Southern corn | Cochliobolus | Corn |
| | | till 1:100 | leaf blight | heterostrophus | |
| folpet or captan | fenpropidin | from 100:1 | Southern corn | Cochliobolus | Corn |
| | | till 1:100 | leaf blight | heterostrophus | |
| folpet or captan | fluopyram | from 100:1 | Southern corn | Cochliobolus | Corn |
| | | till 1:100 | leaf blight | heterostrophus | |
| folpet or captan | fluopyram | from 100:1 | Southern corn | Cochliobolus | Corn |
| | | till 1:100 | leaf blight | heterostrophus | |
| folpet or captan | fluoxapiprolin | from 100:1 | Southern corn | Cochliobolus | Corn |
| | | till 1:100 | leaf blight | heterostrophus | |
| folpet or captan | fluoxapiprolin | from 100:1 | Southern corn | Cochliobolus | Corn |
| | | till 1:100 | leaf blight | heterostrophus | |
| folpet or captan | fluxapyroxad | from 100:1 | Southern corn | Cochliobolus | Corn |
| | | till 1:100 | leaf blight | heterostrophus | |
| folpet or captan | fluxapyroxad | from 100:1 | Southern corn | Cochliobolus | Corn |
| | | till 1:100 | leaf blight | heterostrophus | |
| folpet or captan | Mandestrobin | from 100:1 | Southern corn | Cochliobolus | Corn |
| | | till 1:100 | leaf blight | heterostrophus | |
| folpet or captan | Mandestrobin | from 100:1 | Southern corn | Cochliobolus | Corn |
| | | till 1:100 | leaf blight | heterostrophus | |
| folpet or captan | mefentrifluconazole | from 100:1 | Southern corn | Cochliobolus | Corn |
| | | till 1:100 | leaf blight | heterostrophus | |
| folpet or captan | mefentrifluconazole | from 100:1 | Southern corn | Cochliobolus | Corn |
| | | till 1:100 | leaf blight | heterostrophus | |
| folpet or captan | metyltetraprole | from 100:1 | Southern corn | Cochliobolus | Corn |
| | | till 1:100 | leaf blight | heterostrophus | |
| folpet or captan | metyltetraprole | from 100:1 | Southern corn | Cochliobolus | Corn |
| | | till 1:100 | leaf blight | heterostrophus | |
| folpet or captan | picarbutrazox | from 100:1 | Southern corn | Cochliobolus | Corn |
| | | till 1:100 | leaf blight | heterostrophus | |
| folpet or captan | picarbutrazox | from 100:1 | Southern corn | Cochliobolus | Corn |
| | | till 1:100 | leaf blight | heterostrophus | |
| folpet or captan | prothioconazole | from 100:1 | Southern corn | Cochliobolus | Corn |
| | | till 1:100 | leaf blight | heterostrophus | |
| folpet or captan | prothioconazole | from 100:1 | Southern corn | Cochliobolus | Corn |
| | | till 1:100 | leaf blight | heterostrophus | |
| folpet or captan | pydiflumetofen | from 100:1 | Southern corn | Cochliobolus | Corn |
| | | till 1:100 | leaf blight | heterostrophus | |
| folpet or captan | pydiflumetofen | from 100:1 | Southern corn | Cochliobolus | Corn |
| | | till 1:100 | leaf blight | heterostrophus | |
| folpet or captan | Sulphur | from 100:1 | Southern corn | Cochliobolus | Corn |
| | | till 1:100 | leaf blight | heterostrophus | |
| folpet or captan | Fluazinam | from 100:1 | Southern corn | Cochliobolus | Corn |
| | | till 1:100 | leaf blight | heterostrophus | |
| folpet or captan | ADF-16 | from 100:1 | Target spot | Corynespora | Soybean |
| | | till 1:100 | | cassiicola | |
| folpet or captan | ADF-16 | from 100:1 | Target spot | Corynespora | Soybean |
| | | till 1:100 | | cassiicola | |
| folpet or captan | fenpicoxamid | from 100:1 | Target spot | Corynespora | Soybean |
| | | till 1:100 | | cassiicola | |
| folpet or captan | fenpicoxamid | from 100:1 | Target spot | Corynespora | Soybean |
| | | till 1:100 | | cassiicola | |
| folpet or captan | fenpropidin | from 100:1 | Target spot | Corynespora | Soybean |
| | | till 1:100 | | cassiicola | |
| folpet or captan | fenpropidin | from 100:1 | Target spot | Corynespora | Soybean |
| | | till 1:100 | | cassiicola | |
| folpet or captan | fluopyram | from 100:1 | Target spot | Corynespora | Soybean |
| | | till 1:100 | | cassiicola | |
| folpet or captan | fluopyram | from 100:1 | Target spot | Corynespora | Soybean |
| | | till 1:100 | | cassiicola | |
| folpet or captan | fluoxapiprolin | from 100:1 | Target spot | Corynespora | Soybean |
| | | till 1:100 | | cassiicola | |
| folpet or captan | fluoxapiprolin | from 100:1 | Target spot | Corynespora | Soybean |
| | | till 1:100 | | cassiicola | |
| folpet or captan | fluxapyroxad | from 100:1 | Target spot | Corynespora | Soybean |
| | | till 1:100 | | cassiicola | |
| folpet or captan | fluxapyroxad | from 100:1 | Target spot | Corynespora | Soybean |
| | | till 1:100 | | cassiicola | |
| folpet or captan | Mandestrobin | from 100:1 | Target spot | Corynespora | Soybean |
| | | till 1:100 | | cassiicola | |
| folpet or captan | Mandestrobin | from 100:1 | Target spot | Corynespora | Soybean |
| | | till 1:100 | | cassiicola | |
| folpet or captan | mefentrifluconazole | from 100:1 | Target spot | Corynespora | Soybean |
| | | till 1:100 | | cassiicola | |
| folpet or captan | mefentrifluconazole | from 100:1 | Target spot | Corynespora | Soybean |
| | | till 1:100 | | cassiicola | |
| folpet or captan | metyltetraprole | from 100:1 | Target spot | Corynespora | Soybean |
| | | till 1:100 | | cassiicola | |
| folpet or captan | metyltetraprole | from 100:1 | Target spot | Corynespora | Soybean |
| | | till 1:100 | | cassiicola | |
| folpet or captan | picarbutrazox | from 100:1 | Target spot | Corynespora | Soybean |
| | | till 1:100 | | cassiicola | |
| folpet or captan | picarbutrazox | from 100:1 | Target spot | Corynespora | Soybean |
| | | till 1:100 | | cassiicola | |
| folpet or captan | prothioconazole | from 100:1 | Target spot | Corynespora | Soybean |
| | | till 1:100 | | cassiicola | |
| folpet or captan | prothioconazole | from 100:1 | Target spot | Corynespora | Soybean |
| | | till 1:100 | | cassiicola | |
| folpet or captan | pydiflumetofen | from 100:1 | Target spot | Corynespora | Soybean |
| | | till 1:100 | | cassiicola | |
| folpet or captan | Sulphur | from 100:1 | Target spot | Corynespora | Soybean |
| | | till 1:100 | | cassiicola | |
| folpet or captan | Fluazinam | from 100:1 | Target spot | Corynespora | Soybean |
| | | till 1:100 | | cassiicola | |
| folpet or captan | ADF-16 | from 100:1 | Yellow rust | Puccinia | Cereals |
| | | till 1:100 | | striiformis | |
| folpet or captan | ADF-16 | from 100:1 | Yellow rust | Puccinia | Cereals |
| | | till 1:100 | | striiformis | |
| folpet or captan | fenpicoxamid | from 100:1 | Yellow rust | Puccinia | Cereals |
| | | till 1:100 | | striiformis | |
| folpet or captan | fenpicoxamid | from 100:1 | Yellow rust | Puccinia | Cereals |
| | | till 1:100 | | striiformis | |
| folpet or captan | fenpropidin | from 100:1 | Yellow rust | Puccinia | Cereals |
| | | till 1:100 | | striiformis | |
| folpet or captan | fenpropidin | from 100:1 | Yellow rust | Puccinia | Cereals |
| | | till 1:100 | | striiformis | |
| folpet or captan | fluopyram | from 100:1 | Yellow rust | Puccinia | Cereals |
| | | till 1:100 | | striiformis | |
| folpet or captan | fluopyram | from 100:1 | Yellow rust | Puccinia | Cereals |
| | | till 1:100 | | striiformis | |
| folpet or captan | fluoxapiprolin | from 100:1 | Yellow rust | Puccinia | Cereals |
| | | till 1:100 | | striiformis | |
| folpet or captan | fluoxapiprolin | from 100:1 | Yellow rust | Puccinia | Cereals |
| | | till 1:100 | | striiformis | |
| folpet or captan | fluxapyroxad | from 100:1 | Yellow rust | Puccinia | Cereals |
| | | till 1:100 | | striiformis | |
| folpet or captan | fluxapyroxad | from 100:1 | Yellow rust | Puccinia | Cereals |
| | | till 1:100 | | striiformis | |
| folpet or captan | Mandestrobin | from 100:1 | Yellow rust | Puccinia | Cereals |
| | | till 1:100 | | striiformis | |
| folpet or captan | Mandestrobin | from 100:1 | Yellow rust | Puccinia | Cereals |
| | | till 1:100 | | striiformis | |
| folpet or captan | mefentrifluconazole | from 100:1 | Yellow rust | Puccinia | Cereals |
| | | till 1:100 | | striiformis | |
| folpet or captan | mefentrifluconazole | from 100:1 | Yellow rust | Puccinia | Cereals |
| | | till 1:100 | | striiformis | |
| folpet or captan | metyltetraprole | from 100:1 | Yellow rust | Puccinia | Cereals |
| | | till 1:100 | | striiformis | |
| folpet or captan | metyltetraprole | from 100:1 | Yellow rust | Puccinia | Cereals |
| | | till 1:100 | | striiformis | |
| folpet or captan | picarbutrazox | from 100:1 | Yellow rust | Puccinia | Cereals |
| | | till 1:100 | | striiformis | |
| folpet or captan | picarbutrazox | from 100:1 | Yellow rust | Puccinia | Cereals |
| | | till 1:100 | | striiformis | |
| folpet or captan | prothioconazole | from 100:1 | Yellow rust | Puccinia | Cereals |
| | | till 1:100 | | striiformis | |
| folpet or captan | prothioconazole | from 100:1 | Yellow rust | Puccinia | Cereals |
| | | till 1:100 | | striiformis | |
| folpet or captan | pydiflumetofen | from 100:1 | Yellow rust | Puccinia | Cereals |
| | | till 1:100 | | striiformis | |
| folpet or captan | pydiflumetofen | from 100:1 | Yellow rust | Puccinia | Cereals |
| | | till 1:100 | | striiformis | |
| folpet or captan | Sulphur | from 100:1 | Yellow rust | Puccinia | Cereals |
| | | till 1:100 | | striiformis | |
| folpet or captan | Fluazinam | from 100:1 | Yellow rust | Puccinia | Cereals |
| | | till 1:100 | | striiformis | |
| folpet or captan | ADF-16 | from 100:1 | Yellow | Pseudocercospora | Banana |
| | | till 1:100 | sigatoka | musae | |
| folpet or captan | ADF-16 | from 100:1 | Yellow | Pseudocercospora | Banana |
| | | till 1:100 | sigatoka | musae | |
| folpet or captan | fenpicoxamid | from 100:1 | Yellow | Pseudocercospora | Banana |
| | | till 1:100 | sigatoka | musae | |
| folpet or captan | fenpicoxamid | from 100:1 | Yellow | Pseudocercospora | Banana |
| | | till 1:100 | sigatoka | musae | |
| folpet or captan | fenpropidin | from 100:1 | Yellow | Pseudocercospora | Banana |
| | | till 1:100 | sigatoka | musae | |
| folpet or captan | fenpropidin | from 100:1 | Yellow | Pseudocercospora | Banana |
| | | till 1:100 | sigatoka | musae | |
| folpet or captan | fluopyram | from 100:1 | Yellow | Pseudocercospora | Banana |
| | | till 1:100 | sigatoka | musae | |
| folpet or captan | fluopyram | from 100:1 | Yellow | Pseudocercospora | Banana |
| | | till 1:100 | sigatoka | musae | |
| folpet or captan | fluoxapiprolin | from 100:1 | Yellow | Pseudocercospora | Banana |
| | | till 1:100 | sigatoka | musae | |
| folpet or captan | fluoxapiprolin | from 100:1 | Yellow | Pseudocercospora | Banana |
| | | till 1:100 | sigatoka | musae | |
| folpet or captan | fluxapyroxad | from 100:1 | Yellow | Pseudocercospora | Banana |
| | | till 1:100 | sigatoka | musae | |
| folpet or captan | fluxapyroxad | from 100:1 | Yellow | Pseudocercospora | Banana |
| | | till 1:100 | sigatoka | musae | |
| folpet or captan | Mandestrobin | from 100:1 | Yellow | Pseudocercospora | Banana |
| | | till 1:100 | sigatoka | musae | |
| folpet or captan | Mandestrobin | from 100:1 | Yellow | Pseudocercospora | Banana |
| | | till 1:100 | sigatoka | musae | |
| folpet or captan | mefentrifluconazole | from 100:1 | Yellow | Pseudocercospora | Banana |
| | | till 1:100 | sigatoka | musae | |
| folpet or captan | mefentrifluconazole | from 100:1 | Yellow | Pseudocercospora | Banana |
| | | till 1:100 | sigatoka | musae | |
| folpet or captan | metyltetraprole | from 100:1 | Yellow | Pseudocercospora | Banana |
| | | till 1:100 | sigatoka | musae | |
| folpet or captan | metyltetraprole | from 100:1 | Yellow | Pseudocercospora | Banana |
| | | till 1:100 | sigatoka | musae | |
| folpet or captan | picarbutrazox | from 100:1 | Yellow | Pseudocercospora | Banana |
| | | till 1:100 | sigatoka | musae | |
| folpet or captan | picarbutrazox | from 100:1 | Yellow | Pseudocercospora | Banana |
| | | till 1:100 | sigatoka | musae | |
| folpet or captan | pydiflumetofen | from 100:1 | Yellow | Pseudocercospora | Banana |
| | | till 1:100 | sigatoka | musae | |
| folpet or captan | pydiflumetofen | from 100:1 | Yellow | Pseudocercospora | Banana |
| | | till 1:100 | sigatoka | musae | |
| folpet or captan | Sulphur | from 100:1 | Yellow | Pseudocercospora | Banana |
| | | till 1:100 | sigatoka | musae | |
| folpet or captan | prothioconazole | from 100:1 | Yellow | Pseudocercospora | Banana |
| | | till 1:100 | sigatoka | musae | |
| folpet or captan | Fluazinam | from 100:1 | Yellow | Pseudocercospora | Banana |
| | | till 1:100 | sigatoka | musae | |
| folpet or captan | ADF-16 | from 100:1 | Anthracnose | Colletotrichum | Chilli |
| | | till 1:100 | | truncatum | |
| folpet or captan | ADF-16 | from 100:1 | Anthracnose | Colletotrichum | Chilli |
| | | till 1:100 | | truncatum | |
| folpet or captan | fenpicoxamid | from 100:1 | Anthracnose | Colletotrichum | Chilli |
| | | till 1:100 | | truncatum | |
| folpet or captan | fenpicoxamid | from 100:1 | Anthracnose | Colletotrichum | Chilli |
| | | till 1:100 | | truncatum | |
| folpet or captan | fenpropidin | from 100:1 | Anthracnose | Colletotrichum | Chilli |
| | | till 1:100 | | truncatum | |
| folpet or captan | fenpropidin | from 100:1 | Anthracnose | Colletotrichum | Chilli |
| | | till 1:100 | | truncatum | |
| folpet or captan | fluopyram | from 100:1 | Anthracnose | Colletotrichum | Chilli |
| | | till 1:100 | | truncatum | |
| folpet or captan | fluopyram | from 100:1 | Anthracnose | Colletotrichum | Chilli |
| | | till 1:100 | | truncatum | |
| folpet or captan | fluoxapiprolin | from 100:1 | Anthracnose | Colletotrichum | Chilli |
| | | till 1:100 | | truncatum | |
| folpet or captan | fluoxapiprolin | from 100:1 | Anthracnose | Colletotrichum | Chilli |
| | | till 1:100 | | truncatum | |
| folpet or captan | fluxapyroxad | from 100:1 | Anthracnose | Colletotrichum | Chilli |
| | | till 1:100 | | truncatum | |
| folpet or captan | fluxapyroxad | from 100:1 | Anthracnose | Colletotrichum | Chilli |
| | | till 1:100 | | truncatum | |
| folpet or captan | Mandestrobin | from 100:1 | Anthracnose | Colletotrichum | Chilli |
| | | till 1:100 | | truncatum | |
| folpet or captan | Mandestrobin | from 100:1 | Anthracnose | Colletotrichum | Chilli |
| | | till 1:100 | | truncatum | |
| folpet or captan | mefentrifluconazole | from 100:1 | Anthracnose | Colletotrichum | Chilli |
| | | till 1:100 | | truncatum | |
| folpet or captan | mefentrifluconazole | from 100:1 | Anthracnose | Colletotrichum | Chilli |
| | | till 1:100 | | truncatum | |
| folpet or captan | metyltetraprole | from 100:1 | Anthracnose | Colletotrichum | Chilli |
| | | till 1:100 | | truncatum | |
| folpet or captan | metyltetraprole | from 100:1 | Anthracnose | Colletotrichum | Chilli |
| | | till 1:100 | | truncatum | |
| folpet or captan | picarbutrazox | from 100:1 | Anthracnose | Colletotrichum | Chilli |
| | | till 1:100 | | truncatum | |
| folpet or captan | picarbutrazox | from 100:1 | Anthracnose | Colletotrichum | Chilli |
| | | till 1:100 | | truncatum | |
| folpet or captan | pydiflumetofen | from 100:1 | Anthracnose | Colletotrichum | Chilli |
| | | till 1:100 | | truncatum | |
| folpet or captan | pydiflumetofen | from 100:1 | Anthracnose | Colletotrichum | Chilli |
| | | till 1:100 | | truncatum | |
| folpet or captan | Sulphur | from 100:1 | Anthracnose | Colletotrichum | Chilli |
| | | till 1:100 | | truncatum | |
| folpet or captan | Fluazinam | from 100:1 | Anthracnose | Colletotrichum | Chilli |
| | | till 1:100 | | truncatum | |
| folpet or captan | prothioconazole | from 100:1 | Anthracnose | Colletotrichum | Chilli |
| | | till 1:100 | | truncatum | |

Each row of Table D indicates a combination of folpet or captan with a primary fungicide. It can be applied at the ratio as a preventive or curative treatment to a crop which has a target disease that caused by the fungal pathogen in each row of Table D.

In some embodiments, Table D disclosed preventing or treating pulses against anathracnose caused by Colletotrichum sp., which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating chili against anathracnose caused by Colletotrichum truncatum, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating soybean against Asian soybean rust caused by Phakopsora pachyrhizi, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating banana against Black sigatoka caused by Mycosphaerella fijiensis, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating cereals against Brown rust caused by Mycosphaerella fijiensis, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating coffee against Coffee Berry Disease caused by Colletotrichum kahawae, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating coffee against Coffee Leaf Rust caused by Hemileia vastatrix, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating pulses against Didymella pisi caused by Ascochyta rabiei, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating cucurbits against Downy mildew caused by Pseudoperonospora cubensis, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating grape against Downy mildew caused by Plasmopara viticola, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating potato or tomato against Early blight caused by Plasmopara viticola, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating cereals against Fusarium head blight caused by Fusarium sp., which comprises administering folpet and at least one of primary fungicide selected from the group consisting of pyrimidinone fungicide, QiI, QoI, SDHI, DMI OSBPI, amine fungicide, tetrazolyloxime fungicide, phenylpyridinamine fungicide, or inorganic fungicide at a ratio between 100:1 till 1:100.

In some embodiments, Table D disclosed preventing or treating corn against Gray Leaf Spot caused by Cercospora zeae-maydis, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating potato or tomato against Late blight caused by Phytophthora infestans, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating sugar beet against leaf spot of beet caused by Cercospora beticola, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating corn against Northern Corn Leaf Blight caused by Setosphaeria turcica, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating corn against Northern Corn Leaf Blight caused by Cochliobolus carbonum, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating cereals against Ramularia leaf spot caused by Ramularia collo-cygni, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating cotton against Ramularia leaf spot caused by Ramularia areola, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating sugar beet against Ramularia leaf spot caused by Ramularia beticola, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating rice against Rice Blast caused by Pyricularia oryzae, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating sugar beet against Ramularia leaf spot caused by Ramularia beticola, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating rice against Rice Blast caused by Pyricularia oryzae, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating sugar beet against Rust caused by Uromyces betae, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating pome fruit against scab caused by Venturia inaequalis, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating sugar beet against OSR caused by Venturia inaequalis, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating cereals against Septoria caused by Zymoseptoria tritici, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating rice against Sheath Blight caused by Rhizoctonia solani or Thanatephorus cucumeris, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating corn against Southern corn leaf blight caused by Cochliobolus heterostrophus, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating soybean against Target spot caused by Corynespora cassiicola, which comprises administering folpet and at least one of primary fungicide selected from the group consisting of pyrimidinone fungicide, QiI, QoI, SDHI, DMI OSBPI, amine fungicide, tetrazolyloxime fungicide, phenylpyridinamine fungicide, or inorganic fungicide at a ratio between 100:1 till 1:100.

In some embodiments, Table D disclosed preventing or treating cereals against Yellow rust caused by Puccinia striiformis, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating banana against Yellow sigatoka caused by Pseudocercospora musae, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating pulses against anathracnose caused by Colletotrichum sp., which comprises administering captan and at least one of primary fungicide selected from the group consisting of pyrimidinone fungicide, QiI, QoI, SDHI, DMI OSBPI, amine fungicide, tetrazolyloxime fungicide, phenylpyridinamine fungicide, or inorganic fungicide at a ratio between 100:1 till 1:100.

In some embodiments, Table D disclosed preventing or treating chili against anathracnose caused by Colletotrichum truncatum, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating soybean against Asian soybean rust caused by Phakopsora pachyrhizi, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating banana against Black sigatoka caused by Mycosphaerella fijiensis, which comprises administering captan and at least one of primary fungicide selected from the group consisting of pyrimidinone fungicide, QiI, QoI, SDHI, DMI OSBPI, amine fungicide, tetrazolyloxime fungicide, phenylpyridinamine fungicide, or inorganic fungicide at a ratio between 100:1 till 1:100.

In some embodiments, Table D disclosed preventing or treating cereals against Brown rust caused by Mycosphaerella fijiensis, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating coffee against Coffee Berry Disease caused by Colletotrichum kahawae, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating coffee against Coffee Leaf Rust caused by Hemileia vastatrix, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating pulses against Didymella pisi caused by Ascochyta rabiei, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating cucurbits against Downy mildew caused by Pseudoperonospora cubensis, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating grape against Downy mildew caused by Plasmopara viticola, which comprises administering captan and at least one of primary fungicide selected from the group consisting of pyrimidinone fungicide, QiI, QoI, SDHI, DMI OSBPI, amine fungicide, tetrazolyloxime fungicide, phenylpyridinamine fungicide, or inorganic fungicide at a ratio between 100:1 till 1:100.

In some embodiments, Table D disclosed preventing or treating potato or tomato against Early blight caused by Plasmopara viticola, which comprises administering captan and at least one of primary fungicide selected from the group consisting of pyrimidinone fungicide, QiI, QoI, SDHI, DMI fungicide, OSBPI, amine fungicide, tetrazolyloxime e fungicide, phenylpyridinamine fungicide, or inorganic fungicide at a ratio between 100:1 till 1:100.

In some embodiments, Table D disclosed preventing or treating cereals against Fusarium head blight caused by Fusarium sp., which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating corn against Gray Leaf Spot caused by Cercospora zeae-maydis, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating potato or tomato against Late blight caused by Phytophthora infestans, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating sugar beet against leaf spot of beet caused by Cercospora beticola, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating corn against Northern Corn Leaf Blight caused by Setosphaeria turcica, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating corn against Northern Corn Leaf Blight caused by Cochliobolus carbonum, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating cereals against Ramularia leaf spot caused by Ramularia collo-cygni, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating cotton against Ramularia leaf spot caused by Ramularia areola, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating sugar beet against Ramularia leaf spot caused by Ramularia beticola, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating rice against Rice Blast caused by Pyricularia oryzae, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating sugar beet against Ramularia leaf spot caused by Ramularia beticola, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating rice against Rice Blast caused by Pyricularia oryzae, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating sugar beet against Rust caused by Uromyces betae, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating pome fruit against scab caused by Venturia inaequalis, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating sugar beet against OSR caused by Venturia inaequalis, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, Table D disclosed preventing or treating cereals against Septoria caused by Zymoseptoria tritici, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 till 1:100.

In some embodiments, the combination comprises application to a target disease infected with the fungal pathogen on a crop with a phthalimide and a primary fungicide at a ratio, wherein the target disease, the fungal pathogen, the crop, the phthalimide, the primary fungicide, and the ratio are indicated in each row of Table D.

In some embodiments, the combination comprises application to a target disease infected with the fungal pathogen on a crop with folpet and a primary fungicide at a ratio, wherein the target disease, the fungal pathogen, the crop, the primary fungicide, and the ratio are indicated in each row of Table D.

In some embodiments, the combination comprises application to a target disease infected with the fungal pathogen on a crop with captan and a primary fungicide at a ratio, wherein the target disease, the fungal pathogen, the crop, the primary fungicide, and the ratio are indicated in each row of Table D.

In some embodiments, the present application disclosed administering folpet with a pyrimidinone fungicide at a ratio between 100:1 till 1:100 preventing or treating a disease on a crop.

In some embodiments, the present application disclosed administering folpet with a QiI at a ratio between 100:1 till 1:100 preventing or treating a disease on a crop

In some embodiments, the present application disclosed administering folpet with a pyrimidinone fungicide at a ratio between 100:1 till 1:100 preventing or treating a disease on a crop.

In some embodiments, the present application disclosed administering folpet with a QoI at a ratio between 100:1 till 1:100 preventing or treating a disease on a crop

In some embodiments, the present application disclosed administering folpet with a DMI at a ratio between 100:1 till 1:100 preventing or treating a disease on a crop.

In some embodiments, the present application disclosed administering folpet with an OSBPI at a ratio between 100:1 till 1:100 preventing or treating a disease on a crop

In some embodiments, the present application disclosed administering folpet with an amine fungicide at a ratio between 100:1 till 1:100 preventing or treating a disease on a crop.

In some embodiments, the present application disclosed administering folpet with a tetrazolyloxime fungicide at a ratio between 100:1 till 1:100 preventing or treating a disease on a crop

In some embodiments, the present application disclosed administering folpet with a piperidinyl thiazole isoxazoline fungicide at a ratio between 100:1 till 1:100 preventing or treating a disease on a crop.

In some embodiments, the present application disclosed administering folpet with a fungicide at a ratio between 100:1 till 1:100 preventing or treating a disease on a crop

In some embodiments, the present application disclosed administering folpet with an inorganic fungicide at a ratio between 100:1 till 1:100 preventing or treating a disease on a crop.

In some embodiments, the present application disclosed administering folpet with Formula I at a ratio between 100:1 till 1:100 preventing or treating a disease on a crop.

In some embodiments, the present application disclosed administering folpet with fenpicoxamid at a ratio between 100:1 till 1:100 preventing or treating a disease on a crop

In some embodiments, the present application disclosed administering folpet with fluazinam at a ratio between 100:1 till 1:100 preventing or treating a disease on a crop.

In some embodiments, the present application disclosed administering folpet with fluopyram at a ratio between 100:1 till 1:100 preventing or treating a disease on a crop

In some embodiments, the present application disclosed administering folpet with fluoxapiprolin at a ratio between 100:1 till 1:100 preventing or treating a disease on a crop.

In some embodiments, the present application disclosed administering folpet with fluxapyroxad at a ratio between 100:1 till 1:100 preventing or treating a disease on a crop

In some embodiments, the present application disclosed administering folpet with mandestrobin at a ratio between 100:1 till 1:100 preventing or treating a disease on a crop.

In some embodiments, the present application disclosed administering folpet with mefentrifluconazole at a ratio between 100:1 till 1:100 preventing or treating a disease on a crop

In some embodiments, the present application disclosed administering folpet with metyltetraprole at a ratio between 100:1 till 1:100 preventing or treating a disease on a crop.

In some embodiments, the present application disclosed administering folpet with pydiflumetofen at a ratio between 100:1 till 1:100 preventing or treating a disease on a crop

In some embodiments, the present application disclosed administering folpet with sulphur at a ratio between 100:1 till 1:100 preventing or treating a disease on a crop.

In some embodiments, the present application disclosed administering folpet with prothioconazole at a ratio between 100:1 till 1:100 preventing or treating a disease on a crop.

In some embodiments, the present application disclosed administering captan with a pyrimidinone fungicide at a ratio between 100:1 till 1:100 preventing or treating a disease on a crop.

In some embodiments, the present application disclosed administering captan with a QiI at a ratio between 100:1 till 1:100 preventing or treating a disease on a crop

In some embodiments, the present application disclosed administering captan with a pyrimidinone fungicide at a ratio between 100:1 till 1:100 preventing or treating a disease on a crop.

In some embodiments, the present application disclosed administering captan with a QoI at a ratio between 100:1 till 1:100 preventing or treating a disease on a crop

In some embodiments, the present application disclosed administering captan with a DMI at a ratio between 100:1 till 1:100 preventing or treating a disease on a crop.

In some embodiments, the present application disclosed administering captan with an OSBPI at a ratio between 100:1 till 1:100 preventing or treating a disease on a crop

In some embodiments, the present application disclosed administering captan with an amine fungicide at a ratio between 100:1 till 1:100 preventing or treating a disease on a crop.

In some embodiments, the present application disclosed administering captan with a tetrazolyloxime fungicide at a ratio between 100:1 till 1:100 preventing or treating a disease on a crop

In some embodiments, the present application disclosed administering captan with a piperidinyl thiazole isoxazoline fungicide at a ratio between 100:1 till 1:100 preventing or treating a disease on a crop.

In some embodiments, the present application disclosed administering captan with a phenylpyridinamine fungicide at a ratio between 100:1 till 1:100 preventing or treating a disease on a crop

In some embodiments, the present application disclosed administering captan with an inorganic fungicide at a ratio between 100:1 till 1:100 preventing or treating a disease on a crop.

In some embodiments, the present application disclosed administering captan with Formula I at a ratio between 100:1 till 1:100 preventing or treating a disease on a crop.

In some embodiments, the present application disclosed administering captan with fenpicoxamid at a ratio between 100:1 till 1:100 preventing or treating a disease on a crop

In some embodiments, the present application disclosed administering captan with fluazinam at a ratio between 100:1 till 1:100 preventing or treating a disease on a crop.

In some embodiments, the present application disclosed administering captan with fluopyram at a ratio between 100:1 till 1:100 preventing or treating a disease on a crop

In some embodiments, the present application disclosed administering captan with fluoxapiprolin at a ratio between 100:1 till 1:100 preventing or treating a crop.

In some embodiments, the present application disclosed administering captan with fluxapyroxad at a ratio between 100:1 till 1:100 preventing or treating a disease on a crop

In some embodiments, the present application disclosed administering captan with mandestrobin at a ratio between 100:1 till 1:100 preventing or treating a disease on a crop.

In some embodiments, the present application disclosed administering captan with mefentrifluconazole at a ratio between 100:1 till 1:100 preventing or treating a disease on a crop

In some embodiments, the present application disclosed administering captan with metyltetraprole at a ratio between 100:1 till 1:100 preventing or treating a disease on a crop.

In some embodiments, the present application disclosed administering captan with pydiflumetofen at a ratio between 100:1 till 1:100 preventing or treating a disease on a crop

In some embodiments, the present application disclosed administering captan with sulphur at a ratio between 100:1 till 1:100 preventing or treating a disease on a crop.

In some embodiments, the present application disclosed administering captan with prothioconazole at a ratio between 100:1 till 1:100 preventing or treating a disease on a crop.

Lengthy table referenced here
US20250089720A1-20250320-T00001
Please refer to the end of the specification for access instructions.

Each row of Table E indicates a combination of folpet or captan with a first primary fungicide and a second primary fungicide. It can be applied at the ratio as a preventive or curative treatment to a crop which has a target disease that caused by the fungal pathogen in each row of Table E.

In some embodiments, Table E disclosed preventing or treating pulses against anathracnose caused by Colletotrichum sp., which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at at a ratio between 1:1:1 to 1:100:1; or to 100:1:1; or to 1:1:100; or to 1:100:100; or to 100:100:1; or to 100:1:100.

In some embodiments, Table E disclosed preventing or treating chili against anathracnose caused by Colletotrichum truncatum, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at at a ratio between 1:1:1 to 1:100:1; or to 100:1:1; or to 1:1:100; or to 1:100:100; or to 100:100:1; or to 100:1:100.

In some embodiments, Table E disclosed preventing or treating soybean against Asian soybean rust caused by Phakopsora pachyrhizi, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating banana against Black sigatoka caused by Mycosphaerella fijiensis, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating cereals against Brown rust caused by Mycosphaerella fijiensis, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating coffee against Coffee Berry Disease caused by Colletotrichum kahawae, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating coffee against Coffee Leaf Rust caused by Hemileia vastatrix, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at at a ratio between 1:1:1 to 1:100:1; or to 100:1:1; or to 1:1:100; or to 1:100:100; or to 100:100:1; or to 100:1:100.

In some embodiments, Table E disclosed preventing or treating pulses against Didymella pisi caused by Ascochyta rabiei, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating cucurbits against Downy mildew caused by Pseudoperonospora cubensis, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating grape against Downy mildew caused by Plasmopara viticola, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating potato or tomato against Early blight caused by Plasmopara viticola, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating cereals against Fusarium head blight caused by Fusarium sp., which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at at a ratio between 1:1:1 to 1:100:1; or to 100:1:1; or to 1:1:100; or to 1:100:100; or to 100:100:1; or to 100:1:100.

In some embodiments, Table E disclosed preventing or treating corn against Gray Leaf Spot caused by Cercospora zeae-maydis, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating potato or tomato against Late blight caused by Phytophthora infestans, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating sugar beet against leaf spot of beet caused by Cercospora beticola, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating corn against Northern Corn Leaf Blight caused by Setosphaeria turcica, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating corn against Northern Corn Leaf Blight caused by Cochliobolus carbonum, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating cereals against Ramularia leaf spot caused by Ramularia collo-cygni, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating cotton against Ramularia leaf spot caused by Ramularia areola, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating sugar beet against Ramularia leaf spot caused by Ramularia beticola, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating rice against Rice Blast caused by Pyricularia oryzae, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating sugar beet against Ramularia leaf spot caused by Ramularia beticola, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at at a ratio between 1:1:1 to 1:100:1; or to 100:1:1; or to 1:1:100; or to 1:100:100; or to 100:100:1; or to 100:1:100.

In some embodiments, Table E disclosed preventing or treating rice against Rice Blast caused by Pyricularia oryzae, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating sugar beet against Rust caused by Uromyces betae, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating pome fruit against scab caused by Venturia inaequalis, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating sugar beet against OSR caused by Venturia inaequalis, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating cereals against Septoria caused by Zymoseptoria tritici, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating rice against Sheath Blight caused by Rhizoctonia solani or Thanatephorus cucumeris, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating corn against Southern corn leaf blight caused by Cochliobolus heterostrophus, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating soybean against Target spot caused by Corynespora cassiicola, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating cereals against Yellow rust caused by Puccinia striiformis, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating banana against Yellow sigatoka caused by Pseudocercospora musae, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at at a ratio between 1:1:1 to 1:100:1; or to 100:1:1; or to 1:1:100; or to 1:100:100; or to 100:100:1; or to 100:1:100.

In some embodiments, Table E disclosed preventing or treating pulses against anathracnose caused by Colletotrichum sp., which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating chili against anathracnose caused by Colletotrichum truncatum, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating soybean against Asian soybean rust caused by Phakopsora pachyrhizi, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating banana against Black sigatoka caused by Mycosphaerella fijiensis, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating cereals against Brown rust caused by Mycosphaerella fijiensis, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at at a ratio between 1:1:1 to 1:100:1; or to 100:1:1; or to 1:1:100; or to 1:100:100; or to 100:100:1; or to 100:1:100.

In some embodiments, Table E disclosed preventing or treating coffee against Coffee Berry Disease caused by Colletotrichum kahawae, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating coffee against Coffee Leaf Rust caused by Hemileia vastatrix, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating pulses against Didymella pisi caused by Ascochyta rabiei, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating cucurbits against Downy mildew caused by Pseudoperonospora cubensis, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating grape against Downy mildew caused by Plasmopara viticola, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at at a ratio between 1:1:1 to 1:100:1; or to 100:1:1; or to 1:1:100; or to 1:100:100; or to 100:100:1; or to 100:1:100.

In some embodiments, Table E disclosed preventing or treating potato or tomato against Early blight caused by Plasmopara viticola, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating cereals against Fusarium head blight caused by Fusarium sp., which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating corn against Gray Leaf Spot caused by Cercospora zeae-maydis, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating potato or tomato against Late blight caused by Phytophthora infestans, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating sugar beet against leaf spot of beet caused by Cercospora beticola, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at at a ratio between 1:1:1 to 1:100:1; or to 100:1:1; or to 1:1:100; or to 1:100:100; or to 100:100:1; or to 100:1:100.

In some embodiments, Table E disclosed preventing or treating corn against Northern Corn Leaf Blight caused by Setosphaeria turcica, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating corn against Northern Corn Leaf Blight caused by Cochliobolus carbonum, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating cereals against Ramularia leaf spot caused by Ramularia collo-cygni, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating cotton against Ramularia leaf spot caused by Ramularia areola, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating sugar beet against Ramularia leaf spot caused by Ramularia beticola, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at at a ratio between 1:1:1 to 1:100:1; or to 100:1:1; or to 1:1:100; or to 1:100:100; or to 100:100:1; or to 100:1:100.

In some embodiments, Table E disclosed preventing or treating rice against Rice Blast caused by Pyricularia oryzae, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating sugar beet against Ramularia leaf spot caused by Ramularia beticola, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating rice against Rice Blast caused by Pyricularia oryzae, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating sugar beet against Rust caused by Uromyces betae, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating pome fruit against scab caused by Venturia inaequalis, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating sugar beet against OSR caused by Venturia inaequalis, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, Table E disclosed preventing or treating cereals against Septoria caused by Zymoseptoria tritici, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and a pyrimidinone fungicide at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and a QiI at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and a QoI at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and a SDHI at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and a DMI at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and an OSBPI at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and an amine fungicide at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and a tetrazolyloxime fungicide at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and a phenylpyridinamine fungicide at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and an inorganic fungicide at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and a piperidinyl thiazole isoxazoline fungicide at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and Formula I at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and fenpicoxamid at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and fluazinam at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and fluopyram at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and fluoxapiprolin at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and fluxapyroxad at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and mandestrobin at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and mefentrifluconazole at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and metyltetraprole at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and pydiflumetofen at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and sulphur at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering folpet with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and prothioconazole at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering captan with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and a pyrimidinone fungicide at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering captan with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and a QiI at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering captan with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and a QoI at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering captan with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and a DMI at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering captan with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and an OSBPI at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering captan with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and an amine fungicide at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering captan with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and a tetrazolyloxime fungicide at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering captan with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and a piperidinyl thiazole isoxazoline fungicide at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering captan with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and an inorganic fungicide and at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering captan with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and Formula I at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering captan with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and fenpicoxamid at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering captan with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and fluazinam at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering captan with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and fluopyram at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering captan with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and fluoxapiprolin at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering captan with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and fluxapyroxad at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering captan with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and mandestrobin at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering captan with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and mefentrifluconazole at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering captan with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and metyltetraprole at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering captan with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and pydiflumetofen at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering captan with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and sulphur at a ratio between 1:1:1 to 1:100:1; or to 100:1:1; or to 1:1:100; or to 1:100:100; or to 100:100:1; or to 100:1:100 preventing or treating a crop against a disease.

In some embodiments, the present application disclosed administering captan with a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and prothioconazole at a ratio between 1:1:1 to 1:100:1; or to 100:1:1; or to 1:1:100; or to 1:100:100; or to 100:100:1; or to 100:1:100 preventing or treating a crop against a disease.

In some embodiments, Table E disclosed preventing or treating pulses against anathracnose caused by Colletotrichum sp., which comprises administering folpet and two primary fungicides selected from the group consisting of Formula I, fenpicoxamid, fenpropidin, metyltetraprole, picarbutrazox, pydiflumetofen, prothioconazole and sulphur at at a ratio between 1:1:1 to 1:100:1; or to 100:1:1; or to 1:1:100; or to 1:100:100; or to 100:100:1; or to 100:1:100.

In some embodiments, Table E disclosed preventing or treating chili against anathracnose caused by Colletotrichum truncatum, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating soybean against Asian soybean rust caused by Phakopsora pachyrhizi, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating banana against Black sigatoka caused by Mycosphaerella fijiensis, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating cereals against Brown rust caused by Mycosphaerella fijiensis, which comprises administering folpet and two primary fungicides selected from the group consisting of Formula I, fenpicoxamid, fenpropidin, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating coffee against Coffee Berry Disease caused by Colletotrichum kahawae, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating coffee against Coffee Leaf Rust caused by Hemileia vastatrix, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating pulses against Didymella pisi caused by Ascochyta rabiei, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating cucurbits against Downy mildew caused by Pseudoperonospora cubensis, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating grape against Downy mildew caused by Plasmopara viticola, which comprises administering folpet and two primary fungicides selected from the group consisting of Formula I, fenpicoxamid, fenpropidin, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating potato or tomato against Early blight caused by Plasmopara viticola, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating cereals against Fusarium head blight caused by Fusarium sp., which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating corn against Gray Leaf Spot caused by Cercospora zeae-maydis, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating potato or tomato against Late blight caused by Phytophthora infestans, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating sugar beet against leaf spot of beet caused by Cercospora beticola, which comprises administering folpet and two primary fungicides selected from the group consisting of Formula I, fenpicoxamid, fenpropidin, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100. In some embodiments, Table E disclosed preventing or treating corn against Northern Corn Leaf Blight caused by Setosphaeria turcica, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating corn against Northern Corn Leaf Blight caused by Cochliobolus carbonum, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating cereals against Ramularia leaf spot caused by Ramularia collo-cygni, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating cotton against Ramularia leaf spot caused by Ramularia areola, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating sugar beet against Ramularia leaf spot caused by Ramularia beticola, which comprises administering folpet and two primary fungicides selected from the group consisting of Formula I, fenpicoxamid, fenpropidin, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating rice against Rice Blast caused by Pyricularia oryzae, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating sugar beet against Ramularia leaf spot caused by Ramularia beticola, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating rice against Rice Blast caused by Pyricularia oryzae, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating sugar beet against Rust caused by Uromyces betae, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating pome fruit against scab caused by Venturia inaequalis, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating sugar beet against OSR caused by Venturia inaequalis, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating cereals against Septoria caused by Zymoseptoria tritici, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating rice against Sheath Blight caused by Rhizoctonia solani or Thanatephorus cucumeris, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating corn against Southern corn leaf blight caused by Cochliobolus heterostrophus, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating soybean against Target spot caused by Corynespora cassiicola, which comprises administering folpet and two primary fungicides selected from the group consisting of Formula I, fenpicoxamid, fenpropidin, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating cereals against Yellow rust caused by Puccinia striiformis, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating banana against Yellow sigatoka caused by Pseudocercospora musae, which comprises administering folpet and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating pulses against anathracnose caused by Colletotrichum sp., which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating chili against anathracnose caused by Colletotrichum truncatum, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating soybean against Asian soybean rust caused by Phakopsora pachyrhizi, which comprises administering captan and two primary fungicides selected from the group consisting of Formula I, fenpicoxamid, fenpropidin, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating banana against Black sigatoka caused by Mycosphaerella fijiensis, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating cereals against Brown rust caused by Mycosphaerella fijiensis, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating coffee against Coffee Berry Disease caused by Colletotrichum kahawae, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating coffee against Coffee Leaf Rust caused by Hemileia vastatrix, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating pulses against Didymella pisi caused by Ascochyta rabiei, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating cucurbits against Downy mildew caused by Pseudoperonospora cubensis, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating grape against Downy mildew caused by Plasmopara viticola, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating potato or tomato against Early blight caused by Plasmopara viticola, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating cereals against Fusarium head blight caused by Fusarium sp., which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating corn against Gray Leaf Spot caused by Cercospora zeae-maydis, which comprises administering captan and two primary fungicides selected from the group consisting of Formula I, fenpicoxamid, fenpropidin, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating potato or tomato against Late blight caused by Phytophthora infestans, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating sugar beet against leaf spot of beet caused by Cercospora beticola, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating corn against Northern Corn Leaf Blight caused by Setosphaeria turcica, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating corn against Northern Corn Leaf Blight caused by Cochliobolus carbonum, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating cereals against Ramularia leaf spot caused by Ramularia collo-cygni, which comprises administering captan and two primary fungicides selected from the group consisting of Formula I, fenpicoxamid, fenpropidin, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating cotton against Ramularia leaf spot caused by Ramularia areola, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating sugar beet against Ramularia leaf spot caused by Ramularia beticola, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating rice against Rice Blast caused by Pyricularia oryzae, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating sugar beet against Ramularia leaf spot caused by Ramularia beticola, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating rice against Rice Blast caused by Pyricularia oryzae, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating sugar beet against Rust caused by Uromyces betae, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating pome fruit against scab caused by Venturia inaequalis, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating sugar beet against OSR caused by Venturia inaequalis, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiments, Table E disclosed preventing or treating cereals against Septoria caused by Zymoseptoria tritici, which comprises administering captan and two primary fungicides selected from the group consisting of Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur at a ratio between 1:1:1 to 1:100:1; or to 100:1:1; or to 1:1:100; or to 1:100:100; or to 100:100:1; or to 100:1:100.

In some embodiment, the combination comprises application to a target disease on a crop infected with a fungal pathogen with a phthalimide, a first primary fungicide and a second primary fungicide at a ratio, wherein the target disease, the fungal pathogen, the crop, the phthalimide, the first primary fungicide, the second primary fungicide and the ratio are indicated in each row of Table E.

In some embodiment, the combination comprises application to a target disease on a crop infected with a fungal pathogen with folpet, a first primary fungicide and a second primary fungicide at a ratio, wherein the target disease, the fungal pathogen, the crop, the first primary fungicide, the second primary fungicide and the ratio are indicated in each row of Table E.

In some embodiment, the combination comprises application to a target disease on a crop infected with a fungal pathogen with captan, a first primary fungicide and a second primary fungicide at a ratio, wherein the target disease, the fungal pathogen, the crop, the first primary fungicide, the second primary fungicide and the ratio are indicated in each row of Table E.

In some embodiments, the ratio between folpet and Formula I for controlling Plasmopara viticola in grape is between 1:1 and 30:1.

In some embodiments, the ratio between captan and Formula I for controlling Plasmopara viticola in grape is between 1:1 and 30:1.

In some embodiments, the ratio between folpet and Formula I for controlling Plasmopara viticola in grape is between 20:1 to 1:1 or 16:1 to 1:1 or 15:1 to 1:1 or 12:1 to 5.3:1.

In some embodiments, the ratio between folpet and Formula I for controlling Plasmopara viticola in grape is 8:1

In some embodiments, the ratio between folpet and Formula I for controlling Plasmopara viticola in grape is 5.3:1

In some embodiments, the ratio between folpet and Formula I for controlling Plasmopara viticola in grape is 12:1

In some embodiments, the ratio between folpet and Formula I for controlling Plasmopara viticola in grape is 8:1

In some embodiments, the ratio between captan and Formula I for controlling Plasmopara viticola in grape is between 20:1 to 1:1 or 16:1 to 1:1 or 15:1 to 1:1 or 12:1 to 5.3:1.

In some embodiments, the ratio between captan and Formula I for controlling Plasmopara viticola in grape is 8:1

In some embodiments, the ratio between captan and Formula I for controlling Plasmopara viticola in grape is 5.3:1

In some embodiments, the ratio between captan and Formula I for controlling Plasmopara viticola in grape is 12:1

In some embodiments, the ratio between captan and Formula I for controlling Plasmopara viticola in grape is 8:1

In some embodiments, folpet is applied at 7 gai/ha and Formula I is applied between 0.5 and 7 gai/ha.

In some embodiments, folpet and Formula I both applied at 7 gai/ha, or folpet is applied at 7 gai/ha and Formula I is applied at 0.5 gai/ha.

In some embodiments, the ratio between folpet and Formula I for controlling ramularia in barley is between 20:1 and 1:1 or 16:1 to 1:1 or 12:1 and 5:1.

In some embodiments, the ratio between captan and Formula I for controlling ramularia in barley is between 20:1 and 1:1 or 16:1 to 1:1 or 12:1 and 5:1.

In some embodiments, the ratio between folpet and Formula I for controlling ramularia in barley is 5:1

In some embodiments, the ratio between folpet and Formula I for controlling ramularia in barley is 12:1

In some embodiments, the ratio between folpet and Formula I for controlling ramularia in barley is 8.6:1

In some embodiments, the ratio between folpet and Formula I for controlling ramularia in barley is 16:1

In some embodiments, the ratio between folpet and Formula I for controlling ramularia in barley is 11.4:1

In some embodiments, the ratio between folpet and Formula I for controlling ramularia in barley is between 10:1 and 7.5:1, 7.5:1 and 6.7:1, or 6.7:1 and 5:1.

In some embodiments, wherein folpet is applied between 500 and 750 gai/ha and Formula is applied between 75 and 100 gai/ha.

In some embodiments, folpet is applied at 500 gai/ha and Formula I is applied at 75 gai/ha, or folpet is applied at 500 gai/ha and Formula I is applied at 100 gai/ha, or folpet is applied at 750 gai/ha and Formula I is applied at 100 gai/ha, or folpet is applied at 750 gai/ha and Formula I is applied at 75 gai/ha.

In some embodiments, the ratio between folpet and Formula I for controlling ramularia in barley is between 5:1 and 16:1.

In some embodiments, folpet is applied between 175 and 400 gai/ha and Formula is applied between 25-35 gai/ha.

In some embodiments, folpet is applied at 175 gai/ha and Formula I is applied at 35 gai/ha, or folpet is applied at 300 gai/ha and Formula I is applied at 25 gai/ha, or folpet is applied at 300 gai/ha and Formula I is applied at 35 gai/ha, or folpet is applied at 400 gai/ha and Formula I is applied at 25 gai/ha, or folpet is applied at 400 gai/ha and Formula I is applied at 35 gai/ha.

In some embodiments, folpet and Formula I for controlling ramularia on barley is between 5:1 and 16:1.

In some embodiments, the ratio between folpet and Formula I for controlling Plasmopara viticola on grape is between 5.3:1 and 12:1.

In some embodiments, folpet is applied at 400 gai/ha and Formula I is applied at 50 gai/ha, or folpet is applied at 400 gai/ha and Formula I is applied at 75 gai/ha, or folpet is applied at 600 gai/ha and Formula I is applied at 50 gai/ha, or folpet is applied at 600 gai/ha and Formula I is applied at 75 gai/ha.

In some embodiments, the ratio between folpet and Formula I for controlling Spilocea oleagina on olive is 1.2:1.

In some embodiments, folpet is applied at 12 g/HI and Formula I is applied at 10 ml/hL, or folpet is applied at 12 g/hL and Formula I is applied at 20 ml/hL.

The present invention provides an improved combination comprising an amount of a primary fungicide and an amount of a phthalimide fungicide.

The present invention provides a fungicidal combination or mixture comprising a) at least one succinate dehydrogenase inhibitor fungicide, and b) captan.

Preferred phthalimide fungicides (including combinations of phthalimide fungicides), primary fungicides (including combinations of primary fungicides), and combinations of phthalimide fungicides and primary fungicides, as well as preferred weight ratios, are described herein above.

In some embodiments, the combination is a mixture. Any of the combinations described herein may be in the form of a mixture.

The present invention provides a fungicidal mixture comprising, as active components a) a succinate dehydrogenase inhibitor fungicide; and b) captan.

In some embodiments, the mixture is a tank mix. Any of the combinations described herein may be in the form of a tank mix. In some embodiments, each of the phthalimide fungicide(s) and primary fungicide(s) is formulated in its own composition prior to tank mix.

In some embodiments, the combination is a composition. Any of the combinations described herein may be in the form of a composition.

The combination, mixture or composition comprising the primary fungicide and phthalimide fungicide may be an improved combination, mixture or composition in any one or any combination of ways as described below.

In some embodiments, the combination comprises an amount of fungicide I and an amount of a phthalimide fungicide. The combination comprising fungicide I and phthalimide fungicide may be an improved combination in any one or any combination of ways as described below.

In some embodiments, the combination is an improved combination in that it is synergistic.

In some embodiments, the combination is an improved combination in that the amount of the primary fungicide and the amount of the phthalimide fungicide are more effective for treating a plant or locus against fungal infection than when the amount of the phthalimide fungicide and the amount of a primary fungicide are applied alone.

In some embodiments, the combination is an improved combination in that the amount of the primary fungicide is more effective for treating a plant or locus against fungal infection when applied in combination with the amount of the phthalimide fungicide than when the same amount of the primary fungicide is applied not in combination with the same amount of the phthalimide fungicide.

In some embodiments, the combination is an improved combination in that the amount of the phthalimide fungicide is more effective for treating a plant or locus against fungal infection when applied in combination with the amount of the primary fungicide than when the same amount of the phthalimide fungicide is applied not in combination with the same amount of the primary fungicide.

In some embodiments, the combination is an improved combination in that the amount of the phthalimide fungicide improves the fungicidal efficacy of the amount of the primary fungicide compared to when the same amount of the primary fungicide is applied not in combination with the amount of the phthalimide fungicide. In some embodiments, the locus is soil.

In some embodiments, the combination is an improved combination in that the amount of the phthalimide fungicide improves the fungicidal efficacy of the amount of the primary fungicide compared to when the same amount of the primary fungicide is applied not in combination with the amount of the phthalimide fungicide.

In some embodiments, fungicidal efficacy is increased by at least 10%, 20%, or 30% compared to when the same amount of the primary fungicide is applied alone. In some embodiments, fungicidal efficacy is increased by at least 50%, 100%, 200% or 300% compared to when the same amount of the primary fungicide is applied alone.

In some embodiments, fungicidal efficacy is measured in a treated area of the plant. In some embodiments, fungicidal efficacy is measured in an untreated area of the plant. In some embodiments, fungicidal efficacy is increased in a treated area of the plant. In some embodiments, fungicidal efficacy is increased in an untreated area of the plant.

In some embodiments, fungicidal efficacy is measure at least 21 days after treatment. In some embodiments, fungicidal efficacy is measure at least 28 days after treatment.

In some embodiments, the combination is an improved combination in that a substantially similar level of fungicidal efficacy is achieved by using a lesser amount of the phthalimide fungicide and/or the primary fungicide.

In some embodiments, the amount of phthalimide fungicide in the combination is less than the fungicidally effective amount of phthalimide fungicide when phthalimide fungicide is used alone. In some embodiments, the amount of the phthalimide fungicide is less than its fungicidally effective amount. In some embodiments, the amount of the primary fungicide in the combination is less than the fungicidally effective amount of the primary fungicide when the primary fungicide is used alone.

In some embodiments, the combination is an improved combination in that the amount of the phthalimide fungicide is effective to increase sensitivity of the fungus to the amount of the primary fungicide compared to the sensitivity of the fungus to the amount of the primary fungicide when it is applied not in combination with the amount of the phthalimide fungicide.

In some embodiments, the combination is an improved combination in that the amount of the phthalimide fungicide is effective to increase bioavailability of the amount of the primary fungicide compared to the bioavailability of the amount of the primary fungicide when it is applied not in combination with the amount of the phthalimide fungicide.

Increasing bioavailability includes increasing penetration of the amount of the primary fungicide into the plant. The primary fungicide may penetrate into the plant by penetrating into leaves (including penetrating leaf cuticle) and/or roots. In some embodiments, the combination of the amount of the primary fungicide and the amount of the phthalimide fungicide increases penetration of the amount of the primary fungicide into the plant. In some embodiments, the combination of the amount of the primary fungicide and the amount of the phthalimide fungicide increases penetration of the amount of the primary fungicide into the plant leaf. In some embodiments, the combination of the amount of the primary fungicide and the amount of the phthalimide fungicide increases penetration of the primary fungicide into the plant root.

Increasing bioavailability also includes increased translocation of the amount of the primary fungicide once inside the plant, including leaves. In some embodiments, the combination of the amount of the primary fungicide and the amount of the phthalimide fungicide increases translocation of the amount of the primary fungicide after penetration into the plant.

In some embodiments, the combination is an improved combination in that it is more effective in treating the plant or locus against fungal infection than when each fungicide at the same amount is applied alone. In some embodiments, the primary fungicide as part of the combination is more effective in treating the plant or locus against fungal infection than when applied at the same amount alone. Increased effectiveness may be due to increased bioavailability and/or uptake by the fungal pathogen.

In some embodiments, the combination is an improved combination in that the amount of the primary fungicide and the amount of the phthalimide fungicide are more effective for treat a plant or locus against fungal infection than when the amount of the phthalimide fungicide and the amount of a primary fungicide are applied alone. In some embodiments, the combination comprises one or more primary fungicide(s) and the combination of the phthalimide fungicide and at least one of the primary fungicides applied is more effective in treating the plant or soil against fungal infection than when each fungicide at the same amount is applied alone. In some embodiments, the combination comprises two or more primary fungicides and the combination of the phthalimide fungicide and at least two of the primary fungicides applied is more effective in treating the plant or soil against fungal infection than when each fungicide at the same amount is applied alone.

In some embodiments, treating a plant or locus against fungal infection comprises inhibiting fungal mycelium formation.

In some embodiments, treating a plant or locus against fungal infection comprises combating phytopathogenic diseases on the plant or locus.

In some embodiments, treating the plant or locus against fungal infection comprises protecting the plant or locus from fungal attack.

In some embodiments, treating the plant or locus against fungal infection comprises preventing fungal infection of the plant or locus.

In some embodiments, treating the plant or locus against fungal infection comprises controlling fungal disease affecting the plant or locus.

In some embodiments, treating the plant or locus against fungal infection comprises controlling a fungal pathogen, a fungal pathogen group or a fungal pathogen class affecting the plant or locus.

In some embodiments, treating the plant or locus against fungal infection comprises controlling a fungal disease caused by a fungal pathogen, a fungal pathogen group or a fungal pathogen class affecting the plant or locus.

In some embodiments, treating the plant or locus against fungal infection comprises reducing fungal infection of the plant or locus.

In some embodiments, the combination is an improved combination in that it prolongs the period of protection against fungal infection and/or control of fungal infection than when the amount of the phthalimide fungicide and the amount of a primary fungicide are applied alone.

In some embodiments, the period of protection against fungal infection and/or control of fungal infection is prolonged by at least 7 days, 14 day, 21 days, or 28 days.

In some embodiments, the combination is an improved combination in that it reduces the amount of time needed to achieve a level of fungal control than when the amount of the phthalimide fungicide and the amount of a primary fungicide are applied alone.

An example for reduction is, if each fungicide is applied alone achieves 50% control of fungal disease 7 days after application, the mixture or composition disclosed herein achieves 50% control of fungal diseases 2 days after application where each fungicide is applied at the amount.

In some embodiments, the amount of time needed to achieve a level of fungal control is reduced by at least 1 day, 2 days, 3 days, 4 day, 5 days, 7 days, 10 days, 14 days or 21 days, or 28 days.

In some embodiments, the combination is an improved combination in that it improves plant development compared to the development of a plant affected by the same type and degree of fungal infection to which the combination is not applied. In some embodiments, the plant is a crop plant. In some embodiments, the primary fungicide as part of the combination is more effective in improving plant development than when applied at the same amount alone. In some embodiments, the phthalimide fungicide as part of the combination is more effective in improving plant development than when applied at the same amount alone.

In some embodiments, the plant development is improved by treating the plant against fungal attack.

In some embodiments, improving plant development comprises enhancing crop plants. In some embodiment, improving plant development comprises improving plant quality.

Improving plant development includes, but is not limited to, enhancing the root systems, enhancing shoot of the plant, enhancing plant vigor, enhancing greening effect on leaves and/or enhancing plant potential yield.

In some embodiments, improving plant development comprises enhancing the root system. In some embodiments, enhancement in root system is measured by root weight. In some embodiments, root weight is increased by at least 1%, 5%, 10, 20%, 30%, 40%, 50%, 60%, 70%, 80%, or 90%.

In some embodiments, improving plant development comprises enhancing shoot of the plant. In some embodiments, enhancement in shoot is measured by shoot weight. In some embodiments, shoot weight is increased by at least 1%, 5%, 10, 20%, 30%, 40%, 50%, 60%, 70%, 80%, or 90%.

In some embodiments, improving plant development comprises enhancing plant vigor. In some embodiments, plant vigor is assessed using the relative vigor index. In some embodiments, plant vigor is increased by at least 1%, 5%, 10, 20%, 30%, 40%, 50%, 60%, 70%, 80%, or 90%.

In some embodiments, improving plant development comprises enhancing greening effect on leaves. In some embodiments, greening effect on leaves is assessed using the relative vigor index. In some embodiments, greening effect on leaves is increased by at least 1%, 5%, or 10%.

In some embodiments, improving plant development comprises enhancing plant yield. In some embodiments, plant yield is increased by at least 1%, 5%, 10, 20%, 30%, 40%, 50%, 60%, 70%, 80%, or 90%.

In some embodiments, the amount of phthalimide fungicide in the combination is less than the fungicidally effective amount of the phthalimide fungicide when the phthalimide fungicide is applied alone.

In some embodiments, the amount of the primary fungicide in the combination is less than the fungicidally effective amount of the primary fungicide when the primary fungicide is applied not in combination with the phthalimide fungicide.

In some embodiments, the combination is an improved combination in that it is anti-resistance. Anti-resistance refers to the effect of blocking the development or the spreading of resistance by increased efficacy of the combination.

In some embodiments, the combination is an improved combination in that it has improved potentiated efficacy, improved long lasting effect, improved anti-resistance activity, improving activity against resistant strains, improved green leaf area, improved greening effect, increased disease spectrum of activity, increased efficacy against disease not controlled by the solo fungicides, higher yield, higher protein content, higher sugar content, higher °Brix, better color grading of fruits, higher thousand kernels weight, higher test weight or hectoliter weight, increased fruit size, increased number of marketable fruits, improved plant vigor, and/or reduced risks of adverse effects on plants.

In some embodiments, the combination comprises at least one pesticide in addition to the phthalimide fungicide(s) and the primary fungicide(s). In some embodiments, the combination comprises at least two pesticides in addition to the phthalimide fungicide(s) and the primary fungicide(s). In some embodiments, the pesticide is herbicide, insecticide, acaricides, or nematicide.

In some embodiments, the combination comprises at least one fungicide in addition to the phthalimide fungicide(s) and the primary fungicide(s). In some embodiments, the combination comprises at least two fungicides in addition to the phthalimide fungicide(s) and the primary fungicide(s).

In some embodiments, the combination does not comprise any pesticide other than the phthalimide fungicide and the primary fungicide.

In some embodiments, the combination comprises an additional crop protection agent, for example insecticides, herbicides, fungicides, bactericides, nematicides, molluscicides, growth regulators, biological agents, fertilizers, or mixtures thereof.

In some embodiments, the combination comprises at least one additive selected from the group consisting of wetting agents, anti-foaming, adhesives, neutralizers, thickeners, binders, sequestrates, fertilizers, biocides, stabilizers, buffers and anti-freeze agents.

The invention combinations help prevent fungal attack and thus enable the use of a reduced amount of fungicides at a later stage of the plant development. The present combination is capable of containing or destroying the microorganisms which occur on plants or parts of plants (fruits, flowers, foliage, stalks, tubers, roots) of a variety of crops of useful plants, and even on parts of plants which are formed at a later point in time and remain unharmed by such microorganisms.

### Compositions

The combinations of the present invention may be formulated as one composition. The combinations of the present invention may be formulated as separate compositions. The combinations of the present invention may be formulated in more than one composition.

The present invention also provides a fungicidal composition comprising any one of the combinations disclosed herein, and an agriculturally acceptable carrier.

The present invention also provides a fungicidal composition comprising (i) a phthalimide fungicide, (ii) a primary fungicide, and an agriculturally acceptable carrier.

Preferred phthalimide fungicides (including combinations of phthalimide fungicides), primary fungicides (including combinations of primary fungicides), and combinations of phthalimide fungicides and primary fungicides, as well as preferred weight ratios, are described herein above.

The agriculturally acceptable carrier may be liquid or solid. Suitable carriers are described in detail below.

In some embodiments, the composition comprises captan and 5-fluoro-4-imino-3-methyl-1-tosyl-3,4-dihydropyrimidin-2(1H)-one.

In some embodiments, the composition comprises folpet and 5-fluoro-4-imino-3-methyl-1-tosyl-3,4-dihydropyrimidin-2(1H)-one.

In some embodiments, the composition comprises captafol and 5-fluoro-4-imino-3-methyl-1-tosyl-3,4-dihydropyrimidin-2(1H)-one.

In an embodiment, the amount of the phthalimide fungicide(s) and the primary fungicide(s) in the composition is from about 0.1%, 0.5%, 1%, 1.5%, 2%, 2.5%, 3%, 3.5%, 4%, 4.5%, 5% to about 90%, 93%, 95%, 98%, 99% based on the total weight of the composition.

In an embodiment, the amount of the phthalimide fungicide(s) and the primary fungicide(s) in the composition is from about 0.5% to about 95% by weight based on the total weight of the composition.

In some embodiments, the succinate dehydrogenase inhibitor and phthalimide fungicide are present in a combined amount ranging from 5% to 80% by weight of the total weight of all components in the composition.

In some embodiments, the combined amount of fluxapyroxad and at least one phthalimide fungicide selected from group consisting of captan and captafol in the ready-for-use (ready-mix) formulations according to the invention is 0.01-95 wt. %, particularly 0.1-90 wt. %, more particularly 1-90 wt. %, even more particularly is 10-90 wt. %, based on the total weight of the formulation.

In some embodiments, the combined amount of the succinate dehydrogenase inhibitor fungicide and captan together in the ready-for-use (ready-mix) formulations is 1-95 wt. %, particularly 75-95 wt. %, based on the total weight of the formulation.

In yet another embodiment, the composition is prepared in the form of a ready-for-use (ready-mix) formulation. A ready-mix formulation can be obtained by combining the active components in a fungicidal effective amount with an agriculturally acceptable carrier, a surfactant or other application-promoting adjuvant customarily employed in formulation technology. This ready-use formulation can also be obtained by combining the active components with one or more fungicide active components, belonging to the same or to different chemical classes, in a fungicidal effective amount with an agriculturally acceptable carrier, a surfactant or other application-promoting adjuvant customarily employed in formulation technology.

In some embodiments, succinate dehydrogenase inhibitor fungicide and phthalimide fungicide are prepared separately, and the individual formulations are applied as is, or are diluted to predetermined concentrations. In some embodiments, succinate dehydrogenase inhibitor fungicide and phthalimide fungicide are prepared separately, and the formulations are mixed when are diluted to a predetermined concentration. In some embodiment, succinate dehydrogenase inhibitor fungicide and phthalimide fungicide are formulated together, and the formulation is applied as it is, or the formulation is diluted to a predetermined concentration.

In some embodiments, the composition of the present invention is applied in the form of a ready-for-use (ready-mix) formulation comprising fluxapyroxad and captan, which can be obtained by combining the two active components with an agriculturally acceptable carrier, a surfactant or other application-promoting adjuvant customarily employed in formulation technology.

In some embodiments, the composition of the present invention is applied in the form of a ready-for-use (ready-mix) formulation comprising fluxapyroxad and captafol, which can be obtained by combining the two active components with an agriculturally acceptable carrier, a surfactant or other application-promoting adjuvant customarily employed in formulation technology.

The present invention provides a fungicidal composition comprising a) at least one succinate dehydrogenase inhibitor fungicide, and b) captan.

The present invention provides a fungicidal composition comprising a) at least one succinate dehydrogenase inhibitor fungicide and b) captafol.

The present invention provides a fungicidal composition comprising a) at least one succinate dehydrogenase inhibitor fungicide, and b) folpet.

Preferred weight ratios between the succinate dehydrogenase inhibitor fungicide and the captan, captafol or folpet are described herein above.

In some embodiments, the succinate dehydrogenase inhibitor fungicide and the captan or captafol are present in a combined amount ranging from 5% to 80% by weight of the total weight of all components in the composition.

In some embodiments, the combined amount of the succinate dehydrogenase inhibitor fungicide and captan together in the ready-for-use (ready-mix) formulations is 1-95 wt. %, particularly 75-95 wt. %, based on the total weight of the formulation.

In some embodiments, the combined amount of fluxapyroxad and at least one phthalimide fungicide selected from group consisting of captan and captafol in the ready-for-use (ready-mix) composition according to the invention is 0.01-95 wt. %, particularly 0.1-90 wt. %, more particularly 1-90 wt. %, even more particularly is 10-90 wt. %, based on the total weight of the formulation.

In some embodiments, the combined amount of (i) the SDHI fungicide and/or DMI fungicide, and (ii) the phthalimide fungicide in the ready-for-use (ready-mix) composition is 0.01-95 wt. % based on the total weight of the composition. In some embodiments, the combined amount of (i) the SDHI fungicide and/or DMI fungicide, and (ii) the phthalimide fungicide in the ready-for-use (ready-mix) composition is 0.1-90 wt. % based on the total weight of the composition. In some embodiments, the combined amount of (i) the SDHI fungicide and/or DMI fungicide, and (ii) the phthalimide fungicide in the ready-for-use (ready-mix) composition 1-90 wt. % based on the total weight of the composition. In some embodiments, the combined amount of (i) the SDHI fungicide and/or DMI fungicide, and (ii) the phthalimide fungicide in the ready-for-use (ready-mix) composition is 10-90 wt. % based on the total weight of the composition.

In some embodiments, the combined amount of fluxapyroxad and at least one phthalimide fungicide selected from group consisting of captan and captafol in the ready-for-use (ready-mix) composition according to the invention is 0.01-95 wt. %, particularly 0.1-90 wt. %, more particularly 1-90 wt. %, even more particularly is 10-90 wt. %, based on the total weight of the composition.

In some embodiments, the composition comprises a phthalimide fungicide, 5-fluoro-4-imino-3-methyl-1-tosyl-3,4-dihydropyrimidin-2(1H)-one, and at least one additional primary fungicide. The additional primary fungicide(s) may be any one or any combination of the primary fungicides described herein.

The present composition may be employed or prepared in any conventional form, for example, as wettable powders (WP), emulsion concentrates (EC), microemulsion concentrates (MEC), water-soluble powders (SP), water-soluble concentrates (SL), suspoemulsion (SE), oil dispersions (OD), concentrated emulsions (BW) such as oil-in-water and water-in-oil emulsions, sprayable solutions or emulsions, capsule suspensions (CS), suspension concentrates (SC), suspension concentrates, dusts (DP), oil-miscible solutions (OL), a mixed formulation of CS and SC (ZC), a mixed heterogeneous formulation of CS and SE (ZE), a mixed heterogeneous formulation CS and EW (ZW), seed-dressing products, granules (GR) in the form of microgranules, spray granules, coated granules and absorption granules, granules for soil application or broadcasting, water-soluble granules (SG), water-dispersible granules (WDG), ULV formulations, microcapsules or waxes. These individual formulation types are known in the art.

The composition may be employed in any conventional form, especially in the form of water dispersible granules, coated granules, emulsifiable concentrate, suspension concentrate, microemulsion, oil dispersion, suspo-emulsion, capsule suspension, a mixed formulation of capsule suspension and suspension concentrate.

Such compositions may be produced in conventional manner, e.g. by mixing the active ingredients with appropriate adjuvants (diluents or solvents and optionally other formulating ingredients such as surfactants).

Aqueous use forms can be prepared from emulsion concentrates, suspensions, pastes, wettable powders or water-dispersible granules by adding water. To prepare emulsions, pastes or oil dispersions, the components of the compositions either as such or dissolved in an oil or solvent, can be homogenized in water by means of a wetting agent, tackifier, dispersant or emulsifier. Alternatively, it is also possible to prepare concentrates comprising active component, wetting agent, tackifier, dispersant or emulsifier and, if desired, a solvent or oil, which are suitable for dilution with water.

In some embodiments, the composition is a ready-for-use (ready mix) composition.

In some embodiments, the composition comprises at least one agriculturally acceptable additive. In some embodiments, the agriculturally acceptable additive is selected from the group of surfactants, solid diluents, liquid diluents and any combination thereof. The agriculturally acceptable additive may also be other application-promoting adjuvants customarily employed in formulation technology and formulation techniques that are known in the art.

In some embodiments, the composition comprises at least one additional component selected from the group of surfactants, solid diluents and liquid diluents.

Such compositions can be formulated using agriculturally acceptable carriers, surfactants or other application-promoting adjuvants customarily employed in formulation technology and formulation techniques that are known in the art.

Examples of suitable surfactants include, but are not limited to, non-ionic, anionic, cationic and ampholytic types such as alkoxylated fatty alcohols, ethoxylated polysorbate (e.g. tween 20), ethoxylated castor oil, lignin sulfonates, fatty acid sulfonates (e.g. lauryl sulfonate), phosphate esters such as phosphate esters of alcohol alkoxylates, phosphate esters of alkylphenol alkoxylates and phosphate esters of styrylphenol ethoxylates, condensates of sulfonated naphthalene and naphthalene derivatives with formaldehyde, condensates of naphthalene or of naphthalenesulfonic acid with phenol and formaldehyde, alkylarylsulfonates, ethoxylated alkylphenols and aryl phenols, polyalkylene glycols, sorbitol esters, alkali metal, sodium salts of lignosulphonates, tristyrylphenol ethoxylate phosphate esters, aliphatic alcohol ethoxylates, alkylphenol ethoxylates, ethylene oxide/propylene oxide block copolymers, graft copolymers and polyvinyl alcohol-vinyl acetate copolymers. Other surfactants known in the art may be used as desired.

Suitable carriers and adjuvants may be solid or liquid and correspond to the substances ordinarily employed in formulation technology, such as, e.g. natural or regenerated mineral substances, solvents, dispersants, wetting fungicides, tackifiers, thickeners, binding fungicides or fertilizers. Such carriers are for example described in WO 96/22690.

Examples of suitable liquid carriers potentially useful in the present compositions include but are not limited to water; aromatic hydrocarbons such as alkylbenzenes and alkylnaphthalenes; alcohols such as cyclohexanol, and decanol; ethylene glycol; polypropylene glycol; dipropropylene glycol; N,N-dimethylformamide; dimethylsulfoxide; dimethylacetamide; N-alkylpyrrolidones such as N-methyl-2-pyrrolidone; paraffins; various oils such as olive, castor, linseed, tung, sesame, corn, peanut, cotton-seed, soybean, rape-seed, or coconut oil; fatty acid esters; ketones such as cyclohexanone, 2-heptanone, isophorone, and 4-hydroxy-4-methyl-2-pentanone; and the like.

Examples of suitable solid carriers potentially useful in the present compositions include but are not limited to mineral earths such as silica gels, silicates, talc, kaolin, sericite, attaclay, limestone, bentonite, lime, chalk, bole, mirabilite, loess, clay, dolomite, zeolite, diatomaceous earth, calcium carbonate, calcium sulfate, magnesium sulfate, magnesium oxide, sodium carbonate and bicarbonate, and sodium sulfate; ground synthetic materials; fertilizers such as ammonium sulfate, ammonium phosphate, ammonium nitrate, ureas, and products of vegetable origin, such as cereal meal, tree bark meal, wood meal, and nutshell meal; cellulose powders; and other solid carriers.

Other ingredients, such as wetting agents, anti-foaming, adhesives, neutralizers, thickeners, binders, sequestrates, fertilizers, biocides, stabilizers, buffers or anti-freeze agents, may also be added to the present compositions in order to increase the stability, density, and viscosity of the described compositions.

Aqueous use forms can be prepared from emulsion concentrates, suspensions, pastes, wettable powders or water-dispersible granules by adding water. To prepare emulsions, pastes or oil dispersions, the components of the compositions either as such or dissolved in an oil or solvent, can be homogenized in water by means of a wetting agent, tackifier, dispersant or emulsifier. Alternatively, it is also possible to prepare concentrates comprising active component, wetting agent, tackifier, dispersant or emulsifier and, if desired, a solvent or oil, which are suitable for dilution with water.

Particularly compositions to be applied in spraying forms such as water dispersible concentrates or wettable powders may contain surfactants such as wetting and dispersing fungicides, e.g. the condensation product of formaldehyde with naphthalene sulphonate, an alkylarylsulphonate, a lignin sulphonate, a fatty alkyl sulphate, and ethoxylated alkylphenol and an ethoxylated fatty alcohol.

The composition according to the invention is generally formulated in various ways using formulation adjuvants, such as carriers, solvents and surface-active substances. The formulations can be in various physical forms, e.g. in the form of dusting powders, gels, wettable powders, water-dispersible granules, water-dispersible tablets, effervescent pellets, emulsifiable concentrates, microemulsifiable concentrates, oil-in-water emulsions, oil-flowables, aqueous dispersions, oily dispersions, suspo-emulsions, capsule suspensions, emulsifiable granules, soluble liquids, water-soluble concentrates (with water or a water-miscible organic solvent as carrier), impregnated polymer films or in other forms known e.g. from the Manual on Development and Use of FAO and WHO Specifications for Pesticides, United Nations, First Edition, Second Revision (2010). Such formulations can either be used directly or diluted prior to use. The dilutions can be made, for example, with water, liquid fertilisers, micronutrients, biological organisms, oil or solvents. The formulations can be prepared e.g. by mixing the active ingredient with the formulation adjuvants in order to obtain compositions in the form of finely divided solids, granules, solutions, dispersions or emulsions. The active ingredients can also be formulated with other adjuvants, such as finely divided solids, mineral oils, oils of vegetable or animal origin, modified oils of vegetable or animal origin, organic solvents, water, surface-active substances or combinations thereof.

The active ingredients can also be contained in microcapsules. Microcapsules contain the active ingredients in a porous carrier. This enables the active ingredients to be released into the environment in controlled amounts (e.g. slow-release). Microcapsules usually have a diameter of from 0.1 to 500 microns. They contain active ingredients in an amount of from about 25 to 95% by weight of the capsule weight. The active ingredients can be in the form of a monolithic solid, in the form of fine particles in solid or liquid dispersion or in the form of a suitable solution. The encapsulating membranes can comprise, for example, natural or synthetic rubbers, cellulose, styrene/butadiene copolymers, polyacrylonitrile, polyacrylate, polyesters, polyamides, polyureas, polyurethane or chemically modified polymers and starch xanthates or other polymers that are known to the person skilled in the art. Alternatively, very fine microcapsules can be formed in which the active ingredient is contained in the form of finely divided particles in a solid matrix of base substance, but the microcapsules are not themselves encapsulated.

The formulation adjuvants that are suitable for the preparation of the formulations according to the invention are known per se. As liquid carriers there may be used: water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, /V,/V-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, propylene glycol, glycerol, V-methyl-2-pyrrolidone and the like.

Suitable solid carriers are, for example, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances.

A large number of surface-active substances can advantageously be used in both solid and liquid formulations, especially in those formulations which can be diluted with a carrier prior to use. Surface-active substances may be anionic, cationic, non-ionic or polymeric and they can be used as emulsifiers, wetting fungicides or suspending fungicides or for other purposes. Typical surface-active substances include, for example, salts of alkyl sulfates, such as diethanolammonium lauryl sulfate; salts of alkylarylsulfonates, such as calcium dodecylbenzenesulfonate; alkylphenol/alkylene oxide addition products, such as nonylphenol ethoxylate; alcohol/alkylene oxide addition products, such as tridecylalcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryltrimethylammonium chloride, polyethylene glycol esters of fatty acids, such as polyethylene glycol stearate; block copolymers of ethylene oxide and propylene oxide; and salts of mono- and di-alkylphosphate esters.

Further adjuvants that can be used in pesticidal formulations include crystallisation inhibitors, viscosity modifiers, suspending fungicides, dyes, anti-oxidants, foaming fungicides, light absorbers, mixing auxiliaries, antifoams, complexing fungicides, neutralising or pH-modifying substances and buffers, corrosion inhibitors, fragrances, wetting fungicides, take-up enhancers, micronutrients, plasticizers, glidants, lubricants, dispersants, thickeners, antifreezes, microbicides, and liquid and solid fertilizers.

The compositions according to the invention can include an additive comprising an oil of vegetable or animal origin, a mineral oil, alkyl esters of such oils or mixtures of such oils and oil derivatives. The amount of oil additive in the formulation according to the invention is generally from 0.01 to 10%, based on the mixture to be applied. For example, the oil additive can be added to a spray tank in the desired concentration after a spray mixture has been prepared. Preferred oil additives comprise mineral oils or an oil of vegetable origin, for example rapeseed oil, olive oil or sunflower oil, emulsified vegetable oil, alkyl esters of oils of vegetable origin, for example the methyl derivatives, or an oil of animal origin, such as fish oil or beef tallow. Preferred oil additives comprise alkyl esters of C8-C22 fatty acids, especially the methyl derivatives of C12-C18 fatty acids, for example the methyl esters of lauric acid, palmitic acid and oleic acid (methyl laurate, methyl palmitate and methyl oleate, respectively).

A seed dressing composition is applied in a manner known per se to the seeds employing the mixture of the invention and a diluent in suitable seed dressing composition form, e.g. as an aqueous suspension or in a dry powder form having good adherence to the seeds. Such seed dressing composition are known in the art. Seed dressing composition may contain the single active ingredients or the combination of active ingredients of the present invention in encapsulated form, e.g. as slow release capsules or microcapsules.

In general, the formulations include from 0.01 to 90% by weight of active fungicide, from 0 to 20% agriculturally acceptable surfactant and 10 to 99.99% solid or liquid adjuvant(s). Concentrate forms of compositions generally contain in between about 2 and 80%, preferably between about 5 and 70% by weight of active fungicide. Application forms of formulation may for example contain from 0.01 to 20% by weight, preferably from 0.01 to 5% by weight of active fungicide.

Concentrate forms of compositions generally are diluted before application.

The present composition may include additional crop protection agents, for example insecticides, herbicides, fungicides, bactericides, nematicides, molluscicides, growth regulators, biological agents, fertilizers, or mixtures thereof.

However, for the avoidance of doubt it is understood that such additional crop protection agents are unnecessary to achieve the desired control of fungal disease as achieved by the present mixture. Accordingly, the present fungicidal compositions and mixtures may be limited to containing a primary fungicide and a phthalimide fungicide, as the only crop protection agents present.

### Process of Preparation

The present invention also provides a process of preparing the composition described herein, comprises the steps of: (i) obtaining an amount of the phthalimide fungicide(s) and an amount of the primary fungicide(s), and (ii) mixing the obtained amount of phthalimide fungicide(s) and the obtained amount of the primary fungicide(s) to obtain the composition.

In some embodiments, the amount of the phthalimide fungicide is less than the fungicidally effective amount of the phthalimide fungicide when the phthalimide fungicide is used alone. In some embodiments, the amount of the primary fungicide is less than the fungicidally effective amount of the primary fungicide when the primary fungicide is used alone.

In some embodiments, step (i) comprises obtaining an amount of agrochemically acceptable carrier(s) and step (ii) comprises mixing the amount of agrochemically acceptable carrier(s) with the obtained amount of phthalimide fungicide(s) and the obtained amount of the primary fungicide(s) to obtain the composition.

### Packages and Kits

The present invention also provides a package comprising any one of the combinations disclosed herein. In some embodiments, the combination is any one of the mixtures described herein. In some embodiments, the combination is any one of the compositions described herein.

In some embodiments, the package comprises instructions for using the combination for treating a plant from fungal attack. In some embodiments, the package comprises instructions for using the combination for protecting a plant from fungal attack. In some embodiments, the package comprises instructions for using the combination for controlling fungal disease infecting a plant. In some embodiments, the instructions comprise application rates, application times, target fungal pathogen, and/or target plant as described herein.

In another embodiment, the present invention provides a kit comprising a synergistic fungicidal composition as described herein, or components thereof. Such kits may comprise, in addition to the aforementioned active components, one or more additional active and/or inactive component, either within the provided fungicidal composition or separately. Certain kits comprise a) a succinate dehydrogenase inhibitor fungicide and b) captan, each in a separate container, and each optionally combined with a carrier.

In some embodiments, the compositions, kits and methods described herein exhibit a synergistic effect. A synergistic effect exists wherever the action of a combination of active components is greater than the sum of the action of each of the components alone. Therefore, a synergistically effective amount (or an effective amount of a synergistic composition or mixture) is an amount that exhibits greater fungicidal activity than the sum of the fungicidal activities of the individual components.

In another embodiment, the present invention provides a kit comprising mixture and/or composition fungicidal composition as described herein, or components thereof. Such kits may comprise, in addition to the aforementioned active components, one or more additional active and/or inactive component, either within the provided fungicidal composition or separately. Certain kits comprise (1) an amount of phthalimide fungicide and (2) an amount of succinate dehydrogenase inhibitor fungicide each in a separate container, and each optionally combined with a carrier.

In another embodiment, the present invention provides a kit comprising combination and/or composition as described herein, or components thereof. Such kits may comprise, in addition to the aforementioned active components, one or more additional active and/or inactive component, either within the provided fungicidal composition or separately.

In some embodiments, the kit comprises (i) a SDHI fungicide, a DMI fungicide or a combination thereof, and (ii) at least one phthalimide fungicide, each in a separate container, and each optionally combined with a carrier.

In some embodiments, the kit comprises (i) a SDHI fungicide, and (ii) folpet, each in a separate container, and each optionally combined with a carrier.

In some embodiments, the kit comprises (i) a DMI fungicide, and (ii) folpet, each in a separate container, and each optionally combined with a carrier.

Certain kits comprise a) a succinate dehydrogenase inhibitor fungicide and b) captan, each in a separate container, and each optionally combined with a carrier.

### Uses

The present invention provides a combination of an amount of a phthalimide fungicide and an amount of at least one primary fungicide selected from pyrimidinone fungicide, QiI (quinone inside inhibitors), QoI (quinone outside inhibitors), SDHI (succinate dehydrogenase inhibitors), DMI fungicide (demethylation inhibitor fungicide), OSBPI (oxysterol binding protein inhibitor), amine fungicide, tetrazolyloxime fungicide, phenylpyridinamine fungicide, or inorganic fungicide and any combination thereof, for use to treat a plant or locus against fungal infection wherein the use comprises applying the combination of the amount of the phthalimide fungicide and the amount of the primary fungicide to the plant or locus, wherein (i) the combination of the amount of the phthalimide fungicide and the amount of the primary fungicide is more effective against fungal infection than when the amount of the phthalimide fungicide and the amount of a primary fungicide are applied alone, and/or (ii) the amount of the phthalimide fungicide improves the fungicidal efficacy of the amount of the primary fungicide compared to when the same amount of the primary fungicide is applied not in combination with the amount of the phthalimide fungicide.

In some embodiments, the locus is soil.

In some embodiments, the use comprising applying the amount of the primary fungicide in combination with the amount of the phthalimide fungicide improves the fungicidal efficacy of the amount of primary fungicide compared to when the same amount of the primary fungicide is applied not in combination with the amount of the phthalimide fungicide. The present invention provides a combination of an amount of a phthalimide fungicide and an amount of a primary fungicide for use to improving fungicidal efficacy of the amount of the primary fungicide comprising applying the combination of the amount of the phthalimide fungicide and the amount of the primary fungicide to the fungus, so as to thereby improve the fungicidal efficacy of the amount of the primary fungicide compared to when the same amount of the primary fungicide is applied not in combination with the amount of the phthalimide fungicide.

In some embodiments, fungicidal efficacy is increased by at least 10%, 20%, or 30% compared to when the same amount of the primary fungicide is applied alone. In some embodiments, fungicidal efficacy is increased by at least 50%, 100%, 200% or 300% compared to when the same amount of the primary fungicide is applied alone.

In some embodiments, fungicidal efficacy is measured in a treated area of the plant. In some embodiments, fungicidal efficacy is measured in an untreated area of the plant. In some embodiments, fungicidal efficacy is increased in a treated area of the plant. In some embodiments, fungicidal efficacy is increased in an untreated area of the plant.

In some embodiments, fungicidal efficacy is measure at least 21 days after treatment. In some embodiments, fungicidal efficacy is measure at least 28 days after treatment.

In some embodiments, the amount of the phthalimide fungicide is effective to increase sensitivity of the fungus to the amount of the primary fungicide compared to the sensitivity of the fungus to the amount of the primary fungicide when it is applied not in combination with the amount of the phthalimide fungicide, so as to thereby improve the fungicidal efficacy of the amount of the primary fungicide. The present invention provides a combination of an amount of a phthalimide fungicide and an amount of a primary fungicide for use to increase sensitivity of a fungus to the amount of the primary fungicide comprising applying a combination of the amount of the phthalimide fungicide and the amount of the primary fungicide to the fungus, so as to thereby increase sensitivity of the fungus to the amount of the primary fungicide.

In some embodiments, the amount of the phthalimide fungicide is effective to increase bioavailability of the amount of the primary fungicide compared to the bioavailability of the amount of the primary fungicide when it is applied not in combination with the amount of the phthalimide fungicide, so as to thereby improve the fungicidal efficacy of the amount of the primary fungicide. In some embodiments, the use increases the bioavailability the amount of the primary fungicide in the roots. In some embodiments, the use increases the bioavailability of the amount of the primary fungicide in the leaves. The present invention provides a combination of an amount of a phthalimide fungicide and an amount of a primary fungicide for use to increase bioavailability of the amount of the primary fungicide to a plant comprising applying the combination of the amount of the phthalimide fungicide and the amount of the primary fungicide to the plant, so as to thereby increase bioavailability of the amount of the primary fungicide.

Increasing bioavailability includes increasing penetration of the amount of the primary fungicide into the plant. The primary fungicide may penetrate into the plant by penetrating into leaves (including penetrating leaf cuticle) and/or roots. In some embodiments, applying the amount of the primary fungicide in combination with the amount of the phthalimide fungicide increases penetration of the amount of the primary fungicide into the plant. In some embodiments, applying the amount of the primary fungicide in combination with the amount of the phthalimide fungicide increases penetration of the amount of the primary fungicide into the plant leaf. In some embodiments, applying the amount of the primary fungicide in combination with the amount of the phthalimide fungicide increases penetration of the primary fungicide into the plant root. The present invention provides a combination of an amount of a phthalimide fungicide and an amount of a primary fungicide for use to increase penetration of the amount of the primary fungicide into a plant comprising applying a combination of the amount of the phthalimide fungicide and the amount of the primary fungicide to the plant, so as to thereby increase penetration of the amount of the primary fungicide into the plant.

Increasing bioavailability also includes increased translocation of the amount of the primary fungicide once inside the plant, including leaves. In some embodiments, applying the amount of the primary fungicide in combination with the amount of the phthalimide fungicide increases translocation of the amount of the primary fungicide after penetration into the plant. The present invention provides a combination of an amount of a phthalimide fungicide and an amount of a primary fungicide for use to increase translocation of the amount of the primary fungicide in a plant comprising applying a combination of the amount of the phthalimide fungicide and the amount of the primary fungicide to the plant, so as to thereby increase translocation of the amount of the primary fungicide in the plant.

In some embodiments, the combination of the amount of the phthalimide fungicide and the amount of the primary fungicide is for use to treat a plant or locus against fungal infection, wherein the combination of the amount of the phthalimide fungicide and the amount of the primary fungicide is more effective against fungal infection than when the amount of the phthalimide fungicide and the amount of a primary fungicide are applied alone.

In some embodiments, treating a plant or soil against fungal infection comprises inhibiting fungal mycelium formation. The present invention also provides a combination of an amount of a phthalimide fungicide and an amount of a primary fungicide for use to inhibit fungal mycelium formation comprising applying a combination of the amount of the phthalimide fungicide and the amount of the primary fungicide to the fungus, so as to thereby inhibit fungal mycelium formation.

In some embodiments, treating a plant or locus against fungal infection comprises combating phytopathogenic diseases on the plant or locus. The present invention also provides a combination of an amount of a phthalimide fungicide and an amount of a primary fungicide for use to combat phytopathogenic diseases on a plant or locus which comprises applying to the plant or to the locus a combination of the phthalimide fungicide and the primary fungicide. In some embodiments, the plant is a crop plant.

In some embodiments, treating the plant or locus against fungal infection comprises protecting the plant or locus from fungal attack.

In some embodiments, treating the plant or locus against fungal infection comprises preventing fungal infection of the plant or locus.

In some embodiments, treating the plant or locus against fungal infection comprises controlling fungal disease affecting the plant or locus.

In some embodiments, treating the plant or locus against fungal infection comprises controlling a fungal pathogen, a fungal pathogen group or a fungal pathogen class affecting the plant or locus.

In some embodiments, treating the plant or locus against fungal infection comprises controlling a fungal disease caused by a fungal pathogen, a fungal pathogen group or a fungal pathogen class affecting the plant or locus.

In some embodiments, treating the plant or locus against fungal infection comprises reducing fungal infection of the plant or locus.

In some embodiments, the use is effective for prolonging the period of protection against fungal infection and/or control of fungal infection than when the amount of the phthalimide fungicide and the amount of a primary fungicide are applied alone. The present invention also provides a combination of an amount of a phthalimide fungicide and an amount of a primary fungicide for use to prolong the period of protection against fungal infection and/or control of fungal infection from an application of an amount of a primary fungicide to a plant or locus comprising applying a combination of the amount of the phthalimide fungicide and the amount of the primary fungicide to the plant or locus. In some embodiments, the plant is a crop plant.

In some embodiments, the period of protection against fungal infection and/or control of fungal infection is prolonged by at least 7 days, 14 day, 21 days, or 28 days.

In some embodiments, the use is effective for reducing the amount of time needed to achieve a level of fungal control compared to when the amount of the phthalimide fungicide and the amount of a primary fungicide are applied alone. The present invention also provides a combination of an amount of a phthalimide fungicide and an amount of a primary fungicide for use to reduce the amount of time needed to achieve a level of fungal control from an application of an amount of primary fungicide to a plant or locus comprising applying a combination of the amount of the phthalimide fungicide and the amount of the primary fungicide to the plant or locus.

An example for reduction is, if each fungicide is applied alone achieves 50% control of fungal disease 7 days after application, the method disclosed herein achieves 50% control of fungal diseases 2 days after application where each fungicide is applied at the amount.

In some embodiments, the amount of time needed to achieve a level of fungal control is reduced by at least 1 day, 2 days, 3 days, 4 day, 5 days, 7 days, 10 days, 14 days or 21 days, or 28 days.

In some embodiments, the use is effective for improving plant development compared to the development of a plant affected by the same type and degree of fungal infection to which the combination is not applied. The present invention also provides a combination of an amount of a phthalimide fungicide and an amount of a primary fungicide for use to improve development of a plant affected by fungal infection comprising applying a combination of the phthalimide fungicide and the primary fungicide to the plant or a locus thereof so as to improve the development of the plant compared to the development of a plant affected by the same type and degree of fungal infection to which the combination is not applied. In some embodiments, the plant is a crop plant.

In some embodiments, the plant development is improved by treating the plant against fungal attack.

In some embodiments, improving plant development comprises enhancing crop plants. In some embodiment, improving plant development comprises improving plant quality.

Improving plant development includes, but is not limited to, enhancing the root systems, enhancing shoot of the plant, enhancing plant vigor, enhancing greening effect on leaves and/or enhancing plant potential yield.

In some embodiments, improving plant development comprises enhancing the root system. In some embodiments, enhancement in root system is measured by root weight. In some embodiments, root weight is increased by at least 1%, 5%, 10, 20%, 30%, 40%, 50%, 60%, 70%, 80%, or 90%.

In some embodiments, improving plant development comprises enhancing shoot of the plant. In some embodiments, enhancement in shoot is measured by shoot weight. In some embodiments, shoot weight is increased by at least 1%, 5%, 10, 20%, 30%, 40%, 50%, 60%, 70%, 80%, or 90%.

In some embodiments, improving plant development comprises enhancing plant vigor. In some embodiments, plant vigor is assessed using the relative vigor index. In some embodiments, plant vigor is increased by at least 1%, 5%, 10, 20%, 30%, 40%, 50%, 60%, 70%, 80%, or 90%.

In some embodiments, improving plant development comprises enhancing greening effect on leaves. In some embodiments, greening effect on leaves is assessed using the relative vigor index. In some embodiments, greening effect on leaves is increased by at least 1%, 5%, or 10%.

In some embodiments, improving plant development comprises enhancing plant yield. In some embodiments, plant yield is increased by at least 1%, 5%, 10, 20%, 30%, 40%, 50%, 60%, 70%, 80%, or 90%.

In some embodiments, the combination is more effective in treating the plant or locus against fungal infection than when each fungicide at the same amount is applied alone.

In some embodiments, the combination comprises one or more primary fungicide(s) and the combination of the phthalimide fungicide and at least one of the primary fungicides applied is more effective in treating the plant or soil against fungal infection than when each fungicide at the same amount is applied alone. In some embodiments, the combination comprises two or more primary fungicides and the combination of the phthalimide fungicide and at least two of the primary fungicides applied is more effective in treating the plant or soil against fungal infection than when each fungicide at the same amount is applied alone.

In some embodiments, the combination is more effective in treating the plant or locus against fungal infection than when the primary fungicide at the same amount is applied alone.

In some embodiments, the amount of phthalimide fungicide applied is less than the fungicidally effective amount of the phthalimide fungicide when the phthalimide fungicide is applied alone.

In some embodiments, the amount of the primary fungicide applied is less than the fungicidally effective amount of the primary fungicide when the primary fungicide is applied not in combination with the phthalimide fungicide.

Preferred phthalimide fungicide(s), primary fungicide(s), and combinations of phthalimide fungicide(s) and primary fungicide(s) are described herein. Any one the phthalimide fungicide(s), primary fungicide(s), and combinations of phthalimide fungicide(s) and primary fungicide(s) described herein may be used in connection with the uses described herein.

Fungal pathogens, fungal pathogen groups and fungal pathogen classes that the combinations of the present invention are particularly effective in treating against are described herein. The combinations of the present invention may be used for treating a plant or locus against any one or any combination of the fungal pathogens, fungal pathogen groups and fungal pathogen classes described herein, or any fungal diseases caused thereby.

The present invention also provides use of any one of the combination, mixtures or compositions disclosed herein for combating phytopathogenic (fungal) diseases on crop plants.

The present invention also provides use of any one of the combination, mixtures or compositions disclosed herein for treating a plant or soil against fungal infection.

The present invention also provides use of any one of the combination, mixtures or compositions disclosed herein for combating phytopathogenic diseases on crop plants.

The present invention also provides use of any one of the combination, mixtures or compositions disclosed herein for treating a plant or soil against fungal infection.

The present invention also provides use of any one of the combination, mixtures or compositions disclosed herein for protecting a plant or soil from fungal attack.

The present invention also provides use of any one of the combination, mixtures or compositions disclosed herein for protecting a plant or soil from fungal infection.

The present invention also provides use of any one of the combination, mixtures or compositions disclosed herein for preventing fungal infection of a plant or soil.

The present invention also provides use of any one of the combination, mixtures or compositions disclosed herein for controlling fungal infection on a plant or soil.

The present invention also provides use of any one of the combination, mixtures or compositions disclosed herein for controlling fungal disease infecting a plant.

The present invention provides a use of fungicidal mixture or combination comprising, a) at least one succinate dehydrogenase inhibitor fungicide and b) captan, for protecting and prolonging the lifespan of medium to high resistance risk fungicides.

The present invention provides a use of fungicidal mixture or combination comprising, a) at least one succinate dehydrogenase inhibitor fungicide and b) captafol, for protecting and prolonging the lifespan of medium to high resistance risk fungicides.

The present invention provides a use of fungicidal mixture or combination comprising (1) an amount of phthalimide fungicide and (2) an amount of succinate dehydrogenase inhibitor fungicide for controlling an apple Scab disease.

The present invention provides a mixture or combination for controlling an apple Scab disease comprising (1) an amount of phthalimide fungicide and (2) an amount of succinate dehydrogenase inhibitor fungicide.

The present invention provides a use of fungicidal mixture or combination comprising (1) phthalimide fungicide and (2) succinate dehydrogenase inhibitor fungicide for controlling an apple Scab disease.

The present invention provides a fungicidal mixture or combination for controlling an apple Scab disease comprising (1) phthalimide fungicide and (2) succinate dehydrogenase inhibitor fungicide.

The present invention provides a use of fungicidal mixture or combination comprising (1) at least one phthalimide fungicide and (2) at least one succinate dehydrogenase inhibitor fungicide for controlling an apple Scab disease.

The present invention provides a mixture or combination for controlling an apple Scab disease comprising (1) at least one phthalimide fungicide and (2) at least one succinate dehydrogenase inhibitor fungicide.

The present invention provides a use of fungicidal mixture or combination comprising (1) an amount of phthalimide fungicide and (2) an amount of succinate dehydrogenase inhibitor fungicide for controlling disease in vegetable crop.

The present invention provides a fungicidal mixture or combination for controlling disease in vegetable crop comprising 1) an amount of phthalimide fungicide and (2) an amount of succinate dehydrogenase inhibitor fungicide for controlling disease in vegetable crop.

In some embodiments, the vegetable crop is potato.

In some embodiments, the vegetable crop is tomato.

In some embodiments, the vegetable crop is chilli.

In some embodiments, the disease is Anthracnose and/or Alternaria.

In some embodiments, the disease is Early blight.

The present invention provides a use of a fungicidal mixture or combination comprising, (1) an amount of phthalimide fungicide and (2) an amount of succinate dehydrogenase inhibitor fungicide for controlling Early blight disease in potato.

The present invention provides a fungicidal mixture or combination for controlling Early blight disease in potato, comprising (1) an amount of phthalimide fungicide and (2) an amount of succinate dehydrogenase inhibitor fungicide.

The present invention provides a use of a fungicidal mixture or combination comprising, (1) an amount of phthalimide fungicide and (2) an amount of succinate dehydrogenase inhibitor fungicide for controlling Early blight disease in tomato.

The present subject matter also relates to a use of fungicidal mixture or combination comprising (1) an amount of phthalimide fungicide and (2) an amount of succinate dehydrogenase inhibitor fungicide for protecting and prolonging the lifespan of medium to high resistance risk fungicides.

The present invention provides a fungicidal mixture or combination for controlling Early blight disease in tomato, comprising (1) an amount of phthalimide fungicide and (2) an amount of succinate dehydrogenase inhibitor fungicide.

The present invention provides a use of a fungicidal mixture or combination comprising (1) an amount of phthalimide fungicide and (2) an amount of succinate dehydrogenase inhibitor fungicide for controlling Sheath Blight disease in rice.

The present invention provides a fungicidal mixture or combination for controlling Sheath Blight disease on rice, comprising (1) an amount of phthalimide fungicide and (2) an amount of succinate dehydrogenase inhibitor fungicide.

The present invention provides a use of a fungicidal mixture or combination comprising (1) phthalimide fungicide and (2) succinate dehydrogenase inhibitor fungicide for controlling Early blight disease in potatoes.

The present invention provides a mixture or combination for controlling Early blight disease in potatoes, comprising (1) phthalimide fungicide and (2) succinate dehydrogenase inhibitor fungicide.

The present invention provides a method for controlling Early blight disease in tomatoes, comprising applying a fungicidal mixture or combination comprising (1) phthalimide fungicide and (2) succinate dehydrogenase inhibitor fungicide to the plant, propagation material of the plant, and/or a locus of the plant.

The present invention provides a use of a fungicidal mixture or combination comprising, (1) phthalimide fungicide and (2) succinate dehydrogenase inhibitor fungicide for controlling Early blight disease in tomatoes.

The present invention provides a fungicidal mixture or combination for controlling Early blight disease in tomatoes, comprising (1) phthalimide fungicide and (2) succinate dehydrogenase inhibitor fungicide.

The present invention provides a use of a fungicidal mixture or combination comprising (1) phthalimide fungicide and (2) succinate dehydrogenase inhibitor fungicide for controlling Sheath Blight disease in rice.

The present invention provides a mixture or combination for controlling Sheath Blight disease on rice, comprising (1) phthalimide fungicide and (2) succinate dehydrogenase inhibitor fungicide.

The present invention provides a use of a fungicidal mixture or combination comprising (1) at least one phthalimide fungicide and (2) at least one succinate dehydrogenase inhibitor fungicide for controlling Early blight disease in potatoes.

The present invention provides a mixture or combination for controlling Early blight disease in potatoes, comprising (1) at least one phthalimide fungicide and (2) at least one succinate dehydrogenase inhibitor fungicide.

The present invention provides a use of a fungicidal mixture or combination comprising (1) at least one phthalimide fungicide and (2) at least one succinate dehydrogenase inhibitor fungicide for controlling Early blight disease in tomatoes.

The present invention provides a fungicidal mixture for controlling Early blight disease in tomatoes, comprising (1) at least one phthalimide fungicide and (2) at least one succinate dehydrogenase inhibitor fungicide.

The present invention provides a use of a fungicidal mixture or combination comprising (1) at least one phthalimide fungicide and (2) at least one succinate dehydrogenase inhibitor fungicide for controlling Sheath Blight disease in rice.

The present invention provides a fungicidal mixture or combination for controlling Sheath Blight disease in rice, comprising (1) at least one phthalimide fungicide and (2) at least one succinate dehydrogenase inhibitor fungicide.

In some embodiments, the mixture or combination is a synergistic mixture or combination.

The present invention provides a use of a fungicidal mixture or combination comprising (1) an amount of phthalimide fungicide and (2) an amount of succinate dehydrogenase inhibitor fungicide for controlling Anthracnose disease in chili.

The present invention provides a mixture or combination for controlling Anthracnose disease in chili, comprising (1) an amount of phthalimide fungicide and (2) an amount of succinate dehydrogenase inhibitor fungicide.

The present invention provides a use of a fungicidal mixture or combination comprising (1) an amount of phthalimide fungicide and (2) an amount of succinate dehydrogenase inhibitor fungicide for controlling disease in chili.

The present invention provides a mixture or combination for controlling disease in chili, comprising (1) an amount of phthalimide fungicide and (2) an amount of succinate dehydrogenase inhibitor fungicide.

The present invention provides a method for controlling disease in chili, comprising applying a fungicidal mixture or combination comprising (1) phthalimide fungicide and (2) succinate dehydrogenase inhibitor fungicide to the plant, propagation material of the plant, and/or a locus of the plant.

The present invention provides a use of a fungicidal mixture or combination comprising (1) phthalimide fungicide and (2) succinate dehydrogenase inhibitor fungicide for controlling disease in chili.

The present invention provides a mixture or combination for controlling disease in chili, comprising (1) phthalimide fungicide and (2) succinate dehydrogenase inhibitor fungicide.

The present invention provides a use of a fungicidal mixture or combination comprising (1) at least one phthalimide fungicide and (2) at least one succinate dehydrogenase inhibitor fungicide for controlling Alternaria disease in chili crop.

The present invention provides a mixture or combination for controlling Alternaria disease in chili crop, comprising (1) at least one phthalimide fungicide and (2) at least one succinate dehydrogenase inhibitor fungicide.

In some embodiments, the fungicidal mixture or combination is a synergistic mixture or combination.

In some embodiments, the amount of succinate dehydrogenase inhibitor fungicide and the amount of the phthalimide fungicide if applied together is more effective for controlling the disease than if each fungicide at the same amount is applied alone.

The present invention provides a use of a fungicidal mixture or combination comprising (1) an amount of phthalimide fungicide and (2) an amount of succinate dehydrogenase inhibitor fungicide for controlling disease in chili.

The present invention provides a fungicidal mixture or combination for controlling disease in chili, comprising (1) an amount of phthalimide fungicide and (2) an amount of succinate dehydrogenase inhibitor fungicide.

The present invention provides a use of a fungicidal mixture or combination comprising (1) phthalimide fungicide and (2) succinate dehydrogenase inhibitor fungicide for controlling fungal disease in chili.

The present invention provides a mixture or combination for controlling fungal disease in chili, comprising (1) phthalimide fungicide and (2) succinate dehydrogenase inhibitor fungicide.

The present invention provides a use of a fungicidal mixture or combination comprising (1) at least one phthalimide fungicide and (2) at least one succinate dehydrogenase inhibitor fungicide for controlling fungal disease in chili.

The present invention provides a fungicidal mixture or combination for controlling fungal disease in chili crop, comprising (1) at least one phthalimide fungicide and (2) at least one succinate dehydrogenase inhibitor fungicide.

In some embodiments, the disease is Anthracnose and/or Alternaria.

In some embodiments, the disease is caused by Colletotrichum capsica.

In some embodiments, the disease is caused Alternaria solani.

The present invention provides a use of fungicidal mixture or combination comprising (a) at least one phthalimide fungicide selected from the group consisting of captan, folpet, captafol and any combination thereof and (b) at least one succinate dehydrogenase inhibitor fungicide for controlling fungal disease in banana.

The present invention provides a use of fungicidal mixture or combination comprising (a) at least one phthalimide fungicide selected from the group consisting of captan, folpet, captafol and any combination thereof and (b) at least one succinate dehydrogenase inhibitor fungicide for controlling Black sigatoka in banana.

The present invention provides a fungicidal mixture or combination for controlling fungal disease in banana comprising (a) at least one phthalimide fungicide selected from the group consisting of captan, folpet, captafol and any combination thereof and (b) at least one succinate dehydrogenase inhibitor fungicide.

The present invention provides a fungicidal mixture or combination for controlling Black sigatoka in banana comprising (a) at least one phthalimide fungicide selected from the group consisting of captan, folpet, captafol and any combination thereof and (b) at least one succinate dehydrogenase inhibitor fungicide.

In some embodiments, the fungal disease caused by Mycosphaerella fijiensis

The present invention provides a fungicidal mixture or combination for controlling Plasmopara viticola, in grape comprising (a) at least one phthalimide fungicide selected from the group consisting of captan, folpet, captafol and any combination thereof and (b) at least one succinate dehydrogenase inhibitor fungicide.

The present invention provides a use of fungicidal mixture or combination comprising (1) an amount of phthalimide fungicide and (2) an amount of succinate dehydrogenase inhibitor fungicide for protecting and prolonging the lifespan of medium to high resistance risk fungicides.

The present invention provides a use of fungicidal mixture or combination comprising (1) phthalimide fungicide and (2) succinate dehydrogenase inhibitor fungicide for protecting and prolonging the lifespan of medium to high resistance risk fungicides.

The present invention provides a use of fungicidal mixture or combination comprising (1) at last one phthalimide fungicide and (2) at least one succinate dehydrogenase inhibitor fungicide for protecting and prolonging the lifespan of medium to high resistance risk fungicides.

In some embodiments, the mixture comprises SDHI fungicide and phthalimide fungicide as the active ingredients.

The present invention provides a mixture or combination for controlling a disease caused by a pathogen on plant or soil, comprising (1) an amount of phthalimide fungicide and (2) an amount of succinate dehydrogenase inhibitor fungicide wherein the mixture is more effective than if each fungicide at the same amount is applied alone.

The present invention provides a mixture or combination for controlling a disease caused by a pathogen on plant or soil, comprising (1) phthalimide fungicide and (2) succinate dehydrogenase inhibitor fungicide wherein the mixture is more effective than if each fungicide at the same amount is applied alone.

The present invention provides a fungicidal mixture or combination for controlling a disease caused by a pathogen on plant or soil, comprising (1) at least one phthalimide fungicide and (2) at least one succinate dehydrogenase inhibitor fungicide wherein the mixture is more effective than if each fungicide at the same amount is applied alone.

As noted above, the compositions, kits and methods described herein exhibit a synergistic effect.

The present invention also provides use of an amount of phthalimide fungicide for increasing the efficacy of an amount of fungicide I selected from group consisting of succinate dehydrogenase inhibitor (SDHI) fungicides, demethylation inhibitor (DMI) fungicides, quinone outside inhibitor (QoI) fungicides, and any combination thereof compared to the efficacy of the same amount of fungicide I when applied without the amount of phthalimide fungicide.

The present invention also provides use of an amount of phthalimide fungicide for increasing the bioavailability of an amount of fungicide I selected from group consisting of succinate dehydrogenase inhibitor (SDHI) fungicides, demethylation inhibitor (DMI) fungicides, quinone outside inhibitor (QoI) fungicides, and any combination thereof compared to the bioavailability of the same amount of fungicide I when applied without the amount of phthalimide fungicide.

The present invention also provides use of an amount of phthalimide fungicide for increasing the penetration of an amount of fungicide I into a plant compared to the penetration of the same amount of fungicide I when applied without the amount of phthalimide fungicide, wherein fungicide I is selected from group consisting of succinate dehydrogenase inhibitor (SDHI) fungicides, demethylation inhibitor (DMI) fungicides, quinone outside inhibitor (QoI) fungicides, and any combination thereof.

The present invention also provides use of an amount of phthalimide fungicide for increasing the translocation of an amount of fungicide I in a plant compared to the translocation of the same amount of fungicide I when applied without the amount of phthalimide fungicide, wherein fungicide I is selected from group consisting of succinate dehydrogenase inhibitor (SDHI) fungicides, demethylation inhibitor (DMI) fungicides, quinone outside inhibitor (QoI) fungicides, and any combination thereof.

The present invention provides use of a phthalimide fungicide for increasing the bioavailability and biological efficacy of the fungicide I selected from group consisting of succinate dehydrogenase inhibitor (SDHI) fungicides, demethylation inhibitor (DMI) fungicides, quinone outside inhibitor (QoI) fungicides, and combination thereof for controlling plant disease caused by a pathogen.

The present invention also provides use of phthalimide fungicide for increasing the phytopathogenic diseases control by at least one fungicide I selected from group consisting of succinate dehydrogenase inhibitor (SDHI) fungicides, demethylation inhibitor (DMI) fungicides, quinone outside inhibitor (QoI) fungicides, and combination thereof.

In some embodiments, the efficacy of fungicide I, selected from the group consisting of succinate dehydrogenase inhibitor (SDHI) fungicides, demethylation inhibitor (DMI) fungicides, quinone outside inhibitor (QoI) fungicides, and combination thereof, when applied in the presence of phthalimide fungicide is improved compared to when fungicide I at the same amount is applied alone.

The present invention provides a combination, mixture or composition for controlling plant disease caused by pathogen comprising an amount of phthalimide fungicide and an amount of fungicide I, wherein the bioavailability of fungicide I is increased.

In some embodiments, the present invention does not include the inventions disclosed in the PCT/IL2019/051432.

In some embodiments, the present invention does not include the inventions disclosed in the WO 2019/244084.

In some embodiments, the present invention does not include the inventions disclosed in the WO 2015/103262.

In some embodiments, the present invention does not include the inventions disclosed in the WO 2012/025912.

The present invention provides a use of fungicidal mixture or combination comprising (a) at least one phthalimide fungicide selected from the group consisting of captan, folpet, captafol and any combination thereof and (b) 5-fluoro-4-imino-3-methyl-1-tosyl-3,4-dihydropyrimidin-2(1H)-one for controlling fungal disease in barley.

The present invention provides a use of fungicidal mixture or combination comprising (a) at least one phthalimide fungicide selected from the group consisting of captan, folpet, captafol and any combination thereof and (b) 5-fluoro-4-imino-3-methyl-1-tosyl-3,4-dihydropyrimidin-2(1H)-one for controlling Ramularia leaf spot in barley.

The present invention provides a fungicidal mixture or combination for controlling fungal disease in barley comprising (a) at least one phthalimide fungicide selected from the group consisting of captan, folpet, captafol and any combination thereof and (b) 5-fluoro-4-imino-3-methyl-1-tosyl-3,4-dihydropyrimidin-2(1H)-one.

The present invention provides a fungicidal mixture or combination for controlling Ramularia leaf spot in barley comprising (a) at least one phthalimide fungicide selected from the group consisting of captan, folpet, captafol and any combination thereof and (b) 5-fluoro-4-imino-3-methyl-1-tosyl-3,4-dihydropyrimidin-2(1H)-one.

The present invention provides a use of fungicidal mixture or combination comprising (a) at least one phthalimide fungicide selected from the group consisting of captan, folpet, captafol and any combination thereof and (b) 5-fluoro-4-imino-3-methyl-1-tosyl-3,4-dihydropyrimidin-2(1H)-one for controlling Plasmopara viticola in grapevine.

The present invention provides a fungicidal mixture or combination for controlling Plasmopara viticola in grapevine comprising (a) at least one phthalimide fungicide selected from the group consisting of captan, folpet, captafol and any combination thereof and (b) 5-fluoro-4-imino-3-methyl-1-tosyl-3,4-dihydropyrimidin-2(1H)-one.

The present invention provides a use of a fungicidal mixture or combination comprising (1) an amount of phthalimide fungicide and (2) an amount of amine fungicide for controlling disease in sugar beet.

The present invention provides a fungicidal mixture or combination for controlling disease in sugar beet, comprising (1) an amount of phthalimide fungicide and (2) an amount of amine fungicide.

The present invention provides a use of a fungicidal mixture or combination comprising (1) phthalimide fungicide and (2) amine fungicide for controlling fungal disease in sugar beet.

The present invention provides a mixture or combination for controlling Cercospora beticola in sugar beet, comprising (1) phthalimide fungicide and (2) amine fungicide.

Each embodiment disclosed herein is contemplated as being applicable to each of the other disclosed embodiments. Thus, all combinations of the various elements described herein are within the scope of the invention. In addition, the elements recited in the composition embodiments can be used in the combination, mixture (including synergistic mixture), package, method and use embodiments described herein and vice versa. In addition, the elements recited in the combination embodiments can be used in the composition, kit, method and use embodiments described herein and vice versa.

The present invention is illustrated and further described in more detail with reference to the following non-limiting examples. The following examples illustrate the practice of the present subject matter in some of its embodiments but should not be construed as limiting the scope of the present subject matter. Other embodiments will be apparent to one skilled in the art from consideration of the specification and examples. It is intended that the specification, including the examples, is considered exemplary only without limiting the scope and spirit of the present subject matter.

In some embodiments, the present invention provides a method of treating a plant or locus against fungal infection comprising applying a combination of an amount of a phthalimide fungicide and an amount of a primary fungicide to the plant or locus so as to thereby treat the plant or locus against fungal infection, wherein: (i) the method is more effective against fungal infection than when the amount of the phthalimide fungicide and the amount of a primary fungicide are applied alone, and/or (ii) the amount of the phthalimide fungicide improves the fungicidal efficacy of the amount of the primary fungicide compared to when the same amount of the primary fungicide is applied not in combination with the amount of the phthalimide fungicide.

In some embodiments, the present invention provides an improved combination comprising an amount of a primary fungicide and an amount of a phthalimide fungicide.

In some embodiments, the present invention provides a composition comprising a phthalimide fungicide, a primary fungicide and at least one agriculturally acceptable carrier.

In some embodiments, the present invention provides a process of preparing a composition comprising a phthalimide fungicide and a primary fungicide, wherein the process comprises the steps of: (i) obtaining an amount of the phthalimide fungicide(s) and an amount of the primary fungicide(s), and (ii) mixing the obtained amount of phthalimide fungicide(s) and the obtained amount of the primary fungicide(s) to obtain the composition.

In some embodiments, the present invention provides a method of increasing sensitivity of a fungus to an amount of a primary fungicide comprising applying a combination of an amount of a phthalimide fungicide and the amount of the primary fungicide to the fungus, so as to thereby increase sensitivity of the fungus to the amount of the primary fungicide.

In some embodiments, the present invention provides a method of increasing bioavailability of an amount of a primary fungicide to a plant comprising applying a combination of an amount of a phthalimide fungicide and the amount of the primary fungicide to the plant, so as to thereby increase bioavailability of the amount of the primary fungicide.

In some embodiments, the present invention provides a method of inhibiting fungal mycelium formation comprising applying a combination of an amount of a phthalimide fungicide and an amount of a primary fungicide to the fungus, so as to thereby inhibit fungal mycelium formation.

In some embodiments, the present invention provides a method of prolonging the period of protection against fungal infection and/or control of fungal infection from an application of an amount of a primary fungicide to a plant or locus comprising applying a combination of an amount of a phthalimide fungicide and the amount of the primary fungicide to the plant or locus. In some embodiments, the plant is a crop plant.

In some embodiments, the present invention provides a method of reducing the amount of time needed to achieve a level of fungal control from an application of an amount of primary fungicide to a plant or locus comprising applying a combination of an amount of a phthalimide fungicide and the amount of the primary fungicide to the plant or locus.

In some embodiments, the present invention provides a method of improving development of a plant affected by fungal infection comprising applying a combination of a phthalimide fungicide and a primary fungicide to the plant or a locus thereof so as to improve the development of the plant compared to the development of a plant affected by the same type and degree of fungal infection to which the combination is not applied.

### Experiments

### Biological Examples

In the field of agriculture, it is often understood that the term “synergy” is as defined by (1) Colby S. R. in an article entitled “Calculation of the synergistic and antagonistic responses of herbicide combinations” published in the journal Weeds, 1967, 15, p. 20-22, and (2) Wadley (Ulrich Gisi, Phytopathology, 86, 1996, 1273-1279)

Under the Colby approach, a synergistic effect is present if the action of the combination of active ingredients exceeds the total of the actions of the individual components. The expected action E for a given combination of active ingredients can be described by the so-called COLBY formula and can be calculated as follows (COLBY, S. R. “Calculating synergistic and antagonistic responses of herbicide combination”. Weeds, Vol. 15, pages 20-22; 1967).
ppm=milligrams of active ingredient (=a.i.) per litre of spray mixture
X=% action caused by active ingredient I at a rate of application of p ppm of active ingredient
Y=% action caused by active ingredient II at a rate of q ppm of active ingredient
E=expected action of active ingredients I+II at a rate of application of p+q ppm of active ingredient (additive action),

$$X - Y then {Colby}^{′} s formula reads E = X + Y - 100$$

If the actually observed action (O) exceeds the expected action (E), the action of the combination is superadditive, i.e. there is a synergistic effect. O E=factory of synergism (FS).

The action expected for a given combination of two active components can be calculated as follows:

$$E = X + Y - \frac{X Y}{100}$$

The action expected for a given combination of three active components can be calculated as follows:

$$E = X + Y + Z - \frac{X Y + X Z + Y Z}{100} + \frac{X Y Z}{10000}$$

in which E represents the expected effect, e.g. percentage of pest control, for the combination of the three active ingredient at defined doses (for example equal to x, y and z respectively), X is the effect, e.g. percentage of pest control, observed for compound (I) at a defined dose (equal to x), Y is the effect, e.g. percentage of pest control, observed for compound (II) at a defined dose (equal to y), Z is the effect, e.g. percentage of pest control, observed for compound (III) at a defined dose (equal to z). When the effect, e.g. percentage of pest control, observed for the combination is greater than the expected effect, there is a synergistic effect. The ratio of observed action (E_{obs}) and expected action (Eₑₓₚ), i.e. E_{obs}/Eₑₓₚ expresses the factor of interaction level (R) which may be interpreted in accordance with Table 1a below.

TABLE 1a
Colby interaction level

| | |
|---|---|
| R > 1 | Synergy |
| R = 1 | Additivity |
| R < 1 | Antagonism |

A synergistic effect may also be shown by using the Wadley method. The Wadley formula predicts the expected effective concentration (ECtheoretical) at different control levels (50% or 90%).

In the Wadley method, synergistic activity is determined from dose response curves. With this method, the efficacy of the active ingredient (“a.i.”) is determined by comparing the degree of fungal attack on treated plants with that on untreated, similarly inoculated and incubated check plants. Each a.i. is generally tested at multiple. (e.g. 6) concentrations, and dose response curves are generated. The dose response curves are used to establish the EC50 (i.e. the effective concentration of a.i. providing 50% disease control) of the individual compounds as well as of the combinations (EC50Observed). The experimental values of the mixture at a given weight ratio are compared with the values that would have been found where only a complementary efficacy of the components is present as follows:

$$E {C}_{t h e o} = ( a + b ) / [ ( a / {EC}_{A} ) + ( b / {EC}_{B} ) ]$$

A and B=the single products which are tested
a and b=the ratio of each product in the mixture
EC_{A} and EC_{B}=observed effective concentration of the single products A and B at different control levels (50 or 90%)

$$R = E {C}_{t h e o} / {EC}_{observed}$$

For three-way mixture:

$${EC}_{theo} = ( a + b + c ) / [ ( a / {EC}_{A} ) + ( b / {EC}_{B} + ( c / {EC}_{C} ) ]$$

a, b and c=the ratio of each product in the mixture
EC_{A}, EC_{B} and EC_{C}=observed effective concentration of the single products A B and C at different control levels (50 or 90%).

The ratio EC50(A+B)_{Theo}/EC50(A+B)_{observed} expresses the factor of interaction level (R) which may be interpreted in accordance with Table 1b below.

TABLE 1b
Wadley interaction level

| | |
|---|---|
| R > 1.5 | Synergy |
| 0.5 < R < 1.5 | Additivity |
| R < 0.5 | Antagonism |

The Colby approach allows determination of the type of fungicide mixtures interaction at one dose. It is adapted for field and laboratory studies and gives the a.i. interaction at the evaluated dose. The Colby approach is dose dependent.

The Wadley approach evaluates the type of fungicide mixtures interaction within a range of concentrations. It is more adapted for laboratory studies and permits to evaluate the intrinsic a.i. interaction. The Wadley approach is dose independent.

### Example 1

Two experiments were conducted in protected conditions to evaluate the fungicidal activity of the mixture comprising a pyrimidinone fungicide (ADF-16), and a phthalimide (folpet), toward Ramularia (Ramularia collo-cygni) in barley.

The experiments were conducted by applying formula I and folpet (Folpan 80 WG) alone or together. The compound for formula I (ADF-16) is 5-fluoro-4-imino-3-methyl-1-tosyl-3,4-dihydropyrimidin-2(1H)-one. The compound of formula I is also known as ADF-16. The formulation used in this experiment is ADF-16 250 OD. The 250 OD composition of the compound of formula I (i.e. ADF-16), as described in U.S. Provisional Application No. 63/024,031, is provided in Table 2 below:

TABLE 2
250 OD composition of the compound of formula I

| Ingredient | % w/w |
|---|---|
| 5-fluoro-4-imino-3-methyl-1-tosyl-3,4- | 25.00 |
| dihydropyrimidin-2(1H)-one | |
| Agrimer ™ AL-22 | 3.00 |
| Atlox 4916 | 3.00 |
| Aerosol OT-SE | 6.00 |
| Synperonic PE/L 64 | 6.00 |
| Genapol X 050 | 3.00 |
| TEOS | 5.00 |
| Aerosil R202 | 2.60 |
| Agnique ME 18 RD-F | 46.40 |

The compositions were diluted with water.

The following fungicides and combination of fungicides are applied to ramularia in barley. The observation was made 10 days after application. The results are shown below:

TABLE 3

| | | Observed | Expected | |
|---|---|---|---|---|
| | Rate | Efficacy | Efficacy | Synergism |
| Treatment | (g a.i./ha) | (%) | (%) | Factor ^{α□} |
| Folpet | 175 | 25.10 | — | — |
| | 300 | 61.10 | | |
| | 400 | 64.80 | — | — |
| ADF-16 | 25 | 45.70 | — | — |
| | 35 | 55.00 | — | — |
| Folpet + | 175 + 35 | 84.60 | 66.30 | 1.28 |
| ADF-16 | 300 + 25 | 82.60 | 78.88 | 1.05 |
| | 300 + 35 | 89.10 | 82.50 | 1.08 |
| | 400 + 25 | 88.50 | 80.89 | 1.09 |
| | 400 + 35 | 90.50 | 84.16 | 1.08 |

^{α} Synergism Factor = Observed efficacy/ Expected Efficacy

The following fungicides and combination of fungicides are applied to ramularia in barley. The observation was made 24 days after application. The results are shown below:

TABLE 4

| | | Observed | Expected | |
|---|---|---|---|---|
| | Rate | Efficacy | Efficacy | Synergism |
| Treatment | (g a.i./ha) | (%) | (%) | Factor ^{α} |
| Folpet | 175 | 21.60 | — | — |
| | 300 | 31.00 | | |
| | 400 | 49.80 | — | — |
| ADF-16 | 25 | 44.50 | — | — |
| | 35 | 45.60 | — | — |
| Folpet + | 175 + 35 | 73.90 | 57.35 | 1.29 |
| ADF-16 | 300 + 25 | 75.90 | 61.71 | 1.23 |
| | 300 + 35 | 79.30 | 62.46 | 1.27 |
| | 400 + 25 | 80.60 | 72.14 | 1.12 |
| | 400 + 35 | 81.30 | 72.69 | 1.12 |

^{α} Synergism Factor = Observed efficacy/ Expected Efficacy

### Example 2

The following fungicides and combination of fungicides are applied to Downy mildew in grapes. The experiment was conducted to evaluate the fungicidal activity of the mixture comprising a pyrimidinone fungicide (Formula I/ADF-16), and a phthalimide (folpet), alone or together.

The compound for Formula I is 5-fluoro-4-imino-3-methyl-1-tosyl-3,4-dihydropyrimidin-2(1H)-one. The compound of formula I is also known as ADF-16. The formulation used in this experiment is ADF-16 500 SC. The 500 SC composition of the compound of formula I (i.e. ADF-16), as described in U.S. Provisional Application No. 63/024,031. is provided in Table 5 below.

TABLE 5
500 SC composition of the compound of formula I (i.e. ADM 00050 F 1 A)

| Ingredient | CAS No. | Chemical Name | % w/w |
|---|---|---|---|
| compound of | N/A | | 41.66666667 |
| Formula I | | | |
| (ADF-16) | | | |
| AG-RH 23 | 11138-66-2 | Xanthan Gum | 0.191666667 |
| Disodium | 7558-79-4 | Disodium Phosphate | 0.583333333 |
| Phosphate | | Anhydrous | |
| Anhydrous | | | |
| Emulsogen | 104376-75-2 | Tristyryl phenol-polyethylene | 1.416666667 |
| TS 540 | | glycol ether | |
| Potassium | 7778-77-0 | Potassium dihydrogene | 0.141666667 |
| dihydrogene | | phosphate | |
| phosphate | | | |
| Propylene | 57-55-6 | 1,2 propanediol | 1.958333333 |
| glycol | | | |
| Proxel GXL | (A)2634-33-5, | (A)1,2-Benzisothiazol-3(2H)- | 1.67E−02 |
| | (B)1310-73-2 | one, (B)Sodium hydroxide | |
| SAG 1572 | N/A | Polydimethylsiloxane emulsion | 1.5 |
| Silwet L-77 | (A)27306-78-1, | (A)Polyalkyleneoxide modified | 0.2 |
| | (B)67674-67-3 | Heptamethyltrisiloxane, | |
| | | (B)Polyalkyleneoxide Modified | |
| | | Heptamethyltrisiloxane | |
| Soprophor | (A) 90093-37-1, | (A) 2,4,6-Tris(1- | 3.75 |
| 3 D 33 | (B)99734-09-5, | phenylethyl)polyoxyethylenated | |
| | (C)7664-38-2 | phosphates, | |
| | | (B)Poly(oxy-1,2- | |
| | | ethanediyl),.alpha.-[tris(1- | |
| | | phenylethyl)phenyl]-.omega.- | |
| | | hydroxy-, | |
| | | (C)orthophosphoric acid | |
| | | (POLYARYLPHENYL | |
| | | ETHER PHOSPHATE)” | |
| Supragil WP | N/A | Reaction product of | 0.5 |
| | | naphthalene, propan-2-ol, | |
| | | sulfonated and neutralized by | |
| | | caustic soda | |
| water soft | 7732-18-5 | water | 48.575 |

The compositions were diluted with water.

The results are showing below:

TABLE 6

| | INCIDENCE | | |
|---|---|---|---|
| | Fungicide | | |
| | Efficacy | | Evaluation |
| | calculated by | Colby's | of Colby's |
| Treatment | Abbott's formula | Equation | Equation |
| UNTREATED CHECK | 0 | | |
| ADF-16 500 SC | 55.3 | | |
| @ 50 g AI/ha | | | |
| ADF-16 500 SC | 56 | | |
| @75 g AI/ha | | | |
| FOLPAN 80 WDG | 19.6 | | |
| @ 400 g AI/ha | | | |
| FOLPAN 80 WDG | 34.7 | | |
| @ 600 g AI/ha | | | |
| ADF-16 500 SC | 91 | 64.1 | 1.4 |
| @ 50 g AI/ha + | | | |
| FOLPAN 80 WDG | | | |
| @ 400 g AI/ha | | | |
| ADF-16 500 SC | 93 | 64.6 | 1.4 |
| @ 75 g AI/ha + | | | |
| FOLPAN 80 WDG | | | |
| @ 400 g AI/ha | | | |
| ADF-16 500 SC | 89.2 | 70.8 | 1.3 |
| @ 50 g AI/ha + | | | |
| FOLPAN 80 WDG | | | |
| @ 600 g AI/ha | | | |
| ADF-16 500 SC | 94.5 | 71.3 | 1.3 |
| @ 75 g AI/ha + | | | |
| FOLPAN 80 WDG | | | |
| @ 600 g AI/ha | | | |

Level of Interaction R showed synergistic effect when folpet is applied in mixture with ADF-16 for the control of downy mildew in grape.

### Example 3

An experiment was conducted in field conditions to evaluate the fungicidal activity of the mixture comprising a pyrimidinone fungicide (ADF-16), and a phthalimide (folpet), toward Spilocaea oleagina in olive.

The experiment was conducted by applying ADF-16 and folpet (MCW-296 WG) alone or together. The compound for formula I is 5-fluoro-4-imino-3-methyl-1-tosyl-3,4-dihydropyrimidin-2(1H)-one. The compound of formula I is also known as ADF-16. The formulation used in this experiment is ADF-16 500 SC identified by the code ADM.00050.F.1.A. The 500 SC composition of the compound of formula I (i.e. ADF-16), is described in U.S. Provisional Application No. 63/024,031.

The compositions were diluted with water.

Application is performed with backpack sprayer. The tested doses used are resumed in the following table:

TABLE 7
Evaluate the Efficacy on conidia germination
of olive peacock spot (Spilocea oleagina).

| | | |
|---|---|---|
| Treatment | Product Rate | AI Rate |

| | |
|---|---|
| Inoculated check | N/A |

| | | | | |
|---|---|---|---|---|
| ADM.00050. F.1.A | 10 | ml/hL | 5.0 | g AI/hL |
| ADM.00050. F.1.A | 20 | ml/hL | 10.0 | g AI/hL |
| MCW-296 WG | 12 | g/hL | 9.6 | g AI/hL |

| | | |
|---|---|---|
| MCW-296 WG + | 12 g/hL + | 9.6 g AI/hL + |
| ADM.00050. F.1.A | 10 ml/hL | 5.0 g AI/hL |
| MCW-296 WG + | 12 g/hL + | 9.6 g AI/hL + |
| ADM.00050. F.1.A | 20 ml/hL | 10 g AI/hL |

TABLE 8

| | | Formulation | Active | | |
|---|---|---|---|---|---|
| Treatment | Brand Name | Type | Ingredient | AI | Conc. |
| ADM.00050. | ADM.00050. | SC | ADF-16 | 500 | 50% |
| F.1.A | F.1.A | | 502, 4 g/L | | |
| MCW-296 | FOLPAN 80 | WG | Folpet | 800 | 80% |
| WG | WG | | | | |

Olive leaves with natural Spilocaea oleagina infestation were collected in field and taken to the laboratory. Subsequently, they were cut and washed in sterile water to obtain an aqueous solution with high concentrations of conidia. By using a hematocytometer, the conidia were quantified and the concentration per ml was calculated. In 9 cm diameter Petri dishes, 5-10 ml of 2% Agar-Water was added. Once cold and solidified, coverslips were placed on solidified medium. Two drops of product and conidia solution were deposited on coverslip, 3 replicates per dose were done. The plates were sealed with paraffin and kept at 15-20° C. in the dark. One assessment at 5 days after incubation was done.

Germinated conidia were recorded per replicate, a total of 100 conidia per replicate were counted.

Analysis of Variance (ANOVA) and a Bartlett test to assume the homogeneity of the treatment variances were performed on each assessment. Data were analyzed using ANOVA. A multiple comparison test (detailed in the specific result tables) with a confidence level of 95% was applied to separate any significant treatment. Non-germinated conidia percentage was transformed in efficacy percentage values using the Abbott's transformation.

The highest germination percentages were observed in Inoculated Check (73.00%), with values significantly higher than observed in all tested treatments. ADM.00050.F.1.A showed efficacy lower and significantly different in comparison with the mix ADM.00050.F.1.A+MCW-296 WG.

TABLE 9

| | | | | Efficacy % |
|---|---|---|---|---|
| | | | Germiantion | (Abbott's |
| Treatment | Product Rate | | % | Transfomration) |
| Inoculated check | N/A | | 73 (A) | |
| ADM.00050. F.1.A | 10 | ml/hL | 34.00 (C) | 53.43 (F) |
| ADM.00050. F.1.A | 20 | ml/hL | 25.67 (E) | 64.82 (D) |
| MCW-296 WG | 12 | g/hL | 17.67 (C) | 74.88 (D) |

| | | | |
|---|---|---|---|
| MCW-296 WG + | 12 g/hL + | 0.67 (H) | 99.07 (A) |
| ADM.00050. F.1.A | 10 ml/hL | | |
| MCW-296 WG + | 12 g/hL + | 0.33 (H) | 99.56 (A) |
| ADM.00050. F.1.A | 20 ml/hL | | |

TABLE 10

| | AI Rate | | Conidia | | Evaluation |
|---|---|---|---|---|---|
| | (g AI/hL) | | inhibition | Expected | of Colby's |
| Treatment | Folpet | ADF-16 | % | COLBY | Equation |
| ADM.00050. | | 5 | 53.4 | | |
| F.1.A | | | | | |
| ADM.00050. | | 10 | 64.8 | | |
| F.1.A | | | | | |
| MCW-296 | 9.6 | | 74.9 | | |
| WG | | | | | |
| MCW-296 | 9.6 | 5 | 99.07 | 88.3 | 1.12 |
| WG + | | | | | |
| ADM.00050. | | | | | |
| F.1.A | | | | | |
| MCW-296 | 9.6 | 10 | 99.56 | 91.2 | 1.09 |
| WG + | | | | | |
| ADM.00050. | | | | | |
| F.1.A | | | | | |

### Example 4

An experiment is conducted to evaluate the fungicidal control of downy mildew (Plasmopara viticola) on grape with a Phenylpyridinamine (fluazinam) and a phthalimide (folpet), alone and in binary mixtures.

The experiment is conducted by applying compositions of fluazinam and folpet alone or together. The compositions are diluted in water.

TABLE 11
treatment list

| Treatment | AI Rate (gAI/ha) | |
|---|---|---|
| Untreated check | | |
| Fluazinam | 350 | g AI/ha |
| Folpet | 500 | g AI/ha |
| Fluazinam + Folpet | 300 + 500 | g AI/ha |

To test for fungicidal control of downy mildew, the grape plants are sprayed with each of the above treatments. Each of the above treatments are applied from 4 to 10 times according to the disease development, applications occurring 7-14 days after the previous treatment. The treatments are composed of 4 replicates.

Evaluations are performed for the whole duration of the experiment. At each time the incidence and the severity of downy mildew on plants parts is determined.

Results show that the mixtures bring an added value in grape compared to the use of each fungicide alone.

### Example 5

An experiment is conducted to evaluate the fungicidal control of late blight (Phytophthora infestans) on potato with a OSBPI fungicide (fluoxapiprolin) and a phthalimide (folpet), alone and in binary mixtures.

The experiment is conducted by applying compositions of fluoxapiprolin and folpet alone or together. The compositions are diluted in water.

TABLE 13
treatment list

| Treatment | AI Rate (gAI/ha) | |
|---|---|---|
| Untreated check | | |
| Fluoxapiprolin | 20 | g AI/ha |
| Folpet | 500 | g AI/ha |
| Fluoxapiprolin + Folpet | 20 + 500 | g AI/ha |

To test for fungicidal control of late blight, the potato plants are sprayed with each of the above treatments. Each of the above treatments are applied from 4 to 10 times according to the disease development, applications occurring 7-14 days after the previous treatment. The treatments are composed of 4 replicates.

Evaluations are performed for the whole duration of the experiment. At each time the incidence and the severity of late blight on plants parts is determined.

Results show that the mixtures bring an added value in potato compared to the use of each fungicide alone.

### Example 6

An experiment is conducted to evaluate the fungicidal control of Septoria Tritici Blotch (STB) (Zymoseptoria tritici) on wheat with a QoI (metyltetraprole) and a phthalimide (folpet), alone and in binary mixtures.

The experiment is conducted by applying compositions of metyltetraprole and folpet alone or together. The compositions are diluted in water.

TABLE 13
treatment list

| Treatment | AI Rate (gAI/ha) | |
|---|---|---|
| Untreated check | | |
| Metyltetraprole | 100 | g AI/ha |
| Folpet | 500 | g AI/ha |
| Metyltetraprole + Folpet | 100 + 500 | g AI/ha |

To test for fungicidal control of STB, the wheat plants are sprayed with each of the above treatments. Each of the above treatments are applied from 1 to 2 times according to the disease development. The treatments are composed of 4 replicates.

Evaluations are performed for the whole duration of the experiment. At each time the incidence and the severity of STB on plants parts is determined.

Results show that the mixtures bring an added value in wheat compared to the use of each fungicide alone.

### Example 7

An experiment is conducted to evaluate the fungicidal control of soybean rust (Phakopsora pachyrhizi) on soybean with a DMI (mefentrifluconazole), a QoI (picoxystrobin) and a phthalimide (folpet), alone, in binary and ternary mixtures.

The experiment is conducted by applying compositions of mefentrifluconazole, picoxystrobin and folpet alone or together. The compositions are diluted in water.

TABLE 16
treatment list

| Treatment | AI Rate (gAI/ha) | |
|---|---|---|
| Untreated check | | |
| Mefentrifluconazole | 100 | g AI/ha |
| Picoxystrobin | 100 | g AI/ha |
| Folpet | 700 | g AI/ha |
| Mefentrifluconazole + Folpet | 100 + 700 | g AI/ha |
| Picoxystrobin + Folpet | 100 + 700 | g AI/ha |
| Mefentrifluconazole + | 100 + 100 + 700 | g AI/ha |
| Picoxystrobin + Folpet | | |

To test for fungicidal control of soybean rust, the soybean plants are sprayed with each of the above treatments. Each of the above treatments are applied from 1 to 3 times according to the disease development. The treatments are composed of 4 replicates.

Evaluations are performed for the whole duration of the experiment. At each time the incidence and the severity of soybean rust on plants parts is determined.

Results show that the mixtures bring an added value in soybean compared to the use of each fungicide alone.

### Example 8

An experiment was carried out in a glasshouse to evaluate the selectivity on Winter wheat, Antonello variety, and the fungicidal efficacy against Septoria Tritici Blotch (STB) (Zymoseptoria tritici) of FOLPET 500 SC at 1 L/ha and REVYSOL (Mefentrifluconazole) applied at 1.33 L/ha, and the extemporary mixture of REVYSOL at 1.33 L/ha and FOLPET 500 SC at 1 L/ha, as reported in Table 14.

TABLE 17
treatment list

| Treatment | AI Rate (gAI/ha) | |
|---|---|---|
| Untreated check | | |
| Mefentrifluconazole | 100 | g AI/ha |
| Folpet | 500 | g AI/ha |
| Mefentrifluconazole + Folpet | 100 + 500 | g AI/ha |

The study design was a randomized complete block with 4 replicates.

The treatments were applied in accordance with Table 14, and on the day after application, artificial inoculation of the target was performed by spraying the inoculum solution at the concentration of 1×106 cfu/ml on the leaves. The compositions were diluted in a water volume equivalent to 400 L/ha.

The first symptoms were observed 14 days after the application, at this date 12.3% of affected leaves and 2.6% of affected leaf area was recorded on the untreated check.

At the assessment performed at 28 days after the application, the extemporary mixture of FOLPET and REVYSOL resulted significantly different from the untreated control and the better than the straight products both in terms of disease incidence and severity.

Analysis of Variance (ANOVA) and a Bartlett test to assume the homogeneity of the treatment variances were performed on each assessment. Data were analyzed using ANOVA. A multiple comparison test (detailed in the specific result tables) with a confidence level of 95% was applied to separate any significant treatment.

Evaluations were performed on incidence and severity of Septoria on leaves and transformed into percentage of disease control using the Abbott's transformation.

TABLE 18
treatment list

| | | | Disease control | | Evaluation |
|---|---|---|---|---|---|
| | AI Rate | | on severity on | Expected | of Colby's |
| Treatment | (gAI/ha) | | leaves (%) | COLBY | Equation |
| Mefentrifluconazole | 100 | g AI/ha | 49.9 | | |
| Folpet | 500 | g AI/ha | 41.6 | | |
| Mefentrifluconazole + Folpet | 100 + 500 | g AI/ha | 93 | 70.7 | 1.31 |

In presence of a high pressure of Z. tritici, all the test items showed a good control of the target with significantly lower disease pressure compared to the untreated control.

The extemporary mixture of REVYSOL and FOLPET 500 SC showed a synergistic effect in terms of fungicide efficacy compared to the products straight.

No phytotoxicity symptoms were observed during the trial period.

LENGTHY TABLES
The patent application contains a lengthy table section. A copy of the table is available in electronic form from the USPTO web site (https://seqdata.uspto.gov/?pageRequest=docDetail&DocID=US20250089720A1). An electronic copy of the table will also be available from the USPTO upon request and payment of the fee set forth in 37 CFR 1.19(b)(3).

1. A method of treating a plant or locus against fungal infection comprising applying a combination of an amount of a phthalimide fungicide and an amount of a primary fungicide selected from the group consisting of pyrimidinone fungicide, QiI quinoneinside inhibitors (QiI), quinone outside inhibitors (QoI), succinate dehydrogenase inhibitors (SDHI), demethylation inhibitor (DMI) fungicide, oxysterol binding protein inhibitor (OSBPI), amine fungicide, tetrazolyloxime fungicide, phenylpyridinamine fungicide, or inorganic fungicide to the plant or locus so as to thereby treat the plant or locus against fungal infection, wherein:
(i) the method is more effective against fungal infection than when the amount of the phthalimide fungicide and the amount of a primary fungicide are applied alone, and/or
(ii) the amount of the phthalimide fungicide improves the fungicidal efficacy of the amount of the primary fungicide compared to when the same amount of the primary fungicide is applied not in combination with the amount of the phthalimide fungicide.

2. The method of claim 1, wherein the phthalimide fungicide is captan, folpet, captafol, or any combination thereof.

3. The method of claim 1, wherein:
a) the amount of the phthalimide fungicide improves the fungicidal efficacy of the amount of the primary fungicide in a treated area of the plant and/or in an untreated area of the plant,
b) the amount of the phthalimide fungicide is effective to increase sensitivity of the fungus to the primary fungicide compared to the sensitivity of the fungus to the primary fungicide when it is applied not in combination with the amount of the phthalimide fungicide so as to thereby improve the fungicidal efficacy of the amount of the primary fungicide,
c) the amount of the phthalimide fungicide is effective to increase bioavailability of the amount of the primary fungicide compared to the bioavailability of the amount of the primary fungicide when it is applied not in combination with the amount of the phthalimide fungicide, preferably wherein increasing bioavailability comprises increasing penetration of the primary fungicide into the plant and/or increasing translation of the primary fungicide inside the plant so as to thereby improve the fungicidal efficacy of the amount of the primary fungicide,
d) the amount of the phthalimide fungicide applied is less than the fungicidally effective amount of the phthalimide fungicide when the phthalimide fungicide is applied alone,
e) the amount of the primary fungicide applied is less than the fungicidally effective amount of the primary fungicide when the primary fungicide is applied alone,
f) treating a plant or soil against fungal infection comprises:
a. inhibiting fungal mycelium formation,
b. combating phytopathogenic diseases on the plant or locus,
c. protecting the plant or locus from fungal attack,
d. preventing fungal infection of the plant or locus,
e. controlling fungal disease affecting the plant or locus,
f. controlling a fungal pathogen, a fungal pathogen group or a fungal pathogen class affecting the plant or locus, and/or
g. reducing fungal infection of the plant or locus, and/or
g) the method is effective for:
a. prolonging the period of protection against fungal infection and/or control of fungal infection compared to when the amount of the phthalimide fungicide and the amount of a primary fungicide are applied alone,
b. reducing the amount of time needed to achieve a level of fungal control compared to when the amount of the phthalimide fungicide and the amount of a primary fungicide are applied alone, and/or
c. improving plant development compared to the development of a plant affected by the same type and degree of fungal infection to which the combination is not applied, preferably wherein improving plant development comprises enhancing the root systems, enhancing shoot of the plant, enhancing plant vigor, enhancing greening effect on leaves and/or enhancing plant potential yield.

4. (canceled)

5. (canceled)

6. (canceled)

7. (canceled)

8. (canceled)

9. The method of claim 1, wherein:
a. the QiI (quinone inside inhibitors) is fenpicoxamid,
b. the QoI (quinone outside inhibitors) is selected from the group consisting of metyltetraprole, mandestrobin, and any combination thereof,
c. the SDHI (succinate dehydrogenase inhibitors) fungicide is selected from the group consisting of fluxapyroxad, fluopyram, pydiflumetofen, and any combination thereof,
d. the demethylation inhibitor fungicide (DMI fungicide) is mefentrifluconazole,
e. the demethylation inhibitor fungicide (DMI fungicide) is prothioconazole,
f. the OSBPI fungicide is fluoxapiprolin,
g. the amine fungicide is fenpropidin,
h. the phenylpyridinamine fungicide is fluazinam,
i. the tetrazolyloxime fungicide is picarbutrazox,
j. the inorganic fungicide is sulphur, and/or
k. the pyrimidinone fungicide is a fluoropyrimidinone fungicide, preferably 5-fluoro-4-imino-3-methyl-1-tosyl-3,4-dihydropyrimidin-2(1H)-one of the Formula I

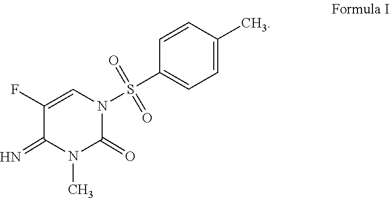 [SMILES: Cc1ccc(S(=O)(=O)n2cc(F)c(=N)n(C)c2=O)cc1]

10. The method of claim 1, wherein the phthalimide fungicide is folpet and the primary fungicide is Formula I.

11. (canceled)

12. The method of claim 1, wherein the combination comprises two primary fungicides and wherein:
a) the two primary fungicides are selected form the group consisting of fluoro-4-imino-3-methyl-1-tosyl-3,4-dihydropyrimidin-2(1H)-one of the Formula I, fenpicoxamid, fenpropidin, fluazinam, fluopyram, fluoxapiprolin, fluxapyroxad, mandestrobin, mefentrifluconazole, metyltetraprole, picarbutrazox, pydiflumetofen, prothioconazole and sulphur, and/or
b) the weight ratio between the total amount of the phthalimide fungicide(s) to the amount of the first primary fungicide to the amount of the second primary fungicide is between 1:1:1 and 1:100:1, between 1:1:1 and 100:1:1, between 1:1:1 and 1:1:100, between 1:1:1 and 1:100:100, between 1:1:1 and 100:100:1, or between 1:1:1 and 100:1:100.

13. The method of claim 1, wherein:
a. the weight ratio between the total amount of the phthalimide fungicide(s) to the total amount of the primary fungicide(s) is from 150:1 to 1:1 or from 100:1 to 1:100,
b. (i) the combination is applied at a rate from 0.1 g a.i./ha to 10000 g a.i./ha, (ii) the phthalimide fungicide(s) is applied at a rate between 10-400 g a.i./ha, and/or (iii) the primary fungicide(s) is applied at a rate of 100-2000 g a.i./ha, or
c. the phthalimide fungicide(s) and primary fungicide(s) are applied as seed treatment and the application rate is between 2 g per 100 kg to 400 g per 100 kg of seed.

14. (canceled)

15. (canceled)

16. (canceled)

17. (canceled)

18. The method of claim 1, wherein:
a. the plant is pulses, chili, olive, barley, cereals, pulses, grape, pome fruit, oilseed rape (OSR), cucurbits, rice, corn, banana, tomatoes, potatoes, cotton, soybean, coffee, or sugar beet,
b. the fungal pathogen is one or more of Colletotrichum sp. or Ascochyta rabiei on pulses, Colletotrichum truncatum on chili, Phakopsora pachyrhizi or Corynespora cassiicola on soybean, Mycosphaerella fijiensis or Pseudocercospora musae on banana, Puccinia recondite, Fusarium sp., Ramularia collo-cygni, ZymoSeptoria tritici, or Puccinia striiformis on cereals, Colletotrichum kahawae or Hemileia vastatrix on Coffee, Pseudoperonospora cubensis on cucurbits, Plasmopara viticola on grape, Alternaria sp. or Phytophthora infestans on tomatoes and potatoes, Cercospora zeae-maydis or Cochliobolus heterostrophus on corn, Cercospora beticola, Ramularia beticola or Uromyces betae on sugar beet, Setosphaeria turcica or Cochliobolus carbonum on corn, Ramularia areola on cotton, Pyricularia oryzae or Rhizoctonia solani/Thanatephorus cucumeris on rice, Venturia inaequalis on pome fruit, ramularia on barley, Spilocea oleagina on Olive or Sclerotinia sclerotiorum on OSR,
c. the fungal infection is Early blight, Anthracnose, Asian soybean Rust, Black sigatoka, Brown Rust, Coffee Berry Disease, Coffee Leaf Rust, Didymella pisi, Downy mildew, Fusarium head blight, Gray Leaf Spot, Late blight, leaf spot of beet, Northern Corn Leaf Blight, Northern Corn Leaf Spot, Ramularia leaf spot, Rice Blast, Rust, Scab, Sclerotinia, Septoria, Sheath Blight, Southern corn leaf blight, Target spot, Yellow Rust, olive peacock spot or Yellow sigatoka.

19. The method of claim 18, wherein:
a. the method is for controlling Plasmopara viticola in grape, wherein:
i. The ratio between folpet and Formula I is between 1:1 and 30:1 or 5.3:1 and 12:1, preferably 15:1 to 1:1 or 12:1 to 5.3:1, and/or
ii. folpet is applied at 7 gai/ha and Formula I is applied between 0.5 and 7 gai/ha, preferably folpet and Formula I are both applied at 7 gai/ha, or folpet is applied at 7 gai/ha and Formula I is applied at 0.5 gai/ha, or folpet is applied between 400 and 600 gai/ha and Formula I is applied between 50-75 gai/ha, preferably folpet is applied at 400 gai/ha and Formula I is applied at 50 gai/ha, or folpet is applied at 400 gai/ha and Formula I is applied at 75 gai/ha, or folpet is applied at 600 gai/ha and Formula I is applied at 50 gai/ha, or folpet is applied at 600 gai/ha and Formula I is applied at 75 gai/ha,
b. the method is for controlling ramularia in barley, wherein:
i. the ratio between folpet and Formula I is between 15:1 and 1:1, 12:1 and 5.3:1, or 5:1 and 16:1, preferably between 10:1 and 7.5:1, 7.5:1 and 6.7:1, or 6.7:1 and 5:1, and/or
ii. folpet is applied between 500 and 750 gai/ha and Formula is applied between 75 and 100 gai/ha, preferably wherein folpet is applied at 500 gai/ha and Formula I is applied at 75 gai/ha, or folpet is applied at 500 gai/ha and Formula I is applied at 100 gai/ha, or folpet is applied at 750 gai/ha and Formula I is applied at 100 gai/ha, or folpet is applied at 750 gai/ha and Formula I is applied at 75 gai/ha, or folpet is applied between 175 and 400 gai/ha and Formula is applied between 25-35 gai/ha, preferably wherein folpet is applied at 175 gai/ha and Formula I is applied at 35 gai/ha, or folpet is applied at 300 gai/ha and Formula I is applied at 25 gai/ha, or folpet is applied at 300 gai/ha and Formula I is applied at 35 gai/ha, or folpet is applied at 400 gai/ha and Formula I is applied at 25 gai/ha, or folpet is applied at 400 gai/ha and Formula I is applied at 35 gai/ha, or
c. the method is for controlling Spilocea oleagina on olive, wherein:
i. the ratio between folpet and Formula I is between 1.2:1 and 1:1, and/or
ii. folpet is applied at 12 g/hL and Formula I is applied at 10 ml/hL, or folpet is applied at 12 g/hL and Formula I is applied at 20 ml/hL.

20. The method of claim 1, wherein:
a. the method is for preventing or treating pulses against anathracnose caused by Colletotrichum sp., which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
b. the method is for preventing or treating chili against anathracnose caused by Colletotrichum truncatum, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
c. the method is for preventing or treating soybean against Asian soybean rust caused by Phakopsora pachyrhizi, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
d. the method is for preventing or treating banana against Black sigatoka caused by Mycosphaerella fijiensis, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
e. the method is for preventing or treating cereals against Brown rust caused by Mycosphaerella fijiensis, which comprises administering folpet and at least one of primary fungicide selected from group the consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
f. the method is for preventing or treating coffee against Coffee Berry Disease caused by Colletotrichum kahawae, which comprises administering folpet and at least one of primary fungicide selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 100:1 and 1:100,
g. the method is for preventing or treating coffee against Coffee Leaf Rust caused by Hemileia vastatrix, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
h. the method is for preventing or treating pulses against Didymella pisi caused by Ascochyta rabiei, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
i. the method is for preventing or treating cucurbits against Downy mildew caused by Pseudoperonospora cubensis, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
j. the method is for preventing or treating grape against Downy mildew caused by Plasmopara viticola, which comprises administering folpet and at least one of primary fungicide selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 100:1 and 1:100,
k. the method is for preventing or treating potato or tomato against Early blight caused by Plasmopara viticola, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
l. the method is for preventing or treating cereals against Fusarium head blight caused by Fusarium sp., which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
m. the method is for preventing or treating corn against Gray Leaf Spot caused by Cercospora zeae-maydis, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
n. the method is for preventing or treating potato or tomato against Late blight caused by Phytophthora infestans, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
o. the method is for preventing or treating sugar beet against leaf spot of beet caused by Cercospora beticola, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
p. the method is for preventing or treating corn against Northern Corn Leaf Blight caused by Setosphaeria turcica, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
q. the method is for preventing or treating corn against Northern Corn Leaf Blight caused by Cochliobolus carbonum, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
r. the method is for preventing or treating cereals against Ramularia leaf spot caused by Ramularia collo-cygni, which comprises administering folpet and at least one of primary fungicide selected from group of the consisting pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 100:1 and 1:100,
s. the method is for preventing or treating cotton against Ramularia leaf spot caused by Ramularia areola, which comprises administering folpet and at least one of primary fungicide selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 100:1 and 1:100,
t. the method is for preventing or treating sugar beet against Ramularia leaf spot caused by Ramularia beticola, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
u. the method is for preventing or treating rice against Rice Blast caused by Pyricularia oryzae, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
v. the method is for preventing or treating sugar beet against Ramularia leaf spot caused by Ramularia beticola, which comprises administering folpet and at least one of primary fungicide selected the from group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
w. the method is for preventing or treating rice against Rice Blast caused by Pyricularia oryzae, which comprises administering folpet and at least one of primary fungicide selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 100:1 and 1:100,
x. the method is for preventing or treating sugar beet against Rust caused by Uromyces betae, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
y. the method is for preventing or treating pome fruit against scab caused by Venturia inaequalis, which comprises administering folpet and at least one of primary fungicide selected from consisting the group of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 100:1 and 1:100,
z. the method is for preventing or treating sugar beet against OSR caused by Venturia inaequalis, which comprises administering folpet and at least one of primary fungicide selected from group the consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
aa. the method is for preventing or treating cereals against Septoria caused by Zymoseptoria tritici, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
bb. the method is for preventing or treating rice against Sheath Blight caused by Rhizoctonia solani or Thanatephorus cucumeris, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
cc. the method is for preventing or treating corn against Southern corn leaf blight caused by Cochliobolus heterostrophus, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
dd. the method is for preventing or treating soybean against Target spot caused by Corynespora cassiicola, which comprises administering folpet and at least one of primary fungicide selected from group the consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
ee. the method is for preventing or treating cereals against Yellow rust caused by Puccinia striiformis, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100, or
ff. the method is for preventing or treating banana against Yellow sigatoka caused by Pseudocercospora musae, which comprises administering folpet and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100.

21. The method of claim 1, wherein:
a. the method is for preventing or treating pulses against anathracnose caused by Colletotrichum sp., which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
b. the method is for preventing or treating chili against anathracnose caused by Colletotrichum truncatum, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
c. the method is for preventing or treating soybean against Asian soybean rust caused by Phakopsora pachyrhizi, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
d. the method is for preventing or treating banana against Black sigatoka caused by Mycosphaerella fijiensis, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
e. the method is for preventing or treating cereals against Brown rust caused by Mycosphaerella fijiensis, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
f. the method is for preventing or treating coffee against Coffee Berry Disease caused by Colletotrichum kahawae, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
g. the method is for preventing or treating coffee against Coffee Leaf Rust caused by Hemileia vastatrix, which comprises administering captan and at least one of primary fungicide selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 100:1 and 1:100,
h. the method is for preventing or treating pulses against Didymella pisi caused by Ascochyta rabiei, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
i. the method is for preventing or treating cucurbits against Downy mildew caused by Pseudoperonospora cubensis, which comprises administering captan and at least one of primary fungicide selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 100:1 and 1:100,
j. the method is for preventing or treating grape against Downy mildew caused by Plasmopara viticola, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
k. the method is for preventing or treating potato or tomato against Early blight caused by Plasmopara viticola, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
l. the method is for preventing or treating cereals against Fusarium head blight caused by Fusarium sp., which comprises administering captan and at least one of primary fungicide selected the from group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
m. the method is for preventing or treating corn against Gray Leaf Spot caused by Cercospora zeae-maydis, which comprises administering captan and at least one of primary fungicide selected from consisting the group of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 100:1 and 1:100,
n. the method is for preventing or treating potato or tomato against Late blight caused by Phytophthora infestans, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
o. the method is for preventing or treating sugar beet against leaf spot of beet caused by Cercospora beticola, which comprises administering captan and at least one of primary fungicide selected from the consisting group of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
p. the method is for preventing or treating corn against Northern Corn Leaf Blight caused by Setosphaeria turcica, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
q. the method is for preventing or treating corn against Northern Corn Leaf Blight caused by Cochliobolus carbonum, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
r. the method is for preventing or treating cereals against Ramularia leaf spot caused by Ramularia collo-cygni, which comprises administering captan and at least one of primary fungicide selected group from the consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
s. the method is for preventing or treating cotton against Ramularia leaf spot caused by Ramularia areola, which comprises administering captan and at least one of primary fungicide selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 100:1 and 1:100,
t. the method is for preventing or treating sugar beet against Ramularia leaf spot caused by Ramularia beticola, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
u. the method is for preventing or treating rice against Rice Blast caused by Pyricularia oryzae, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
v. the method is for preventing or treating sugar beet against Ramularia leaf spot caused by Ramularia beticola, which comprises administering captan and at least one of primary fungicide selected from the of group consisting pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100,
w. the method is for preventing or treating rice against Rice Blast caused by Pyricularia oryzae, which comprises administering captan and at least one of primary fungicide selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 100:1 and 1:100,
x. the method is for preventing or treating sugar beet against Rust caused by Uromyces betae, which comprises administering captan and at least one of primary fungicide selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 100:1 and 1:100,
y. the method is for preventing or treating pome fruit against scab caused by Venturia inaequalis, which comprises administering captan and at least one of primary fungicide selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 100:1 and 1:100,
z. the method is for preventing or treating sugar beet against OSR caused by Venturia inaequalis, which comprises administering captan and at least one of primary fungicide selected from: the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 100:1 and 1:100, or
aa. the method is for preventing or treating cereals against Septoria caused by Zymoseptoria tritici, which comprises administering captan and at least one of primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 100:1 and 1:100.

22. The method of claim 1, wherein:
a. the method is for preventing or treating pulses against anathracnose caused by Colletotrichum sp., which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at at a ratio between 1:1:1 to 1:100:1; or to 100:1:1; or to 1:1:100; or to 1:100:100; or to 100:100:1; or to 100:1:100,
b. the method is for preventing or treating chili against anathracnose caused by Colletotrichum truncatum, which comprises administering folpet and two primary fungicides selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
c. the method is for preventing or treating soybean against Asian soybean rust caused by Phakopsora pachyrhizi, which comprises administering folpet and two primary fungicides selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
d. the method is for preventing or treating banana against Black sigatoka caused by Mycosphaerella fijiensis, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
e. the method is for preventing or treating cereals against Brown rust caused by Mycosphaerella fijiensis, which comprises administering folpet and two primary fungicides selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
f. the method is for preventing or treating coffee against Coffee Berry Disease caused by Colletotrichum kahawae, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
g. the method is for preventing or treating coffee against Coffee Leaf Rust caused by Hemileia vastatrix, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
h. the method is for preventing or treating pulses against Didymella pisi caused by Ascochyta rabiei, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
i. the method is for preventing or treating cucurbits against Downy mildew caused by Pseudoperonospora cubensis, which comprises administering folpet and two primary fungicides selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
j. the method is for preventing or treating grape against Downy mildew caused by Plasmopara viticola, which comprises administering folpet and two primary fungicides selected from the group consisting of pyrimidinone fungicide, QiI, QOI, DMI SDHI, fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
k. the method is for preventing or treating potato or tomato against Early blight caused by Plasmopara viticola, which comprises administering folpet and two primary fungicides selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
l. the method is for preventing or treating cereals against Fusarium head blight caused by Fusarium sp., which comprises administering folpet and two primary fungicides selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
m. the method is for preventing or treating corn against Gray Leaf Spot caused by Cercospora zeae-maydis, which comprises administering folpet and two primary fungicides selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
n. the method is for preventing or treating potato or tomato against Late blight caused by Phytophthora infestans, which comprises administering folpet and two primary fungicides selected from group the consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
o. the method is for preventing or treating sugar beet against leaf spot of beet caused by Cercospora beticola, which comprises administering folpet and two primary fungicides selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
p. the method is for preventing or treating corn against Northern Corn Leaf Blight caused by Setosphaeria turcica, which comprises administering folpet and two primary fungicides selected the group from consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
q. the method is for preventing or treating corn against Northern Corn Leaf Blight caused by Cochliobolus carbonum, which comprises administering folpet and two primary fungicides selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
r. the method is for preventing or treating cereals against Ramularia leaf spot caused by Ramularia collo-cygni, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
s. the method is for preventing or treating cotton against Ramularia leaf spot caused by Ramularia areola, which comprises administering folpet and two primary fungicides selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
t. the method is for preventing or treating sugar beet against Ramularia leaf spot caused by Ramularia beticola, which comprises administering folpet and two primary fungicides selected from group the consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
u. the method is for preventing or treating rice against Rice Blast caused by Pyricularia oryzae, which comprises administering folpet and two primary fungicides selected from the group consisting of pyrimidinone fungicide, QiI, QOI, DMI OSBPI, SDHI, fungicide, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
v. the method is for preventing or treating sugar beet against Ramularia leaf spot caused by Ramularia beticola, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
w. the method is for preventing or treating rice against Rice Blast caused by Pyricularia oryzae, which comprises administering folpet and two primary fungicides selected from the group consisting of pyrimidinone fungicide, QiI, SDHI, fungicide, QoI, DMI OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
x. the method is for preventing or treating sugar beet against Rust caused by Uromyces betae, which comprises administering folpet and two primary fungicides selected from the group consisting of pyrimidinone fungicide, QiI, QoI, SDHI, fungicide, DMI OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
y. the method is for preventing or treating pome fruit against scab caused by Venturia inaequalis, which comprises administering folpet and two primary fungicides selected from the group consisting of pyrimidinone fungicide, QiI, QoI, DMI OSBPI, SDHI, fungicide, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
z. the method is for preventing or treating sugar beet against OSR caused by Venturia inaequalis, which comprises administering folpet and two primary fungicides selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
aa. the method is for preventing or treating cereals against Septoria caused by Zymoseptoria tritici, which comprises administering folpet and two primary fungicides selected from group the consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
bb. the method is for preventing or treating rice against Sheath Blight caused by Rhizoctonia solani or Thanatephorus cucumeris, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
cc. the method is for preventing or treating corn against Southern corn leaf blight caused by Cochliobolus heterostrophus, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
dd. the method is for preventing or treating soybean against Target spot caused by Corynespora cassiicola, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
ee. the method is for preventing or treating cereals against Yellow rust caused by Puccinia striiformis, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100, or
ff. the method is for preventing or treating banana against Yellow sigatoka caused by Pseudocercospora musae, which comprises administering folpet and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

23. The method of claim 1, wherein:
a. the method is for preventing or treating pulses against anathracnose caused by Colletotrichum sp., which comprises administering captan and two primary fungicides selected from the group consisting of pyrimidinone fungicide, QiI, QoI, DMI SDHI, fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
b. the method is for preventing or treating chili against anathracnose caused by Colletotrichum truncatum, which comprises administering captan and two primary fungicides selected from the group consisting of pyrimidinone fungicide, QiI, QoI, SDHI, DMI fungicide, phenylpyridinamine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
c. the method is for preventing or treating soybean against Asian soybean rust caused by Phakopsora pachyrhizi, which comprises administering captan and two primary fungicides group selected from the consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
d. the method is for preventing or treating banana against Black sigatoka caused by Mycosphaerella fijiensis, which comprises administering captan and two primary fungicides selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
e. the method is for preventing or treating cereals against Brown rust caused by Mycosphaerella fijiensis, which comprises administering captan and two primary fungicides selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
f. the method is for preventing or treating coffee against Coffee Berry Disease caused by Colletotrichum kahawae, which comprises administering captan and two primary fungicides selected from consisting the group of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
g. the method is for preventing or treating coffee against Coffee Leaf Rust caused by Hemileia vastatrix, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
h. the method is for preventing or treating pulses against Didymella pisi caused by Ascochyta rabiei, which comprises administering captan and two primary fungicides selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
i. the method is for preventing or treating cucurbits against Downy mildew caused by Pseudoperonospora cubensis, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
j. the method is for preventing or treating grape against Downy mildew caused by Plasmopara viticola, which comprises administering captan and two primary fungicides selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
k. the method is for preventing or treating potato or tomato against Early blight caused by Plasmopara viticola, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
l. the method is for preventing or treating cereals against Fusarium head blight caused by Fusarium sp., which comprises administering captan and two primary fungicides selected the from group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
m. the method is for preventing or treating corn against Gray Leaf Spot caused by Cercospora zeae-maydis, which comprises administering captan and two primary fungicides selected from the group consisting of pyrimidinone fungicide, QiI, QOI, DMI OSBPI, SDHI, fungicide, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
n. the method is for preventing or treating potato or tomato against Late blight caused by Phytophthora infestans, which comprises administering captan and two primary fungicides selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
o. the method is for preventing or treating sugar beet against leaf spot of beet caused by Cercospora beticola, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
p. the method is for preventing or treating corn against Northern Corn Leaf Blight caused by Setosphaeria turcica, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
q. the method is for preventing or treating corn against Northern Corn Leaf Blight caused by Cochliobolus carbonum, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
r. the method is for preventing or treating cereals against Ramularia leaf spot caused by Ramularia collo-cygni, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
s. the method is for preventing or treating cotton against Ramularia leaf spot caused by Ramularia areola, which comprises administering captan and two primary fungicides selected from consisting the group of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
t. the method is for preventing or treating sugar beet against Ramularia leaf spot caused by Ramularia beticola, which comprises administering captan and two primary fungicides selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
u. the method is for preventing or treating rice against Rice Blast caused by Pyricularia oryzae, which comprises administering captan and two primary fungicides selected from the group consisting of pyrimidinone fungicide, QiI, QOI, SDHI, OSBPI, DMI fungicide, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
v. the method is for preventing or treating sugar beet against Ramularia leaf spot caused by Ramularia beticola, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
w. the method is for preventing or treating rice against Rice Blast caused by Pyricularia oryzae, which comprises administering captan and two primary fungicides selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
x. the method is for preventing or treating sugar beet against Rust caused by Uromyces which betae, comprises administering captan and two primary fungicides selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
y. the method is for preventing or treating pome fruit against scab caused by Venturia inaequalis, which comprises administering captan and two primary fungicides selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100,
z. the method is for preventing or treating sugar beet against OSR caused by Venturia inaequalis, which comprises administering captan and two primary fungicides selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100, or
aa. the method is for preventing or treating cereals against Septoria caused by Zymoseptoria tritici, which comprises administering captan and two primary fungicides selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide at a ratio between 1:1:1 to 1:100:1; or to 100:1:1; or to 1:1:100; or to 1:100:100; or to 100:100:1; or to 100:1:100.

24. (canceled)

25. (canceled)

26. An improved combination comprising an amount of a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide and an amount of a phthalimide fungicide.

27. The combination of claim 26, wherein:
i) the combination is an improved combination in that:
a. it is synergistic,
b. it has greening effect,
c. the amount of the phthalimide fungicide improves the fungicidal efficacy of the amount of the primary fungicide compared to when the same amount of the primary fungicide is applied not in combination with the amount of the phthalimide fungicide,
d. a substantially similar level of fungicidal efficacy is achieved by using a lesser amount of the phthalimide fungicide and/or the primary fungicide,
e. the amount of the phthalimide fungicide is effective to increase sensitivity of the fungus to the amount of the primary fungicide compared to the sensitivity of the fungus to the amount of the primary fungicide when it is applied not in combination with the amount of the phthalimide fungicide,
f. the amount of the phthalimide fungicide is effective to increase bioavailability of the amount of the primary fungicide compared to the bioavailability of the amount of the primary fungicide when it is applied not in combination with the amount of the phthalimide fungicide,
g. the combination is more effective in treating the plant or locus against fungal infection than when each fungicide at the same amount is applied alone,
h. the combination prolongs the period of protection against fungal infection and/or control of fungal infection than when the amount of the phthalimide fungicide and the amount of a primary fungicide are applied alone,
i. the combination reduces the amount of time needed to achieve a level of fungal control than when the amount of the phthalimide fungicide and the amount of a primary fungicide are applied alone,
j. the combination improves plant development compared to the development of a plant affected by the same type and degree of fungal infection to which the combination is not applied, and/or
k. the amount of the primary fungicide and the amount of the phthalimide fungicide are more effective for treat a plant or locus against fungal infection than when the amount of the phthalimide fungicide and the amount of a primary fungicide are applied alone,
ii) treating a plant or locus against fungal infection comprises:
a. inhibiting fungal mycelium formation,
b. combating phytopathogenic diseases on the plant or locus,
c. protecting the plant or locus from fungal attack,
d. preventing fungal infection of the plant or locus,
e. controlling fungal disease affecting the plant or locus,
f. controlling a fungal pathogen, a fungal pathogen group or a fungal pathogen class affecting the plant or locus,
g. controlling a fungal disease caused by a fungal pathogen, a fungal pathogen group or a fungal pathogen class affecting the plant or locus, and/or
h. reducing fungal infection of the plant or locus,
iii) the combination is a mixture or a composition, and/or
iv) the phthalimide fungicide is selected from the group consisting of captan, folpet, and a combination thereof.

28. (canceled)

29. (canceled)

30. (canceled)

31. A composition comprising the combination of claim 26 and at least one agriculturally acceptable carrier.

32. The composition of claim 31, wherein:
a) the amount of the phthalimide fungicide(s) and the primary fungicide(s) in the composition is from about 0.5% to about 95% by weight based on the total weight of the composition,
b) the composition is a ready-mix formulation, and/or
c) the composition comprises at least one agriculturally acceptable additive selected from the group consisting of surfactants, solid diluents, liquid diluents, adjuvants and any combination thereof.

33. (canceled)

34. (canceled)

35. A process of preparing the composition of claim 31, wherein the process comprises the steps of: (i) obtaining an amount of the phthalimide fungicide(s) and an amount of the primary fungicide(s), and (ii) mixing the obtained amount of phthalimide fungicide(s) and the obtained amount of the primary fungicide(s) to obtain the composition.

36. A package comprising the combination of claim 26.

37. A method of:
a. increasing sensitivity of a fungus to an amount of a primary fungicide selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide, comprising applying a combination of an amount of a phthalimide fungicide and the amount of the primary fungicide to the fungus, so as to thereby increase sensitivity of the fungus to the amount of the primary fungicide,
b. increasing bioavailability of an amount of a primary fungicide selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide to a plant comprising applying a combination of an amount of a phthalimide fungicide and the amount of the primary fungicide to the plant, so as to thereby increase bioavailability of the amount of the primary fungicide,
c. inhibiting fungal mycelium formation comprising applying a combination of an amount of a phthalimide fungicide and an amount of a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide to the fungus, so as to thereby inhibit fungal mycelium formation,
d. prolonging the period of protection against fungal infection and/or control of fungal infection from an application of an amount of a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide to the plant or locus. In some embodiments, the plant is a crop plant,
e. reducing the amount of time needed to achieve a level of fungal control from an application of an amount of primary fungicide selected from the group consisting of pyrimidinone fungicide, QiI, QOI, SDHI, DMI fungicide, OSBPI, amine fungicide, tetrazolyloxime fungicide, phenylpyridinamine fungicide, or inorganic fungicide to a plant or locus comprising applying a combination of an amount of a phthalimide fungicide and the amount of the primary fungicide to the plant or locus,
f. improving development of a plant affected by fungal infection comprising applying a combination of a phthalimide fungicide and a primary fungicide selected from the group consisting of pyrimidinone fungicide, QiI, QoI, SDHI, DMI fungicide, OSBPI, amine fungicide, tetrazolyloxime fungicide, phenylpyridinamine fungicide, or inorganic fungicide to the plant or a locus thereof so as to improve the development of the plant compared to the development of a plant affected by the same type and degree of fungal infection to which the combination is not applied.
